(19) United States
(12) Patent Application Publication
(10) Pub. No.: US 2024/0424861 A1
(43) Pub. Date: Dec. 26, 2024

(54) VEHICLE SEAT AIR CONDITIONER

(71) Applicant: Panasonic Automotive Systems Co., Ltd., Kanagawa (JP)

(72) Inventors: Takuya NAKAGAWA, Shiga (JP); Yuki MAKITA, Kanagawa (JP); Tatehiko INOUE, Osaka (JP); Yoshihiko MAEDA, Hyogo (JP); Takeshi ENYA, Hyogo (JP)

(21) Appl. No.: 18/830,100

(22) Filed: Sep. 10, 2024

Related U.S. Application Data
(63) Continuation of application No. PCT/JP2022/047774, filed on Dec. 23, 2022.

(30) Foreign Application Priority Data
Mar. 18, 2022 (JP) 2022-043320
Mar. 18, 2022 (JP) 2022-043321
Mar. 18, 2022 (JP) 2022-043349
Mar. 18, 2022 (JP) 2022-043425
Sep. 28, 2022 (JP) 2022-154444

(51) Int. Cl. B60H 1/00

(52) U.S. Cl. CPC B60H 1/00564; B60H 1/00285; B60H 1/00871

(57) ABSTRACT

According to one embodiment, a vehicle seat air conditioner is provided in a first seat of a vehicle and performs air-conditioning for another seat other than the first seat. The vehicle seat air conditioner includes a blower, a blowing duct configured to blow out air guided by the blower from a blowing port provided on a side surface of the first seat, and a controller configured to control the blower. The controller is configured to: acquire blowing target positions of air blown out from the blowing port of the first seat and a blowing port of the other seat; and control, based on the blowing target positions, at least one of a time at which air is blown out from the blowing port, a blowing direction, and selection of the blowing ports from which the air is blown out.

### CROSS-REFERENCE TO RELATED APPLICATIONS

This application is a continuation of International Application No. PCT/JP2022/047774, filed on Dec. 23, 2022 which claims the benefit of priority of the prior Japanese Patent Applications No. 2022-043320, No. 2022-043321, No. 2022-043349, No. 2022-043425, and No. 2022-154444, filed on Mar. 18, 2022, the entire contents of which are incorporated herein by reference.

### FIELD

Embodiments described herein relate generally to a vehicle seat air conditioner.

### BACKGROUND

In recent years, there has been a need to provide a comfortable air-conditioned environment for a person seated in a seat. For example, JP 2019-156154 A discloses a seat air conditioner for performing air-conditioning for a specific seat adjacent to at least one adjacent seat in a user space in which a plurality of seats is installed, the seat air conditioner including: an air conditioner that supplies conditioned air to the specific seat; a setting information acquisition unit that acquires setting information on air-conditioning as for the specific seat; an adjacent information acquisition unit that acquires operation information on an adjacent air conditioner for performing air-conditioning for the adjacent seat; and an air-conditioning controller that controls operation of the air conditioner based on the setting information and adjusts the operation of the air conditioner based on the operation information on the adjacent air conditioner.

However, in the conventional technology, a comfortable environment cannot be provided for an occupant seated in a seat in some cases.

The present disclosure has been made to solve the above problem, and provides a vehicle seat air-conditioning system and a vehicle seat air conditioner capable of providing a more comfortable air-conditioned environment for an occupant seated in a seat.

### SUMMARY

A vehicle seat air conditioner according to an embodiment of the present disclosure is provided in a first seat of a vehicle and performs air-conditioning for another seat other than the first seat. The vehicle seat air conditioner includes: a blower; a blowing duct configured to blow out air guided by the blower from a blowing port provided on a side surface of the first seat; and a controller configured to control the blower. The controller is configured to: acquire blowing target positions of air blown out from the blowing port of the first seat and a blowing port of the other seat; and control, based on the blowing target positions, at least one of a time at which air is blown out from the blowing port, a blowing direction, and selection of the blowing ports from which the air is blown out.

### BRIEF DESCRIPTION OF THE DRAWINGS

FIG. 1 is a view illustrating the appearance of a vehicle seat air-conditioning system according to a first embodiment disposed in a vehicle interior;

FIG. 2 is a perspective view illustrating the appearance of a seat provided with a vehicle seat air conditioner according to the first embodiment;

FIG. 3 is a cross-sectional view of the seat provided with the vehicle seat air conditioner taken along line I-I in FIG. 2;

FIG. 4 is a cross-sectional view of the seat provided with the vehicle seat air conditioner taken along line II-II in FIG. 2;

FIG. 5 is an enlarged cross-sectional view of a frame portion indicated by a broken line in FIG. 4;

FIG. 6 is a block diagram illustrating the vehicle seat air-conditioning system according to the first embodiment;

FIG. 7 is a flowchart illustrating processing of the vehicle seat air-conditioning system according to the first embodiment;

FIG. 8 is a schematic front view illustrating a flow path of air in a driver's seat and a passenger seat for a case where Step S104 in FIG. 7 is executed;

FIG. 9 is a schematic front view illustrating a flow path of air in a driver's seat and a passenger seat for a case where Step S105 in FIG. 7 is executed;

FIG. 10 is a schematic front view illustrating a flow path of air in a driver's seat and a passenger seat for a case where Step S107 in FIG. 7 is executed;

FIG. 11 is a schematic front view illustrating a flow path of air in a driver's seat and a passenger seat for a case where Step S108 in FIG. 7 is executed;

FIG. 12 is a schematic front view illustrating a flow path of air in a driver's seat and a passenger seat for a case where a comparative example in Step S104 in FIG. 7 is executed;

FIG. 13 is a schematic front view illustrating a flow path of air in a driver's seat and a passenger seat for a case where the comparative example in Step S104 in FIG. 7 is executed;

FIG. 14 is a perspective view illustrating the appearance of a seat provided with a vehicle seat air conditioner according to a first modification of the first embodiment;

FIG. 15 is a cross-sectional view of a seat provided with the vehicle seat air conditioner taken along line III-III in FIG. 14;

FIG. 16 is a flowchart illustrating processing of a vehicle seat air-conditioning system according to the first modification of the first embodiment;

FIG. 17 is a schematic diagram illustrating a time difference control mode according to the first modification of the first embodiment;

FIG. 18 is a schematic diagram illustrating a normal control mode according to the first modification of the first embodiment;

FIG. 19 is a block diagram illustrating a vehicle seat air conditioner according to a second modification of the first embodiment;

FIG. 20 is a flowchart illustrating processing of a vehicle seat air conditioner 230A according to the second modification of the first embodiment;

FIG. 21 is a flowchart illustrating processing of a vehicle seat air conditioner 230B according to the second modification of the first embodiment;

FIG. 22 is a flowchart illustrating processing of a vehicle seat air conditioner 330A according to a third modification of the first embodiment;

FIG. 23 is an enlarged cross-sectional view of a second ventilation port in a second embodiment as viewed from a Z-axis positive direction side;

FIG. 24 is a flowchart illustrating processing of a vehicle seat air conditioner 430B according to the second embodiment;

FIG. 25 is a flowchart illustrating processing of a vehicle seat air conditioner 430A according to the second embodiment;

FIG. 26 is a block diagram illustrating a vehicle seat air conditioner according to a modification of the second embodiment;

FIG. 27 is a flowchart illustrating processing of a vehicle seat air conditioner 530B according to a modification of the second embodiment;

FIG. 28 is a block diagram illustrating a vehicle seat air conditioner according to a third embodiment;

FIG. 29 is a flowchart illustrating processing of the vehicle seat air conditioner according to the third embodiment;

FIG. 30 is a flowchart illustrating processing of a vehicle seat air conditioner according to a first modification of the third embodiment;

FIG. 31 is a flowchart illustrating processing of a vehicle seat air conditioner according to a second modification of the third embodiment;

FIG. 32 is a block diagram illustrating a vehicle seat air conditioner according to a fourth embodiment;

FIG. 33 is a flowchart illustrating processing of the vehicle seat air conditioner according to the fourth embodiment;

FIG. 34 is a perspective view illustrating the appearance of a seat provided with a vehicle seat air conditioner according to a modification of the fourth embodiment;

FIG. 35 is a cross-sectional view of a seat portion of the seat provided with the vehicle seat air conditioner taken along line IV-IV in FIG. 34;

FIG. 36 is a flowchart illustrating processing of the vehicle seat air conditioner according to the modification of the fourth embodiment;

FIG. 37 is a block diagram illustrating a vehicle seat air-conditioning system according to a fifth embodiment;

FIG. 38 is a flowchart illustrating processing of the vehicle seat air-conditioning system according to the fifth embodiment;

FIG. 39 is a flowchart illustrating a subroutine of air-conditioning control processing in consideration of a seat position of a passenger seat in FIG. 38;

FIG. 40 is a flowchart illustrating a subroutine of air-conditioning control processing in consideration of a seat position of a driver's seat in FIG. 38; and

FIG. 41 is a flowchart illustrating a subroutine of air-conditioning control processing in which the seat positions are not taken into account in FIG. 38.

### DETAILED DESCRIPTION

Hereinafter, embodiments will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

Note that the accompanying drawings and the following description are provided for those skilled in the art to fully understand the present disclosure, and are not intended to limit the subject matter described in the appended claims.

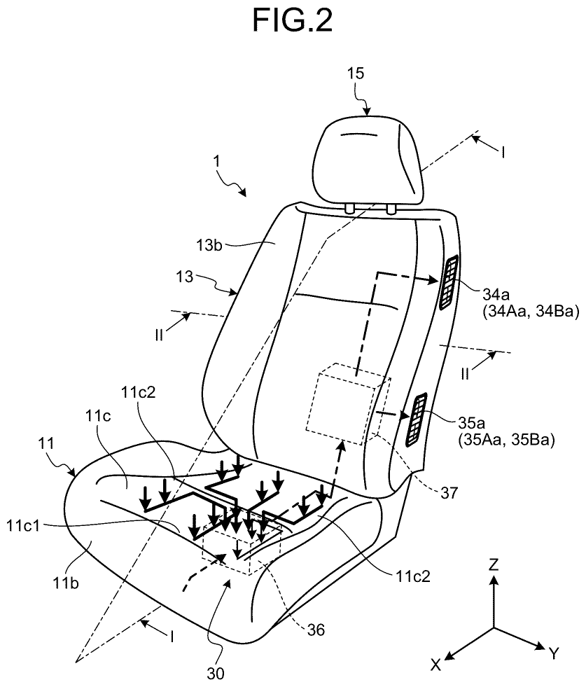

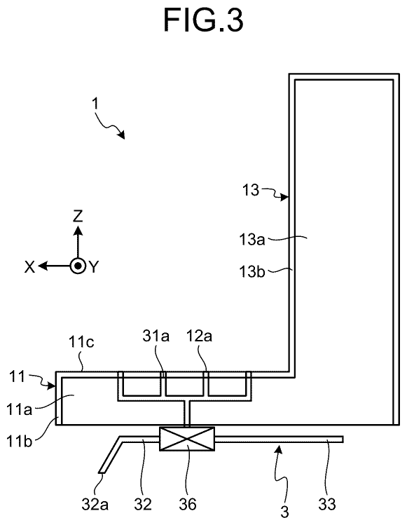

In the following description, a front-back direction of a seat is referred to as an X-axis direction, and a vertical direction of the seat is referred to as a Z-axis direction. Further, a left-right direction of the seat, that is, a direction perpendicular to each of the X-axis direction and the Z-axis direction is referred to as a Y-axis direction. In the X-axis direction, a front side of the seat is referred to as a positive direction side, and a rear side of the seat is referred to as a negative direction side. In the Y-axis direction, a left side of the seat (right foreground as viewed in FIG. 2) is referred to as a positive direction side, and the opposite side is referred to as a negative direction side. The right side is a right side of an occupant seated in the seat with respect to the direction of travel of a vehicle, and is a Y-axis negative direction side. The left side is a left side of the occupant seated in the seat with respect to the direction of travel of the vehicle, and is a Y-axis positive direction side. In the Z-axis direction, an upper side of the seat is referred to as a positive direction side, and a lower side of the seat is referred to as a negative direction side. The same applies to FIG. 3 and the subsequent drawings.

### First Embodiment

### Configuration

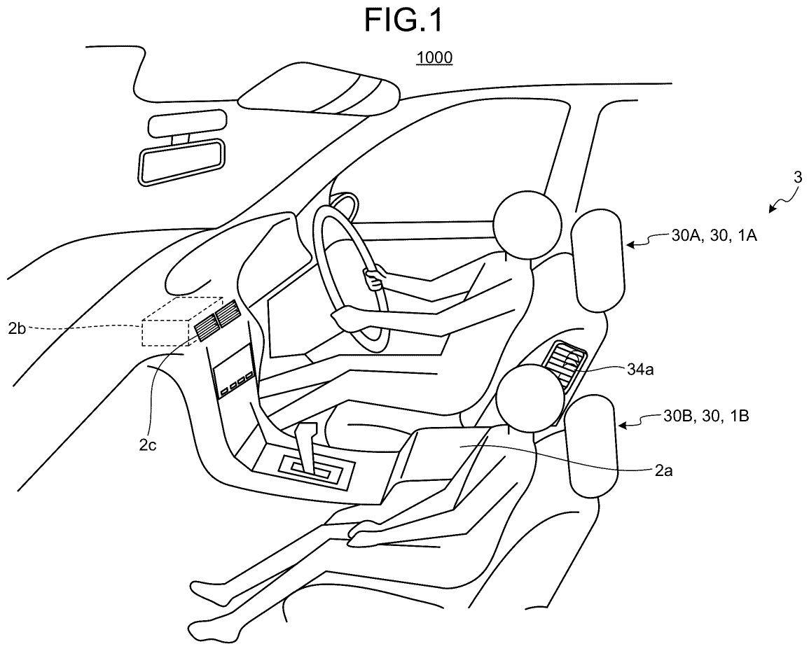

FIG. 1 is a view illustrating the appearance of a vehicle seat air-conditioning system 3 according to the first embodiment disposed in the interior of a vehicle 1000.

As illustrated in FIG. 1, the vehicle 1000 is provided with a driver's seat 1A and a passenger seat 1B, a center console 2a, and a vehicle air conditioner 2b.

The driver's seat 1A and the passenger seat 1B are seats in which occupants are seated, and are arranged along a width direction (left-right direction) of the vehicle 1000. Hereinafter, the driver's seat 1A and the passenger seat 1B are also collectively referred to as a seat 1. The center console 2a is provided at a center part of the vehicle 1000, namely, in a space between the driver's seat 1A and the passenger seat 1B, and separates the driver's seat 1A and the passenger seat 1B. Note that the space between the driver's seat 1A and the passenger seat 1B means not only the space of a gap between the driver's seat 1A and the passenger seat 1B but also a space from the driver's seat 1A to the passenger seat 1B, including the driver's seat 1A and the passenger seat 1B themselves. The center console 2a is long along the length direction of the vehicle 1000 and is connected to an instrument panel of the vehicle 1000.

The vehicle air conditioner 2b is an air conditioner for conditioning the vehicle interior. Specifically, the vehicle air conditioner 2b is mounted on the body of the vehicle 1000 and is covered with an instrument panel of the vehicle 1000. In the present embodiment, a blowing port 2c of the vehicle air conditioner 2b such as an air conditioner disposed at a center part in the width direction of the vehicle 1000 is exemplified. The driver's seat 1A and the passenger seat 1B each can correspond to either a “first seat” or a “second seat” in the appended claims.

Next, the vehicle seat air-conditioning system 3 according to the first embodiment will be described. The vehicle seat air-conditioning system 3 includes a plurality of vehicle seat air conditioners 30 and a controller (not illustrated in FIG. 1) that controls the plurality of vehicle seat air conditioners 30. The plurality of vehicle seat air conditioners 30 are provided in a plurality of seats of the vehicle 1000.

First, each of the vehicle seat air conditioners 30 will be described. Here, the vehicle seat air conditioner 30 provided in the driver's seat 1A is referred to as a vehicle seat air conditioner 30A, and the vehicle seat air conditioner 30 provided in the passenger seat 1B is referred to as a vehicle seat air conditioner 30B. In the following description, the vehicle seat air conditioner 30, which is a generic term for the vehicle seat air conditioner 30A and the vehicle seat air conditioner 30B, will be described.

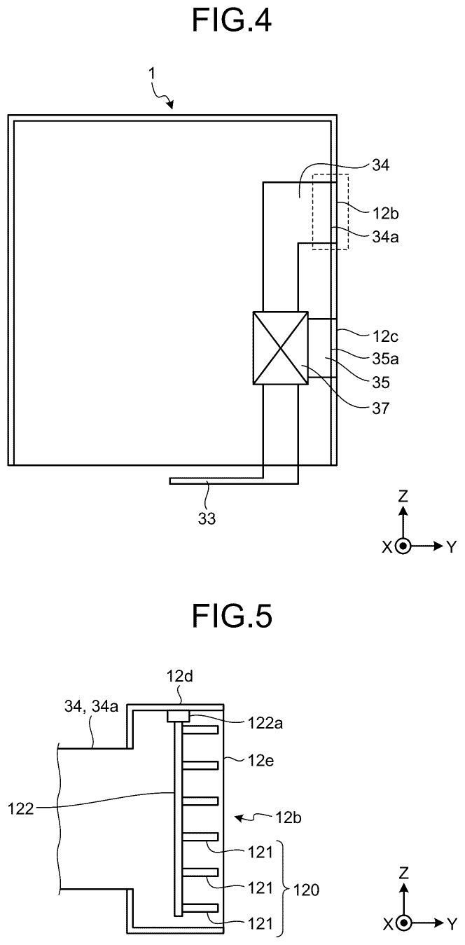

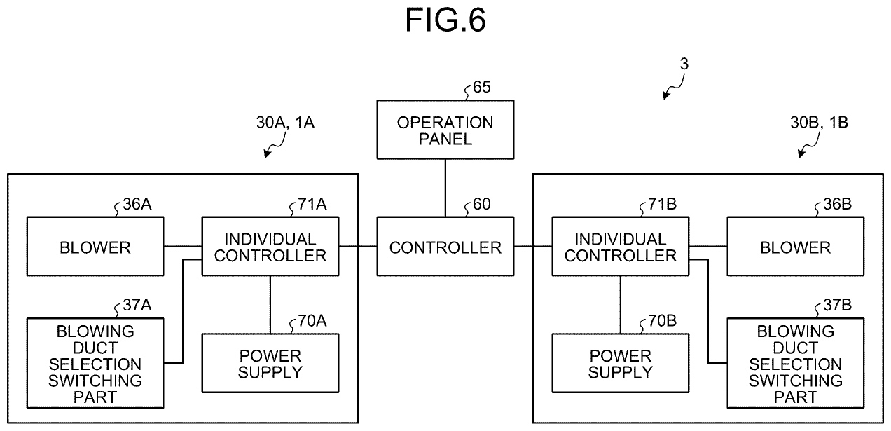

FIG. 2 is a perspective view illustrating the appearance of the seat 1 provided with the vehicle seat air conditioner 30 according to the first embodiment. In FIG. 2, a dashed arrow corresponds to air guided to a second intake duct 32, and an alternate long and short dash arrow corresponds to air guided to a first blowing duct 34 and a second blowing duct 35. FIG. 3 is a cross-sectional view of the seat 1 provided with the vehicle seat air conditioner 30 taken along line I-I in FIG. 2. FIG. 4 is a cross-sectional view of the seat 1 provided with the vehicle seat air conditioner 30 taken along line II-II in FIG. 2. FIG. 5 is an enlarged cross-sectional view of a frame portion indicated by a broken line in FIG. 4. FIG. 6 is a block diagram illustrating the vehicle seat air-conditioning system 3 according to the first embodiment.

As illustrated in FIGS. 2 to 4, for example, the seat 1 mounted on a vehicle or the like cools or warms an occupant seated in a seat adjacent to the seat 1 by discharging air to a body of the occupant. Specifically, the seat 1 is capable of cooling or warming the body of the occupant by discharging air from a first blowing port 34a or a second blowing port 35a used in the seat 1 to the head, neck, acromion, back, waist, buttocks, thighs, or the like of the occupant seated in the seat adjacent to the seat 1 along the width direction of the vehicle 1000. For example, in the driver's seat 1A, air is blown out from a first blowing port 34Aa and a second blowing port 35Aa used in the driver's seat 1A to the body of an occupant seated in the passenger seat 1B, and in the passenger seat 1B, air is blown out from a first blowing port 34Ba and a second blowing port 35Ba used in the passenger seat 1B to the body of an occupant seated in the driver's seat 1A. The seat 1 includes a seat portion 11 in which the occupant is seated, a seat back 13, a headrest 15, the vehicle seat air conditioner 30, and a power supply 70.

### Seat Portion 11

As illustrated in FIGS. 2 to 4, the seat portion 11 is a seat cushion that supports the buttocks, thighs, and the like of the occupant seated in the seat 1. The seat portion 11 includes a first seat pad 11a corresponding to a cushion material and a first seat cover 11b covering the first seat pad 11a.

The first seat pad 11a is made of, for example, urethane foam or the like, and constitutes the body of the seat portion. The first seat pad 11a has a thick and substantially rectangular plate shape, and is disposed in a posture substantially parallel to the X-Y plane. The first seat pad 11a supports the buttocks, thighs, and the like of the seated occupant.

The first seat pad 11a is provided with a first intake duct 31 for guiding air taken in from a first ventilation port 12a of a seat surface 11c that is a surface of the first seat cover 11b on a Z-axis positive direction side.

Although FIG. 3 illustrates an example in which the first ventilation port 12a and the first intake duct 31 have a one-to-one correspondence, the present invention is not limited to the configuration. In other words, a plurality of first ventilation ports 12a may be formed for one first intake duct 31. In this case, for example, a sponge-like cushion member may be disposed between the first seat pad 11a and the first seat cover 11b so that the plurality of first ventilation ports 12a communicate with one first intake duct 31.

A first intake port 31a is formed on the seat surface 11c which is a part of the seat 1 on a side where the occupant is seated in the seat 1. That is, the first intake port 31a is open toward the vehicle interior.

In the present embodiment, a plurality of first intake ports 31a is formed. Specifically, the first intake ports 31a are formed in a center portion 11c1 and an outer edge portion of the seat surface 11c which is a surface on a side where the occupant is seated in the seat 1. In the present embodiment, outer edge portions 11c2 are an outer edge portion 11c2 of the first seat pad 11a on the Y-axis positive direction side with respect to the center portion 11c1, and an outer edge portion 11c2 of the first seat pad 11a on the Y-axis negative direction side with respect to the center portion 11c1. The plurality of first intake ports 31a of the center portion 11c1 are formed along the X-axis direction, and the plurality of first intake ports 31a of the outer edge portions 11c2 are disposed on the Y-axis positive direction side and the Y-axis negative direction side respectively with respect to the first intake ports 31a of the center portion 11c1, and are formed along the X-axis direction. That is, the plurality of first intake ports 31a formed along the X-axis direction are formed in a plurality of rows so as to be arranged in the Y-axis direction on the surface of the first seat pad 11a on the Z-axis positive direction side.

Further, the second intake duct 32 for guiding air taken in from a second intake port 32a is provided in a space on the Z-axis negative direction side of the first seat pad 11a. The second intake port 32a is formed at a place other than the seat surface 11c which is a surface on a side where the occupant is seated in the seat 1. In the present embodiment, the second intake port 32a is formed in the space on the Z-axis negative direction side of the first seat pad 11a, and is connected to the vehicle air conditioner 2b mounted on the vehicle 1000. In the present embodiment, the example in which the second intake port 32a is connected to the vehicle air conditioner 2b has been described, but the present invention is not limited to the configuration. For example, the second intake port 32a may also be configured to be open toward the vehicle interior similarly to the first intake port 31a.

The first seat pad 11a is provided with a part of an air blowing duct 33, a blower 36 (blower 36A, blower 36B), and the like, in addition to the first intake duct 31 and the second intake duct 32. The blower 36 is driven, so that air flows into at least one of the first intake duct 31 and the second intake duct 32 in the first seat pad 11a. The first intake duct 31 formed in the space on the Z-axis negative direction side of the first seat pad 11a is implemented by, for example, a ventilation duct. The first intake duct 31 may be formed in the first seat pad 11a. In this case, the first intake duct 31 may be a simple through hole formed on the first seat pad 11a, or may be implemented by a ventilation duct. The second intake duct 32 formed in the first seat pad 11a may be a simple through hole formed on the first seat pad 11a, or may be implemented by a ventilation duct.

The first seat cover 11b is a cover that covers the first seat pad 11a. The first seat cover 11b is, for example, a leather cover, a fiber cover, or the like.

The first seat cover 11b is formed with the first ventilation ports 12a for taking in air. The first ventilation ports 12a are formed on the seat surface 11c which is a surface on a side where the occupant is seated in the seat portion 11, and are formed at a position corresponding to the first intake ports 31a of the vehicle seat air conditioner 30. In the present embodiment, the plurality of first ventilation ports 12a are formed on the first seat cover 11b along the X-axis direction, and are also formed in a plurality of rows so as to be arranged in the Y-axis direction. In FIG. 2, a start point of a solid arrow corresponds to the first ventilation port 12a.

Air taken in from the first ventilation port 12a is guided to the first intake port 31a of the vehicle seat air conditioner 30, is taken in from the first intake port 31a and then guided to the first intake duct 31. Accordingly, the first ventilation port 12a also serves as an intake port that sucks in air convection above the seat surface 11c by a suction force from the first intake port 31a by operation of the vehicle seat air conditioner 30. The first ventilation port 12a may be a part of the first intake duct 31. In this case, the first ventilation port 12a is an example of the first intake port 31a.

In the present embodiment, although the first seat cover 11b does not cover the second intake port 32a, the first seat cover 11b may cover the second intake port 32a. In this case, similarly to the first ventilation port 12a corresponding to the first intake port 31a, an ventilation port corresponding to the second intake port 32a may be formed on the first seat cover 11b. Air taken in from the ventilation port may be guided to the second intake duct 32.

### Seat Back 13

The seat back 13 is a backrest portion that supports the acromion, back, waist, and the like of the occupant seated in the seat 1. The seat back 13 is long along the Z-axis direction and is disposed so as to rise with respect to the seat portion 11. The seat back 13 includes a second seat pad 13a corresponding to a cushion material and a second seat cover 13b covering the second seat pad 13a.

The second seat pad 13a is made of, for example, urethane foam or the like, and is disposed in a posture so as to pivot about the Y axis. The second seat pad 13a supports the acromion, back, waist, and the like of the seated occupant.

The second seat pad 13a is provided with a part of the air blowing duct 33 for discharging air sucked from the first intake port 31a and the second intake port 32a, the first blowing duct 34, the second blowing duct 35, a blowing duct selection switching part 37, and the like. In the second seat pad 13a, air flowing into the second intake duct 32 in the first seat pad 11a by operation of the blower 36 is blown out from at least one of the first blowing port 34a of the first blowing duct 34 and the second blowing port 35a of the second blowing duct 35. The air blowing duct 33, the first blowing duct 34, and the second blowing duct 35 formed in the second seat pad 13a may be simple through holes formed on the second seat pad 13a, or may be implemented by ventilation ducts.

The second seat cover 13b is a cover that covers the second seat pad 13a. The second seat cover 13b is, for example, a leather cover, a fiber cover, or the like.

The second seat cover 13b is formed with a second ventilation port 12b and a third ventilation port 12c for discharging sucked air. The second ventilation port 12b is provided at a position corresponding to the first blowing port 34a of the first blowing duct 34 on the side surface of the seat back 13 facing the seat adjacent to the seat 1. The third ventilation port 12c is provided at a position corresponding to the second blowing port 35a of the second blowing duct 35 on the side surface of the seat back 13 facing the seat adjacent to the seat 1.

In other words, the first blowing port 34a and the second blowing port 35a are formed on the side surface of the seat back 13 facing the seat adjacent to the seat 1.

As described above, in the present embodiment, the second ventilation port 12b (first blowing port 34a) and the third ventilation port 12c (second blowing port 35a) are provided, among the side surfaces of the seat back 13, on the side surface on the center console 2a side, not on the side surface on the door side of the vehicle 1000 on which an airbag can be mounted.

The second ventilation port 12b and the third ventilation port 12c may be provided so as to protrude laterally from the seat back 13, or may be provided so as to be embedded in the seat back 13.

The second ventilation port 12b is disposed vertically above the third ventilation port 12c, that is, on the Z-axis positive direction side. In the present embodiment, the second ventilation port 12b is formed in a part of the second seat cover 13b corresponding to at least one or more portions of the head, neck, acromion, and back of the occupant seated in the seat adjacent to the seat 1, and the third ventilation port 12c is formed in a part of the second seat cover 13b corresponding to at least one or more portions of the waist, buttocks, and thighs of the occupant seated in the seat adjacent to the seat 1.

Air that has been guided to the second intake duct 32, the air blowing duct 33, and the first blowing duct 34 and blown out from the first blowing port 34a passes through the second ventilation port 12b. That is, when the vehicle seat air conditioner 30 is operated to guide air into the second intake duct 32, the air blowing duct 33, and the first blowing duct 34 and the air is blown out from the first blowing port 34a, that air is guided to the second ventilation port 12b. Accordingly, the second ventilation port 12b also serves as a blowing port for discharging air to the outside of the seat 1.

Air that has been guided to the second intake duct 32, the air blowing duct 33, and the second blowing duct 35 and blown out from the second blowing port 35a passes through the third ventilation port 12c. That is, when the vehicle seat air conditioner 30 is driven to guide air into the second intake duct 32, the air blowing duct 33, and the second blowing duct 35 and the air is blown out from the second blowing port 35a, that air is guided to the third ventilation port 12c. Accordingly, the third ventilation port 12c also serves as a blowing port for discharging air to the outside of the seat 1.

As illustrated in FIG. 5, the second ventilation port 12b includes a case 12d having a space communicating with the first blowing duct 34, and an opening 12e provided in the case 12d. This allows the second ventilation port 12b to blow out air flowing through the first blowing duct 34 from the opening 12e to the occupant seated in the seat adjacent to the seat 1 or a space around the occupant.

A plurality of horizontal plate fins 121 as an airflow direction changing member 120, a link mechanism 122, a drive unit 122a, and the like are provided inside the second ventilation port 12b. The horizontal plate fins 121 are members for changing the direction of air blown out from the second ventilation port 12b. The horizontal plate fins 121 are connected by the link mechanism 122. The link mechanism 122 is configured to simultaneously change the orientations of the horizontal plate fins 121. The drive unit 122a is connected to the link mechanism 122, and is configured to change the orientations of the horizontal plate fins 121 by operation of the drive unit 122a. The third ventilation port 12c also has a similar configuration.

### Headrest 15

The headrest 15 is a headrest portion that supports the head of the occupant seated in the seat 1. The headrest 15 is fixed to an end portion of the seat back 13 on the Z-axis positive direction side.

### Vehicle Seat Air Conditioner 30

The vehicle seat air conditioner 30 is an air conditioner that is used in the seat 1 of the vehicle 1000 and can blow out air from the side of the occupant seated in the seat adjacent to the seat 1 toward the occupant. The vehicle seat air conditioner 30 blows air by sucking in air from the vehicle air conditioner 2b mounted on the vehicle 1000 and discharging the sucked air to the occupant. Accordingly, the air blown out by the vehicle seat air conditioner 30 to the occupant becomes hot air when the temperature of air sent from the vehicle air conditioner 2b is higher than a normal temperature, and becomes cold air when the temperature thereof is lower than the normal temperature.

As illustrated in FIGS. 3, 4, and 6, the vehicle seat air conditioner 30 includes the blower 36, the second intake duct 32, the air blowing duct 33, the first blowing duct 34, the second blowing duct 35, the blowing duct selection switching part 37, and an individual controller 71.

The blower 36 can suck in air from the second intake port 32a formed in the first seat pad 11a and blow out the sucked air from the second ventilation port 12b and the third ventilation port 12c formed in the second seat pad 13a. Specifically, the blower 36 is electrically connected to the individual controller 71, and is driven and controlled by the individual controller 71 to suck in air from at least one of the first intake port 31a and the second intake port 32a, blow out the sucked air from the first blowing port 34a via the second intake duct 32, the air blowing duct 33, the blowing duct selection switching part 37, and the first blowing duct 34, and blow out the sucked air from the second blowing port 35a via the second intake duct 32, the air blowing duct 33, the blowing duct selection switching part 37, and the second blowing duct 35.

The blower 36 is embedded in the seat portion 11 of the seat 1. Specifically, the blower 36 is disposed in the space on the Z-axis negative direction side of first seat pad 11a. When the blower 36 is driven, air is sucked in from the first intake port 31a and the second intake port 32a of the first seat cover 11b.

The blower 36 is disposed upstream of the blowing duct selection switching part 37. Specifically, the blower 36 is disposed upstream of the blowing duct selection switching part 37 in the flow path of air flowing from the first intake port 31a to the first blowing port 34a, the flow path of air flowing from the first intake port 31a to the second blowing port 35a, the flow path of air flowing from the second intake port 32a to the first blowing port 34a, and the flow path of air flowing from the second intake port 32a to the second blowing port 35a. It is only required that air flows from the first intake port 31a and the second intake port 32a to the blowing duct selection switching part 37 and air flows from the blowing duct selection switching part 37 to at least one of the first blowing port 34a and the second blowing port 35a; therefore, the blower 36 may be arranged outside the second intake duct 32. The blower 36 may be arranged outside the first seat pad 11a, and the arrangement position is not particularly limited.

The first intake duct 31 is embedded in the seat 1. Specifically, the first intake duct 31 is disposed inside the seat portion 11 so as to extend from the seat surface 11c of the seat portion 11 to the blower 36.

In the first intake duct 31, air sucked in from the first intake port 31a provided in the seat portion 11 of the seat 1 is guided to the air blowing duct 33 by the blower 36. The first intake duct 31 is implemented by, for example, a ventilation duct.

One end of the first intake duct 31 forms the first intake port 31a, and the other end is connected to the blower 36. In other words, the first intake duct 31 extends from the first intake port 31a to the blower 36.

The first intake port 31a can suck in air from the seat surface 11c of the seat portion 11, and corresponds to the first ventilation port 12a of the first seat cover 11b. When viewed along the Z-axis direction, the first intake port 31a overlaps with the first ventilation port 12a. In the present embodiment, the first intake port 31a sucks in air through the first ventilation port 12a, but may be configured to directly suck in air.

The second intake duct 32 is disposed on the Z-axis negative direction side of the seat 1. Specifically, the second intake duct 32 is disposed in the space on the Z-axis negative direction side of the first seat pad 11a so as to extend from a place other than the seat surface 11c of the seat portion 11 to the blower 36.

The second intake duct 32 is a ventilation path different from the first intake duct 31. The second intake duct 32 guides air sucked in from the second intake port 32a by the blower 36 to the air blowing duct 33. The second intake duct 32 is implemented by, for example, a ventilation duct.

One end of the second intake duct 32 forms the second intake port 32a, and the other end is connected to the blower 36. In other words, the second intake duct 32 extends from the second intake port 32a to the blower 36.

The second intake port 32a is an intake port different from the first intake port 31a. The second intake port 32a is formed at a place other than the seat surface 11c of the seat portion 11. In the present embodiment, the second intake port 32a is formed in the space on the Z-axis negative direction side of the first seat pad 11a, and is connected to the vehicle air conditioner 2b mounted on the vehicle 1000.

The air blowing duct 33 is embedded in the seat 1. Specifically, the air blowing duct 33 is disposed inside the seat 1 so as to extend from the blower 36 to the blowing duct selection switching part 37. A part of the air blowing duct 33 is disposed in the space on the Z-axis negative direction side of the first seat pad 11a, and a part of the remaining part of the air blowing duct 33 is disposed inside the seat back 13.

The air blowing duct 33 is a ventilation path different from the first intake duct 31 and the second intake duct 32. The air blowing duct 33 guides air guided to the first intake duct 31 and the second intake duct 32 by the blower 36 to the blowing duct selection switching part 37. The air blowing duct 33 is implemented by, for example, a ventilation duct.

One end of the air blowing duct 33 is connected to the blower 36, and the other end is connected to the blowing duct selection switching part 37. In other words, the air blowing duct 33 extends from the blower 36 to the blowing duct selection switching part 37.

The first blowing duct 34 is a ventilation path different from the first intake duct 31, the second intake duct 32, and the air blowing duct 33. The first blowing duct 34 guides air guided from the air blowing duct 33 by the blower 36 from the blowing duct selection switching part 37 to the first blowing port 34a provided in the seat 1. Specifically, the first blowing duct 34 guides, to the first blowing port 34a, air sucked in from the first intake port 31a and guided to the air blowing duct 33 through the first intake duct 31, and air sucked in from the second intake port 32a and guided to the air blowing duct 33 through the second intake duct 32.

The first blowing duct 34 is implemented by, for example, a ventilation duct. One end of the first blowing duct 34 forms the first blowing port 34a, and the other end is connected to the blowing duct selection switching part 37.

The first blowing duct 34 may be connected to the blowing duct selection switching part 37 via the blower 36. The first blowing port 34a corresponds to the second ventilation port 12b of the second seat cover 13b. When viewed along the Y-axis direction, the first blowing port 34a overlaps with the second ventilation port 12b. In the present embodiment, the first blowing port 34a blows out air through the second ventilation port 12b, but may be configured to directly blow out air.

The first blowing duct 34 is embedded in the seat 1. Specifically, the first blowing duct 34 is disposed inside the seat back 13.

The first blowing duct 34 extends from the blowing duct selection switching part 37 to the first blowing port 34a. The first blowing port 34a, which is one end of the first blowing duct 34, is arranged at a position corresponding to at least one or more of the head, neck, acromion, back, waist, buttocks, and thighs of the occupant seated in the seat adjacent to the seat 1.

The second blowing duct 35 is a ventilation path different from the first intake duct 31, the second intake duct 32, the air blowing duct 33, and the first blowing duct 34, and guides air guided from the air blowing duct 33 by the blower 36 from the blowing duct selection switching part 37 to the second blowing port 35a provided in the seat 1.

Specifically, the second blowing duct 35 guides, to the second blowing port 35a, air sucked in from the first intake port 31a and guided to the air blowing duct 33 through the first intake duct 31, and air sucked in from the second intake port 32a and guided to the air blowing duct 33 through the second intake duct 32. The second blowing duct 35 is implemented by, for example, a ventilation duct. One end of the second blowing duct 35 forms the second blowing port 35a, and the other end is connected to the blowing duct selection switching part 37. The second blowing duct 35 may be connected to the blowing duct selection switching part 37 via the blower 36.

The second blowing port 35a corresponds to the third ventilation port 12c of the second seat cover 13b. When viewed along the Y-axis direction, the second blowing port 35a overlaps with the third ventilation port 12c. In the present embodiment, the second blowing port 35a blows out air through the third ventilation port 12c, but may be configured to directly blow out air.

The second blowing duct 35 is embedded in the seat 1. Specifically, the second blowing duct 35 is disposed inside the seat back 13.

The second blowing duct 35 extends from the blowing duct selection switching part 37 to the second blowing port 35a. The second blowing port 35a, which is one end of the second blowing duct 35, is arranged at a position corresponding to at least one or more of the head, neck, acromion, back, waist, buttocks, and thighs of the occupant seated in the seat adjacent to the seat 1.

With such configurations of the second intake duct 32, the first blowing duct 34, and the second blowing duct 35, the first intake port 31a, the second intake port 32a, the first blowing port 34a, and the second blowing port 35a have the following relationship. The first intake port 31a and the second intake port 32a are disposed vertically below the first blowing port 34a and the second blowing port 35a. The first blowing port 34a is disposed vertically above the second blowing port 35a. As a result, air sucked in from the vehicle air conditioner 2b mounted on the vehicle 1000 is blown out from positions corresponding to the head, neck, acromion, back, waist, buttocks, thighs, and the like of the occupant, so that the air is blown to the occupant seated in the seat adjacent to the seat 1.

The blowing duct selection switching part 37 is provided closer to the first blowing port 34a and the second blowing port 35a side than the blower 36 is, selects and switches at least one or more ventilation paths of the first blowing duct 34 and the second blowing duct 35, and guides air guided to the air blowing duct 33 to the selected ventilation paths. The blowing duct selection switching part 37 includes a damper, and can switch the flow path of air, that is, the ventilation path. In the air guided to the air blowing duct 33, the blowing duct selection switching part 37 is disposed downstream of the blower 36. The blowing duct selection switching part 37 can guide the air guided to the air blowing duct 33 to selectively either the first blowing duct 34 alone or the second blowing duct 35 alone.

Specifically, the blowing duct selection switching part 37 has a first mode and a second mode. The first mode is a mode for connecting the air blowing duct 33 and the first blowing duct 34 to each other. In the first mode, the blowing duct selection switching part 37 guides the air guided from the air blowing duct 33 only to the first blowing duct 34 to thereby blow out the air from the first blowing port 34a. The second mode is a mode for connecting the air blowing duct 33 and the second blowing duct 35 to each other. In the second mode, the blowing duct selection switching part 37 guides the air guided from the air blowing duct 33 to the second blowing duct 35 to thereby blow out the air from the second blowing port 35a. The blowing duct selection switching part 37 is electrically connected to the individual controller 71 and is driven and controlled by the individual controller 71 to select one of the first mode and the second mode.

### Individual Controller 71

The individual controller 71 controls the blower 36 and the blowing duct selection switching part 37. The individual controller 71 is a microcomputer that controls, for example, the output of the blower 36 by switching on/off of a current flowing through the blower 36 and the blowing duct selection switching part 37 or changing the current value. The individual controller 71 switches the modes of the blowing duct selection switching part 37 by selecting any one of the first mode and the second mode.

### Power Supply 70

The power supply 70 is a power supply circuit that supplies power to the blower 36 and the blowing duct selection switching part 37 via the individual controller 71 and the like. Here, the power supply 70 is a DC power supply supplied from a battery (not illustrated). The power supply 70 (power supply 70A, power supply 70B) is controlled by the individual controller 71 to adjust the current to be supplied to the blower 36 and the blowing duct selection switching part 37.

### Vehicle Seat Air-Conditioning System 3

As illustrated in FIG. 6, the vehicle seat air-conditioning system 3 includes the vehicle seat air conditioner 30A, the vehicle seat air conditioner 30B, a controller 60, and an operation panel 65. The vehicle seat air conditioner 30A is a vehicle seat air conditioner used in the driver's seat 1A, and is an air conditioner capable of discharging air toward the occupant seated in the passenger seat 1B adjacent to the driver's seat 1A. The vehicle seat air conditioner 30B is a vehicle seat air conditioner used in the passenger seat 1B, and is an air conditioner capable of discharging air toward the occupant seated in the driver's seat 1A adjacent to the passenger seat 1B.

The controller 60 in the present embodiment is disposed as a higher-order system of an individual controller 71A on the driver side and an individual controller 71B on the passenger side. The controller 60 includes a microcomputer, and is electrically connected to the individual controller 71A and the individual controller 71B.

The controller 60 can control the operations of the vehicle seat air conditioner 30A and the vehicle seat air conditioner 30B by outputting control signals to the individual controller 71A and the individual controller 71B, and can make the vehicle seat air conditioner 30A and the vehicle seat air conditioner 30B work in coordination.

The operation panel 65 is electrically connected to the controller 60. The operation panel 65 is an input interface mounted on the vehicle 1000, and receives an operation input by an occupant to output, to the controller 60, setting instructions such as a temperature, an air volume, and a blowing target position of each of the vehicle seat air conditioner 30A and the vehicle seat air conditioner 30B. The operation panel 65 is a control panel for vehicle, a tablet terminal, a smartphone, or the like.

The controller 60 acquires, from the operation panel 65, the blowing target positions for the occupant seated in the driver's seat 1A and the occupant seated in the passenger seat 1B. In the present embodiment, as the blowing target position, a first portion corresponding to at least one or more of the head, neck, acromion, and back of the occupant or a second portion corresponding to at least one or more of the waist, buttocks, and thighs of the occupant is selected. The controller 60 acquires the blowing target position for the driver side and the blowing target position for the passenger side based on the operation input by the occupant on the operation panel 65.

Then, the controller 60 controls a blowing duct selection switching part 37B of the vehicle seat air conditioner 30B to select any one of the first mode and the second mode so as to blow out air to the blowing target position for the driver side, and controls the horizontal plate fins 121 of the blowing port corresponding to the selected mode to adjust the blowing direction.

Further, the controller 60 controls a blowing duct selection switching part 37A of the vehicle seat air conditioner 30A to select any one of the first mode and the second mode so as to blow out air to the blowing target position for the passenger side, and controls the horizontal plate fins 121 of the blowing port corresponding to the selected mode to adjust the blowing direction.

In the meantime, a configuration is possible in which, as the blowing target position, a first portion corresponding to at least one or more of the head, neck, acromion, and back of the occupant or a second portion that corresponds to at least one or more of the head, neck, acromion, and back of the occupant and differs from the first portion is selected. Another configuration is possible in which, as the blowing target position, a first portion corresponding to at least one or more of the waist, buttocks, and thighs of the occupant or a second portion that corresponds to at least one or more of the waist, buttocks, and thighs of the occupant and differs from the first portion is selected. Yet alternatively, the blowing target position may be selected not only from the first portion and the second portion described above but also from three or more portions including a third portion different from the first portion and the second portion.

The vehicle seat air-conditioning system 3 may be provided with a temperature sensor that detects a skin temperature of the occupant. Such a temperature sensor is, for example, a non-contact thermometer or thermography that detects the skin temperature of the occupant using infrared rays or the like. The temperature sensor may output information indicating the detected temperature to the controller 60, and the controller 60 may control the vehicle seat air conditioner 30A and the vehicle seat air conditioner 30B based on the information indicating the detected temperature instead of the operation input by the occupant on the operation panel 65.

### Processing

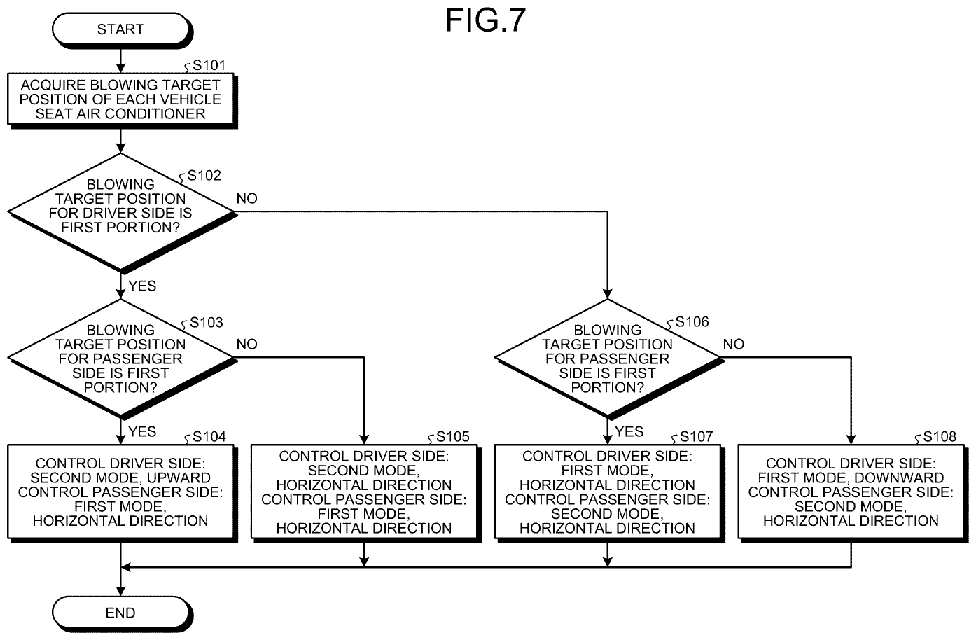

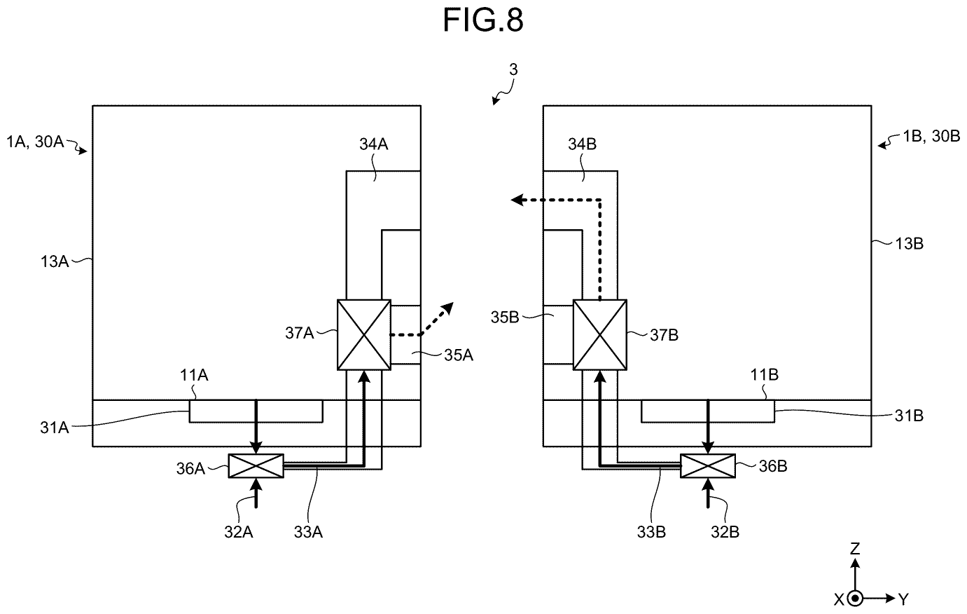

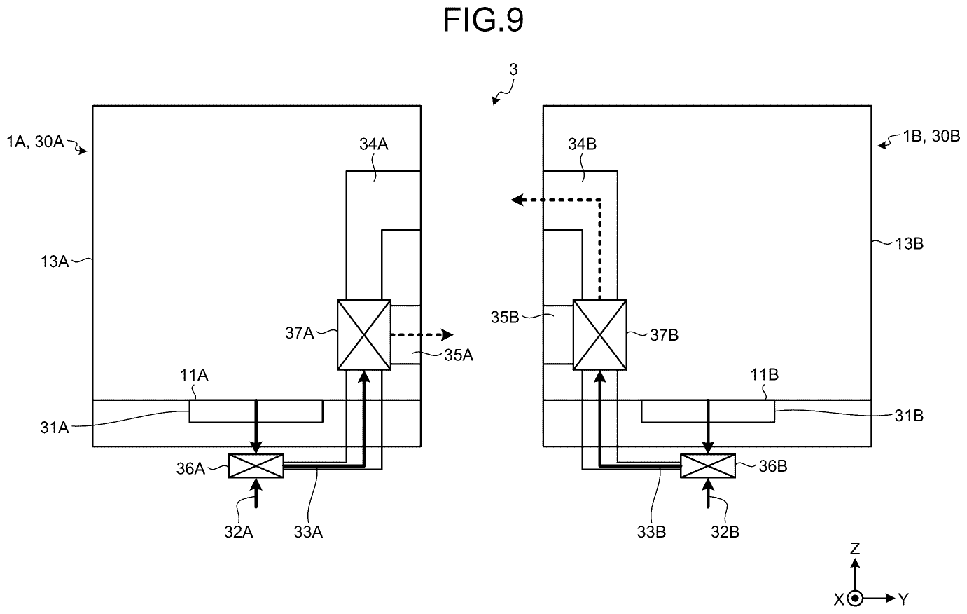

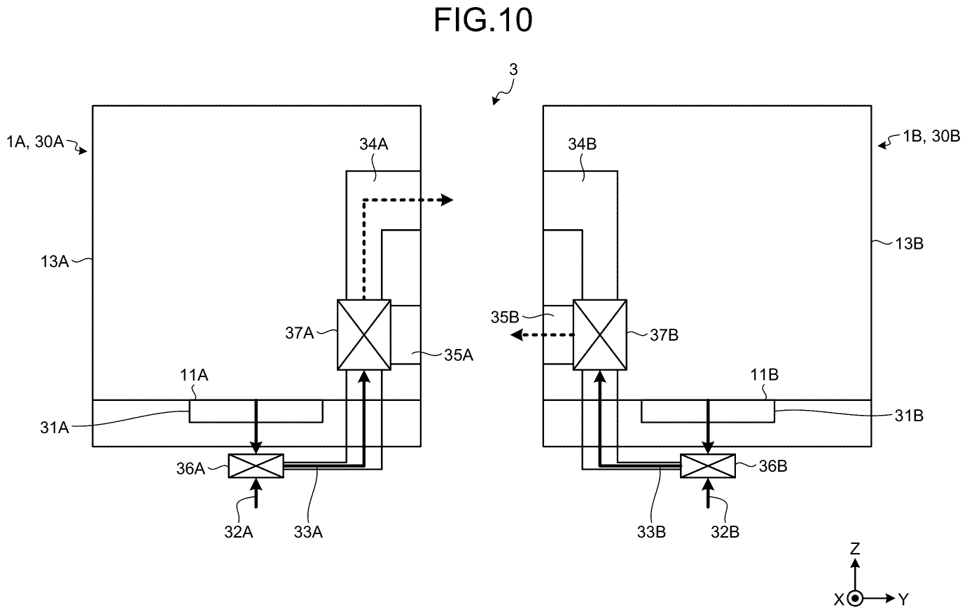

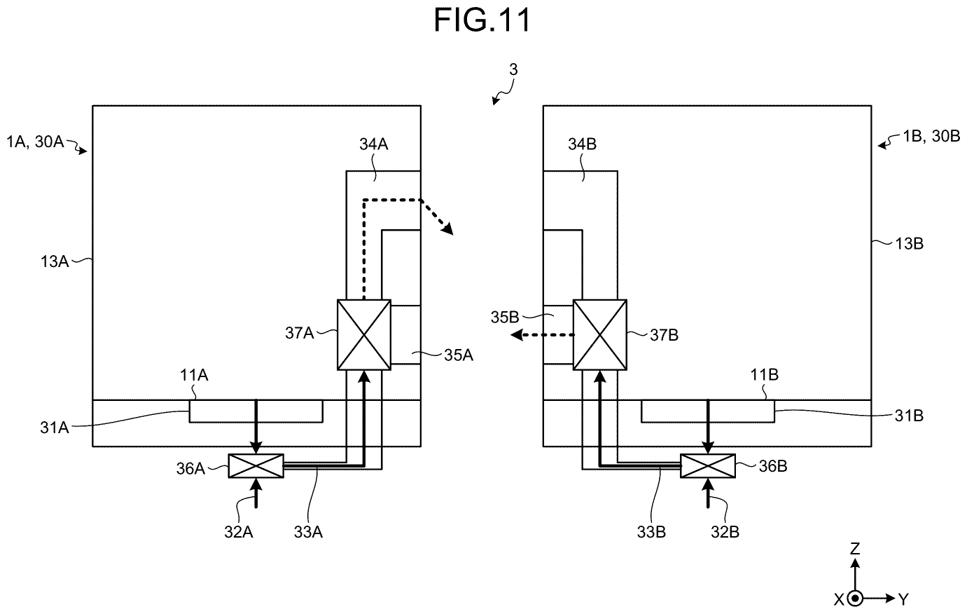

FIG. 7 is a flowchart illustrating processing of the vehicle seat air-conditioning system 3 according to the first embodiment. FIG. 8 is a schematic front view illustrating a flow path of air in the driver's seat 1A and the passenger seat 1B for a case where Step S104 in FIG. 7 is executed. FIG. 9 is a schematic front view illustrating a flow path of air in the driver's seat 1A and the passenger seat 1B for a case where Step S105 in FIG. 7 is executed. FIG. 10 is a schematic front view illustrating a flow path of air in the driver's seat 1A and the passenger seat 1B for a case where Step S107 in FIG. 7 is executed. FIG. 11 is a schematic front view illustrating a flow path of air in the driver's seat 1A and the passenger seat 1B for a case where Step S108 in FIG. 7 is executed.

In the flowchart of FIG. 7, the operation may be started when the functions of the vehicle seat air conditioner 30 provided in each of the driver's seat 1A and the passenger seat 1B are both turned on. The functions of the vehicle seat air conditioners 30 may be switched on or off in accordance with an input operation received by the operation panel 65.

First, in Step S101, the controller 60 acquires the blowing target position of each of the vehicle seat air conditioners 30, that is, the blowing target position of the vehicle seat air conditioner 30B for the driver side and the blowing target position of the vehicle seat air conditioner 30A for the passenger side. The controller 60 switches the modes of the blowing duct selection switching part 37 of each of the vehicle seat air conditioners 30 based on the acquired blowing target position of each of the vehicle seat air conditioners 30.

Specifically, in Step S102, the controller 60 determines whether the blowing target position for the driver side is the first portion. That is, the controller 60 determines whether the blowing target position of the vehicle seat air conditioner 30B is at least one or more of the head, neck, acromion, and back of the occupant seated in the driver's seat 1A.

If the controller 60 determines that the blowing target position for the driver side is the first portion (YES in S102), then the process proceeds to Step S103. In Step S103, the controller 60 determines whether the blowing target position for the passenger side is the first portion. That is, the controller 60 determines whether the blowing target position of the vehicle seat air conditioner 30A is at least one or more of the head, neck, acromion, and back of the occupant seated in the passenger seat 1B.

If the controller 60 determines that the blowing target position for the passenger side is the first portion (YES in S103), then the process proceeds to Step S104. In Step S104, the controller 60 causes the blowing duct selection switching part 37A of the driver's seat 1A to execute the second mode, and controls the horizontal plate fins 121 of the third ventilation port 12c of the driver's seat 1A to adjust the blowing direction upward. Further, the controller 60 causes the blowing duct selection switching part 37B of the passenger seat 1B to execute the first mode, and controls the horizontal plate fins 121 of the second ventilation port 12b of the passenger seat 1B to adjust the blowing direction to the horizontal direction. Then, the controller 60 ends the process and the process returns to Step S101 to repeat the process.

FIG. 8 illustrates a flow path of air in the driver's seat 1A and the passenger seat 1B for a case where Step S104 is executed. As illustrated in FIG. 8, the vehicle seat air conditioner 30A can blow air to the first portion of the occupant seated in the passenger seat 1B by discharging the sucked air upward from the second blowing port 35Aa. The vehicle seat air conditioner 30B can blow air to the first portion of the occupant seated in the driver's seat 1A by discharging the sucked air in the horizontal direction from the first blowing port 34Ba. In FIG. 8, air guided to the first intake ducts 31, the second intake ducts 32, and the air blowing ducts 33 is indicated by solid lines, and air guided to the first blowing ducts 34 or the second blowing ducts 35 is indicated by broken lines.

If the controller 60 determines that the blowing target position for the passenger side is the second portion (NO in S103), then the process proceeds to Step S105. In Step S105, the controller 60 causes the blowing duct selection switching part 37A of the driver's seat 1A to execute the second mode, and controls the horizontal plate fins 121 of the third ventilation port 12c of the driver's seat 1A to adjust the blowing direction to the horizontal direction. Further, the controller 60 causes the blowing duct selection switching part 37B of the passenger seat 1B to execute the first mode, and controls the horizontal plate fins 121 of the second ventilation port 12b of the passenger seat 1B to adjust the blowing direction to the horizontal direction. Then, the controller 60 ends the process and the process returns to Step S101 to repeat the process.

FIG. 9 illustrates a flow path of air in the driver's seat 1A and the passenger seat 1B for a case where Step S105 is executed. As illustrated in FIG. 9, the vehicle seat air conditioner 30A can blow air to the second portion of the occupant seated in the passenger seat 1B by discharging the sucked air in the horizontal direction from the second blowing port 35Aa. The vehicle seat air conditioner 30B can blow air to the first portion of the occupant seated in the driver's seat 1A by discharging the sucked air in the horizontal direction from the first blowing port 34Ba. In FIG. 9, air guided to the first intake ducts 31, the second intake ducts 32, and the air blowing ducts 33 is indicated by solid lines, and air guided to the first blowing ducts 34 or the second blowing ducts 35 is indicated by broken lines.

If the controller 60 determines that the blowing target position for the driver side is the second portion (NO in S102), then the process proceeds to Step S106. In Step S106, the controller 60 determines whether the blowing target position for the passenger side is the first portion.

If the controller 60 determines that the blowing target position for the passenger side is the first portion (YES in S106), then the process proceeds to Step S107. In Step S107, the controller 60 causes the blowing duct selection switching part 37A of the driver's seat 1A to execute the first mode, and controls the horizontal plate fins 121 of the second ventilation port 12b of the driver's seat 1A to adjust the blowing direction to the horizontal direction. Further, the controller 60 causes the blowing duct selection switching part 37B of the passenger seat 1B to execute the second mode, and controls the horizontal plate fins 121 of the third ventilation port 12c of the passenger seat 1B to adjust the blowing direction to the horizontal direction. Then, the controller 60 ends the process and the process returns to Step S101 to repeat the process.

FIG. 10 illustrates a flow path of air in the driver's seat 1A and the passenger seat 1B for a case where Step S107 is executed. As illustrated in FIG. 10, the vehicle seat air conditioner 30A can blow air to the first portion of the occupant seated in the passenger seat 1B by discharging the sucked air in the horizontal direction from the first blowing port 34Aa. The vehicle seat air conditioner 30B can blow air to the second portion of the occupant seated in the driver's seat 1A by discharging the sucked air in the horizontal direction from the second blowing port 35Ba. In FIG. 10, air guided to the first intake ducts 31, the second intake ducts 32, and the air blowing ducts 33 is indicated by solid lines, and air guided to the first blowing ducts 34 or the second blowing ducts 35 is indicated by broken lines.

If the controller 60 determines that the blowing target position for the passenger side is the second portion (NO in S106), then the process proceeds to Step S108. In Step S108, the controller 60 causes the blowing duct selection switching part 37A of the driver's seat 1A to execute the first mode, and controls the horizontal plate fins 121 of the second ventilation port 12b of the driver's seat 1A to adjust the blowing direction downward. Further, the controller 60 causes the blowing duct selection switching part 37B of the passenger seat 1B to execute the second mode, and controls the horizontal plate fins 121 of the third ventilation port 12c of the passenger seat 1B to adjust the blowing direction to the horizontal direction. Then, the controller 60 ends the process and the process returns to Step S101 to repeat the process.

FIG. 11 illustrates a flow path of air in the driver's seat 1A and the passenger seat 1B for a case where Step S108 is executed. As illustrated in FIG. 11, the vehicle seat air conditioner 30A can blow air to the second portion of the occupant seated in the passenger seat 1B by discharging the sucked air downward from the first blowing port 34Aa. The vehicle seat air conditioner 30B can blow air to the second portion of the occupant seated in the driver's seat 1A by discharging the sucked air in the horizontal direction from the second blowing port 35Ba. In FIG. 11, air guided to the first intake ducts 31, the second intake ducts 32, and the air blowing ducts 33 is indicated by solid lines, and air guided to the first blowing ducts 34 or the second blowing ducts 35 is indicated by broken lines.

In this process, the order of the determination processes may be appropriately changed in Steps S102, S103, and S106. For example, the controller 60 may determine whether the blowing target position for the passenger side is the first portion in Step S102, and may determine whether the blowing target position for the driver side is the first portion in Steps S103 and S106.

In Steps S104, S105, S107, and S108, the control of each of the vehicle seat air conditioners 30 is not limited to the above-described control. For example, in Step S104, the controller 60 may control the vehicle seat air conditioner 30A so that the sucked air is blown out in the horizontal direction from the first blowing port 34Aa, and may control the vehicle seat air conditioner 30B so that the sucked air is blown out upward from the second blowing port 35Ba.

In Step S105, the controller 60 may control the vehicle seat air conditioner 30A so that the sucked air is blown out downward from the first blowing port 34Aa, and may control the vehicle seat air conditioner 30B so that the sucked air is blown out in the horizontal direction from the first blowing port 34Ba. Alternatively, the controller 60 may control the vehicle seat air conditioner 30A so that the sucked air is blown out in the horizontal direction from the second blowing port 35Aa, and may control the vehicle seat air conditioner 30B so that the sucked air is blown out upward from the second blowing port 35Ba.

Further, in Step S107, the controller 60 may control the vehicle seat air conditioner 30A so that the sucked air is blown out upward from the second blowing port 35Aa, and may control the vehicle seat air conditioner 30B so that the sucked air is blown out in the horizontal direction from the second blowing port 35Ba. Alternatively, the vehicle seat air conditioner 30A may be controlled so that the sucked air is blown out in the horizontal direction from the first blowing port 34Aa, and the vehicle seat air conditioner 30B may be controlled so that the sucked air is blown out downward from the first blowing port 34Ba.

In Step S108, the controller 60 may control the vehicle seat air conditioner 30A so that the sucked air is blown out in the horizontal direction from the second blowing port 35Aa, and may control the vehicle seat air conditioner 30B so that the sucked air is blown out downward from the first blowing port 34Ba.

Here, in Steps S104, S105, S107, and S108, the controller 60 may perform control to switch the blowing direction and the modes of the blowing duct selection switching part 37 at predetermined time intervals.

For example, in Step S104, the controller 60 may perform control to switch between the following two types of control at predetermined time intervals: controlling the vehicle seat air conditioner 30A so that the sucked air is blown out upward from the second blowing port 35Aa and the vehicle seat air conditioner 30B so that the sucked air is blown out in the horizontal direction from the first blowing port 34Ba; and controlling the vehicle seat air conditioner 30A so that the sucked air is blown out in the horizontal direction from the first blowing port 34Aa and the vehicle seat air conditioner 30B so that the sucked air is blown out upward from the second blowing port 35Ba. The predetermined time is an arbitrary time between five seconds and ten seconds, for example. The predetermined time herein may be changed depending on a temperature environment in the vehicle interior, an instruction of an occupant, a driving situation, and the like. The predetermined time may be an irregular interval having fluctuation characteristics. The fluctuation characteristic is, for example, a 1/f fluctuation characteristic.

Further, in Step S105, the controller 60 may perform control to switch between the following two types of control at predetermined time intervals: controlling the vehicle seat air conditioner 30A so that the sucked air is blown out in the horizontal direction from the second blowing port 35Aa and the vehicle seat air conditioner 30B so that the sucked air is blown out in the horizontal direction from the first blowing port 34Ba; and controlling the vehicle seat air conditioner 30A so that the sucked air is blown out downward from the first blowing port 34Aa and the vehicle seat air conditioner 30B so that the sucked air is blown out in the horizontal direction from the first blowing port 34Ba.

Alternatively, the controller 60 may perform control to switch, at predetermined time intervals, between any one of the above controlling and controlling the vehicle seat air conditioner 30A so that the sucked air is blown out in the horizontal direction from the second blowing port 35Aa and the vehicle seat air conditioner 30B so that the sucked air is blown out upward from the second blowing port 35Ba.

Further, in Step S107, the controller 60 may perform control to switch between the following two types of control at predetermined time intervals: controlling the vehicle seat air conditioner 30A so that the sucked air is blown out in the horizontal direction from the first blowing port 34Aa and the vehicle seat air conditioner 30B so that the sucked air is blown out in the horizontal direction from the second blowing port 35Ba; and controlling the vehicle seat air conditioner 30A so that the sucked air is blown out upward from the second blowing port 35Aa and the vehicle seat air conditioner 30B so that the sucked air is blown out in the horizontal direction from the second blowing port 35Ba.

Alternatively, the controller 60 may perform control to switch, at predetermined time intervals, between any one of the above controlling and controlling the vehicle seat air conditioner 30A so that the sucked air is blown out in the horizontal direction from the first blowing port 34Aa and the vehicle seat air conditioner 30B so that the sucked air is blown out downward from the first blowing port 34Ba.

Further, in Step S108, the controller 60 may perform control to switch between the following two types of control at predetermined time intervals: controlling the vehicle seat air conditioner 30A so that the sucked air is blown out downward from the first blowing port 34Aa and the vehicle seat air conditioner 30B so that the sucked air is blown out in the horizontal direction from the second blowing port 35Ba; and controlling the vehicle seat air conditioner 30A so that the sucked air is blown out in the horizontal direction from the second blowing port 35Aa and the vehicle seat air conditioner 30B so that the sucked air is blown out downward from the first blowing port 34Ba.

### Functional Effects

Next, the functional effects of the vehicle seat air-conditioning system 3 according to the present embodiment will be described.

As described above, the vehicle seat air-conditioning system 3 of the present embodiment includes the vehicle seat air conditioner 30 provided in each of the plurality of seats 1 of the vehicle 1000, and the controller 60 that controls the vehicle seat air conditioners 30. The vehicle seat air conditioners 30 each include the blower 36 and the blowing ducts (including the first blowing duct 34 and the second blowing duct 35) that guide air guided by the blower 36 to the blowing ports (including the first blowing port 34a and the second blowing port 35a) provided on a side surface of the seat 1. Then, the controller 60 acquires the blowing target position of air from each of the vehicle seat air conditioners 30, and controls, based on the blowing target position, at least one of the time at which air is blown out from the blowing port, the blowing direction of the air, and the selection of the blowing port from which the air is blown out.

The configuration can reduce interference between the air blown out from each of the vehicle seat air conditioners 30. Therefore, the vehicle seat air conditioner 30 used in each seat 1 can blow out air more reliably toward the blowing target position of the occupant seated in the adjacent seat, and can provide a more comfortable air-conditioned environment for that occupant.

More specifically, the plurality of vehicle seat air conditioners 30 of the present embodiment are the vehicle seat air conditioner 30A and the vehicle seat air conditioner 30B respectively used in the driver's seat 1A and the passenger seat 1B, which are two seats 1 adjacent in the left-right direction of the vehicle 1000. The blowing port is provided on each of the side surface of the driver's seat 1A facing the passenger seat 1B and the side surface of the passenger seat 1B facing the driver's seat 1A. The controller 60 sets, based on the blowing target position, selection of the blowing direction and the blowing port from which air is blown out so as to reduce interference between the air blown out from the blowing ports provided in the driver's seat 1A and the passenger seat 1B.

The configuration can reduce interference between the air blown out from the vehicle seat air conditioner 30A and the air blown out from the vehicle seat air conditioner 30B used respectively in the driver's seat 1A and the passenger seat 1B that are adjacent in the left-right direction of the vehicle 1000.

In particular, the blowing port of the seat 1 is disposed on the side surface of the seat 1 facing the adjacent seat; therefore, the blowing port can be provided in a location where an airbag or the like is not provided. As a result, air conditioning can be performed without hindering the operation of the airbag or the like, and air can be blown out more reliably toward the blowing target position of the occupant seated in the adjacent seat.

Further, the vehicle seat air conditioner 30 provided in the seat 1 performs air-conditioning for the adjacent seat; therefore, the vehicle seat air conditioner 30 is hardly affected by the physique and clothing of the occupant seated in the adjacent seat, and is easy to blow out air toward the blowing target position of the occupant seated in the adjacent seat.

In the vehicle seat air-conditioning system 3 of the present embodiment, the plurality of blowing ports are provided in each of the driver's seat 1A and the passenger seat 1B. The blowing ducts include the first blowing duct 34 and the second blowing duct 35 that blow out air guided by the blower 36 from each of the first blowing port 34a and the second blowing port 35a that are the plurality of blowing ports. The vehicle seat air conditioners 30 each further include the blowing duct selection switching part 37 that selects a ventilation path. The blowing duct selection switching part 37 has the first mode for guiding the air guided by the blower 36 to the first blowing duct 34 and the second mode for guiding the air guided by the blower 36 to the second blowing duct 35. The controller 60 switches, based on the blowing target position, between the modes of the first mode and the second mode of the blowing duct selection switching part 37 for each of the driver's seat 1A and the passenger seat 1B to control selection of the blowing port from which air is blown out.

The configuration can reduce interference between the air blown out from the vehicle seat air conditioner 30A and the air blown out from the vehicle seat air conditioner 30B even in a case where each of the driver's seat 1A and the passenger seat 1B is provided with a plurality of blowing ports.

The second blowing port 35a is provided below the first blowing port 34a.

According to the configuration, the controller 60 can select a mode corresponding to any one of the first blowing port 34a and the second blowing port 35a arranged to be shifted in the vertical direction, which makes it possible to further reduce interference between the air blown out from the vehicle seat air conditioner 30A and the air blown out from the vehicle seat air conditioner 30B.

Further, the blowing target position is selected from among a plurality of portions of the occupant seated in the adjacent seat including the first portion of the occupant and the second portion, which is below the first portion, of the occupant. The controller 60 controls the blowing direction and the mode of the blowing duct selection switching part 37 based on the blowing target position.

According to the configuration, the controller 60 can blow out air more reliably toward the first portion, the second portion, or the like of the occupant seated in the adjacent seat while reducing interference between the air blown out from the vehicle seat air conditioner 30A and the air blown out from the vehicle seat air conditioner 30B, so that a comfortable air-conditioned environment can be provided for that occupant.

The controller 60 further switches, based on the blowing target position, the blowing direction and the modes of the blowing duct selection switching part 37 at predetermined time intervals.

The configuration makes it possible to provide a more comfortable air-conditioned environment for the occupant seated in the seat while reducing interference between the air blown out from the vehicle seat air conditioner 30A and the air blown out from the vehicle seat air conditioner 30B. More specifically, in a case where air is continuously blown out to the occupant from the same blowing port in the same blowing direction, the occupant may feel uncomfortable because a certain body part is excessively cooled. However, according to this control, it is possible to reduce the discomfort of the occupant and provide a more comfortable air-conditioned environment for the occupant.

At this time, the controller 60 may switch the blowing direction of both the vehicle seat air conditioner 30A and the vehicle seat air conditioner 30B and the modes of the blowing duct selection switching part 37 at predetermined time intervals, or may switch only one of the blowing direction and the modes of the blowing duct selection switching part 37 at predetermined time intervals. The configuration can reduce the discomfort of at least one of the occupant seated in the driver's seat 1A and the occupant seated in the passenger seat 1B, and provide a more comfortable air-conditioned environment for that occupant.

Here, a vehicle seat air-conditioning system according to a comparative example will be described.

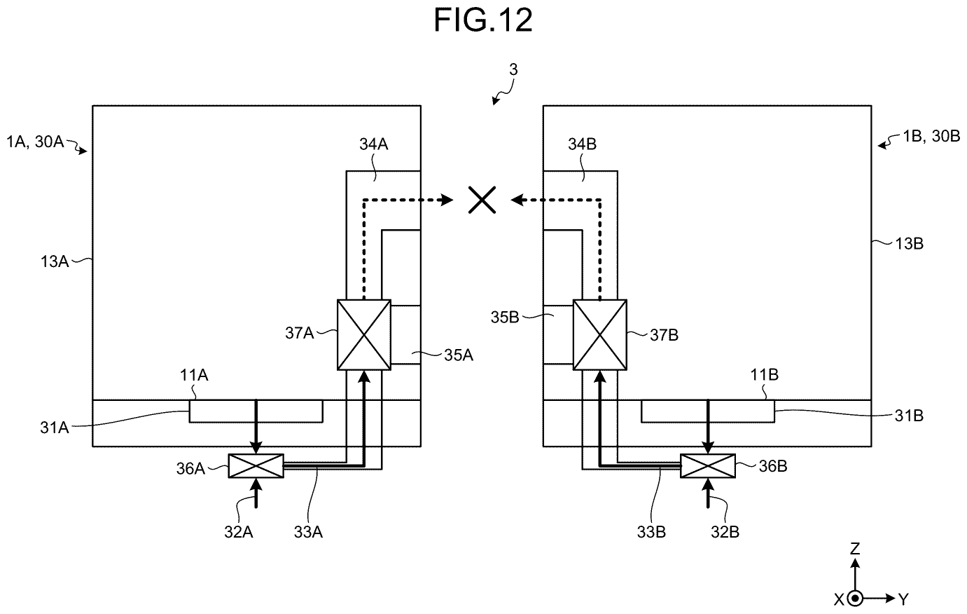

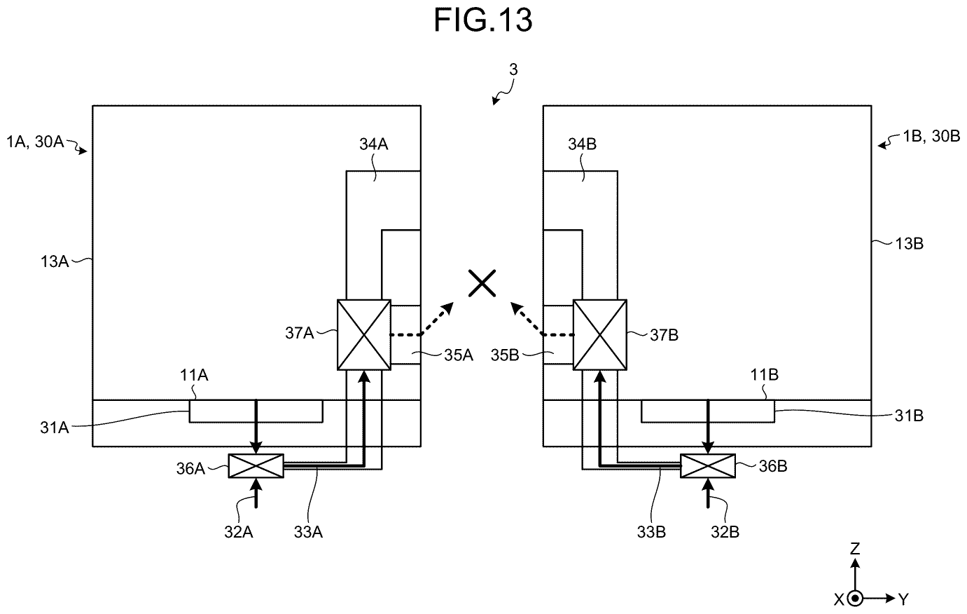

FIGS. 12 and 13 are schematic front views illustrating a flow path of air in the driver's seat 1A and the passenger seat 1B for a case where a comparative example in Step S104 in FIG. 7 is executed.

Referring to the comparative example in FIG. 12, the vehicle seat air conditioner 30A blows out sucked air in the horizontal direction from the first blowing port 34Aa, and the vehicle seat air conditioner 30B blows out sucked air in the horizontal direction from the first blowing port 34Ba. In this case, the air blown out from each of the vehicle seat air conditioners 30 interferes with each other, and the air is dispersed or the wind axis of the air is bent, resulting in turbulence in the airflow. This probably reduces air to be blown out to the first portion of the occupant seated in the driver's seat 1A and the first portion of the occupant seated in the passenger seat 1B.

Referring to the comparative example in FIG. 13, the vehicle seat air conditioner 30A blows out sucked air upward from the second blowing port 35Aa, and the vehicle seat air conditioner 30B blows out sucked air upward from the second blowing port 35Ba. In this case also, the air blown out from each of the vehicle seat air conditioners 30 interferes with each other, and the air is dispersed or the wind axis of the air is bent, resulting in turbulence in the airflow. This probably reduces air to be blown out to the first portion of the occupant seated in the driver's seat 1A and the first portion of the occupant seated in the passenger seat 1B.

In contrast to the comparative examples, in the vehicle seat air-conditioning system 3 of the present embodiment, the blowing direction and the modes of the blowing duct selection switching part 37 can be controlled based on the blowing target position, so that interference between the air blown out from each of the vehicle seat air conditioners 30 can be reduced. Therefore, the vehicle seat air conditioners 30 each can blow out air more reliably toward the blowing target position of the occupant seated in the adjacent seat, and can provide a comfortable air-conditioned environment for that occupant.

### First Modification of First Embodiment

The present modification is different from the vehicle seat air-conditioning system of the first embodiment in that one blowing port 134a is provided on a side surface of the seat back 13 of each seat 1. That is, while the first blowing port 34a and the second blowing port 35a are provided in each seat 1 in the first embodiment, one blowing port 134a is provided in the present modification. Further, vehicle seat air conditioners 130 included in a vehicle seat air-conditioning system 3a of the present modification does not include a blowing duct selection switching part. The other configurations in the present modification are similar to those in the first embodiment, and the same configurations and functions are denoted by the same reference numerals, and detailed description of the configurations and functions is omitted.

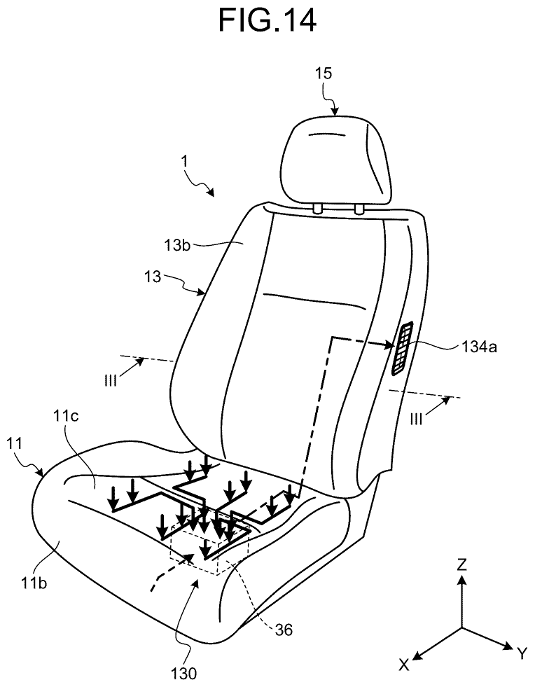

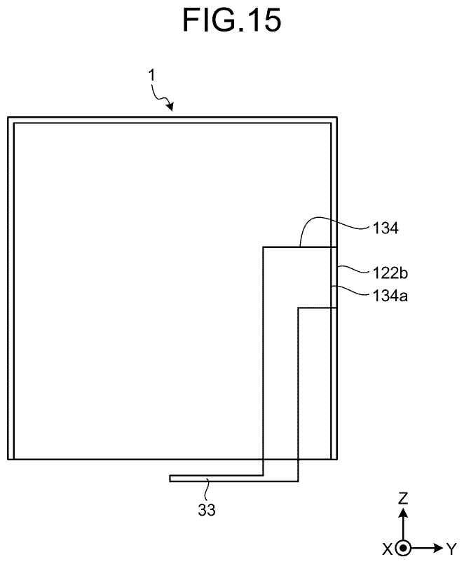

FIG. 14 is a perspective view illustrating the appearance of the seat 1 provided with the vehicle seat air conditioner 130 according to the first modification of the first embodiment. In FIG. 14, a dashed arrow corresponds to air guided to the second intake duct 32, and an alternate long and short dash arrow corresponds to air guided to a blowing duct 134. FIG. 15 is a cross-sectional view of the seat 1 provided with the vehicle seat air conditioner 130 taken along line III-III in FIG. 14.

As illustrated in FIGS. 14 and 15, in the present modification, the second seat pad 13a of the seat back 13 is provided with a part of the air blowing duct 33 for discharging air sucked from the second intake port 32a, the blowing duct 134, and the like. The second seat cover 13b is formed with a fourth ventilation port 112b for discharging sucked air. The fourth ventilation port 112b is provided at a position corresponding to the blowing port 134a of the blowing duct 134 on the side surface of the seat back 13 facing a seat adjacent to the seat 1. The configuration of the fourth ventilation port 112b is similar to that of the second ventilation port 12b and the third ventilation port 12c in the first embodiment. In the present modification, the fourth ventilation port 112b is formed in a part of the second seat cover 13b corresponding to the back of the occupant seated in the seat adjacent to the seat 1.

A blowing port 134Aa provided in the driver's seat 1A is provided at a height corresponding to a blowing port 134Ba provided in the passenger seat 1B. The corresponding height refers to an equivalent height, but is not limited to exactly the same height.

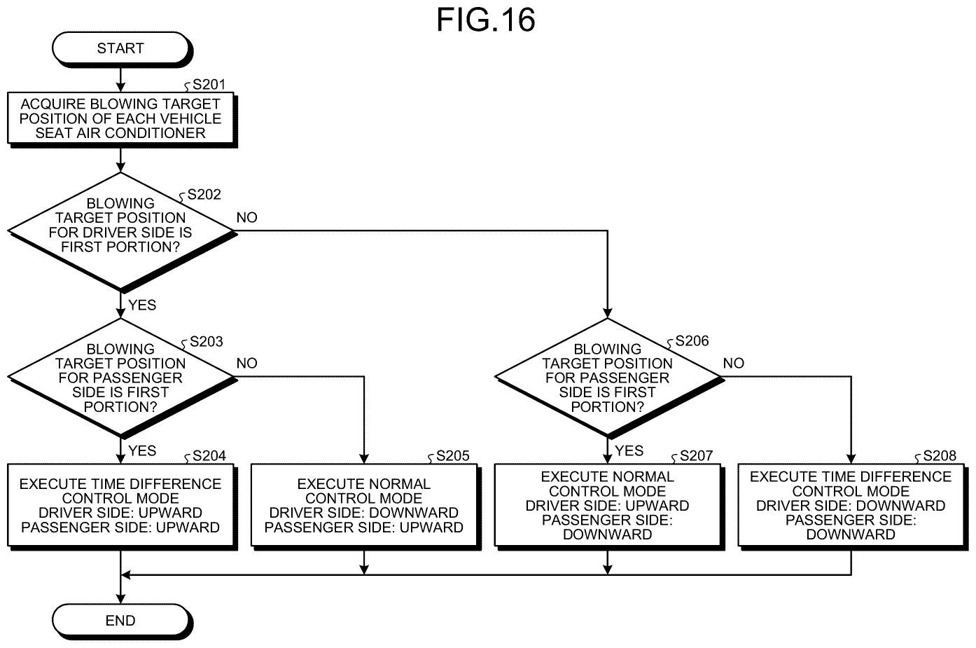

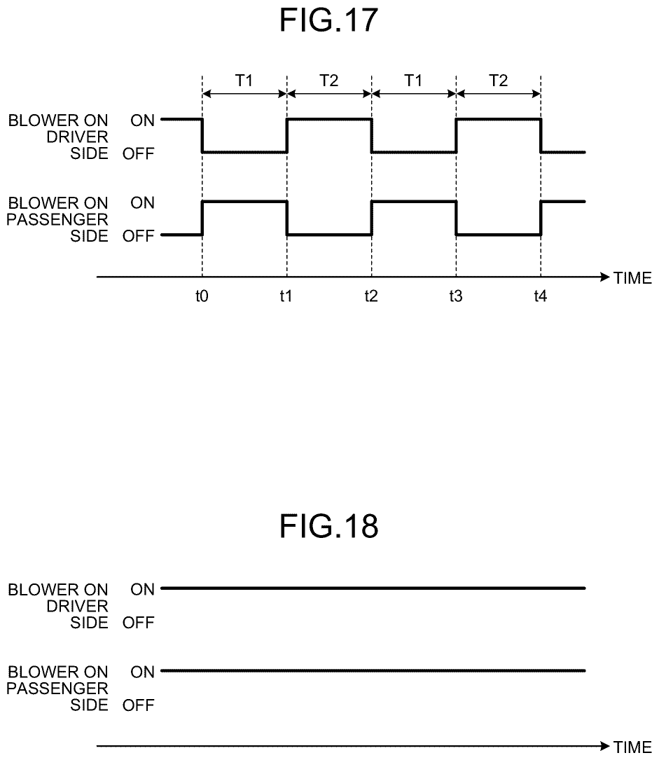

FIG. 16 is a flowchart illustrating processing of the vehicle seat air-conditioning system 3a according to the first modification of the first embodiment. FIG. 17 is a schematic diagram illustrating a time difference control mode according to the first modification of the first embodiment. FIG. 18 is a schematic diagram illustrating a normal control mode according to the first modification of the first embodiment.

In the flowchart of FIG. 16, the operation may be started when the functions of the vehicle seat air conditioner 130 provided in each of the driver's seat 1A and the passenger seat 1B are both turned on. The functions of the vehicle seat air conditioners 130 may be switched on or off in accordance with an input operation received by the operation panel 65.

First, in Step S201, the controller 60 acquires the blowing target position of each of the vehicle seat air conditioners 130, that is, the blowing target position of a vehicle seat air conditioner 130B for the driver side and the blowing target position of a vehicle seat air conditioner 130A for the passenger side. The controller 60 controls the blower 36 of each of the vehicle seat air conditioners 130 based on the acquired blowing target position of each of the vehicle seat air conditioners 130.

Specifically, in Step S202, the controller 60 determines whether the blowing target position for the driver side is the first portion. That is, the controller 60 determines whether the blowing target position of the vehicle seat air conditioner 130B is at least one or more of the head, neck, acromion, and back of the occupant seated in the driver's seat 1A.

If the controller 60 determines that the blowing target position for the driver side is the first portion (YES in S202), then the process proceeds to Step S203. In Step S203, the controller 60 determines whether the blowing target position for the passenger side is the first portion. That is, the controller 60 determines whether the blowing target position of the vehicle seat air conditioner 130A is at least one or more of the head, neck, acromion, and back of the occupant seated in the passenger seat 1B.

If the controller 60 determines that the blowing target position for the passenger side is the first portion (YES in S203), then the process proceeds to Step S204. In Step S204, the controller 60 controls the horizontal plate fins 121 of the fourth ventilation port 112b of the driver's seat 1A to adjust the blowing direction upward, and controls the horizontal plate fins 121 of the fourth ventilation port 112b of the passenger seat 1B to adjust the blowing direction upward. Further, the controller 60 controls the blower 36 of each seat 1 to execute the time difference control mode. Then, the controller 60 ends the process and the process returns to Step S201 to repeat the process.

Here, the time difference control mode will be described with reference to FIG. 17. In FIG. 17, the horizontal axis represents a time axis, and times t0 to t4 are times set at predetermined intervals. The predetermined interval is, for example, ten seconds. A period between time t0 and time t1 and a period between time t2 and time t3 each are defined as a first period T1, and a period between time t1 and time t2 and a period between time t3 and time t4 each are defined as a second period T2. That is, each of the first period T1 and the second period T2 is a period corresponding to the predetermined interval, and the first period T1 and the second period T2 are periods set alternately and continuously. Note that the first period T1 and the second period T2 do not have to be set continuously. For example, an interval may be provided between the first period T1 and the second period T2. Alternatively, the second period T2 may be started from the middle of the first period T1.

As illustrated in FIG. 17, in the first period T1, the controller 60 turns off the blower 36A of the driver's seat 1A and turns on the blower 36B of the passenger seat 1B. Then, in the second period T2, the controller 60 turns on the blower 36A of the driver's seat 1A and turns off the blower 36B of the passenger seat 1B. Thereafter, the controller 60 repeats the control of the first period T1 and the second period T2. In this manner, the controller 60 executes the time difference control mode by shifting the first period T1 in which the blower 36B of the passenger seat 1B is turned on from the second period T2 in which the blower 36A of the driver's seat 1A is turned on.

If the controller 60 determines that the blowing target position for the passenger side is the second portion (NO in S203), then the process proceeds to Step S205. In Step S205, the controller 60 controls the horizontal plate fins 121 of the fourth ventilation port 112b of the driver's seat 1A to adjust the blowing direction downward, and controls the horizontal plate fins 121 of the fourth ventilation port 112b of the passenger seat 1B to adjust the blowing direction upward. At this time, the controller 60 controls the blower 36 of each seat 1 to execute the normal control mode. As illustrated in FIG. 18, the normal control mode is a mode in which the blower 36A of the driver's seat 1A and the blower 36B of the passenger seat 1B are simultaneously turned on and operated without shifting the period in which the blower 36A is turned on from the period in which the blower 36B is turned on. Then, the controller 60 ends the process and the process returns to Step S201 to repeat the process.

If the controller 60 determines that the blowing target position for the driver side is the second portion (NO in S202), then the process proceeds to Step S206. In Step S206, the controller 60 determines whether the blowing target position for the passenger side is the first portion.

If the controller 60 determines that the blowing target position for the passenger side is the first portion (YES in S206), then the process proceeds to Step S207. In Step S207, the controller 60 controls the horizontal plate fins 121 of the fourth ventilation port 112b of the driver's seat 1A to adjust the blowing direction upward, and controls the horizontal plate fins 121 of the fourth ventilation port 112b of the passenger seat 1B to adjust the blowing direction downward. At this time, the controller 60 controls the blower 36 of each seat 1 to execute the normal control mode. Then, the controller 60 ends the process and the process returns to Step S201 to repeat the process.

If the controller 60 determines that the blowing target position for the passenger side is the second portion (NO in S206), then the process proceeds to Step S208. In Step S208, the controller 60 controls the horizontal plate fins 121 of the fourth ventilation port 112b of the driver's seat 1A to adjust the blowing direction downward, and controls the horizontal plate fins 121 of the fourth ventilation port 112b of the passenger seat 1B to adjust the blowing direction downward. Further, the controller 60 controls the blower 36 of each seat 1 to execute the time difference control mode. Then, the controller 60 ends the process and the process returns to Step S201 to repeat the process.

As described above, in the vehicle seat air-conditioning system 3a of the present modification, one blowing port is provided in each of the driver's seat 1A and the passenger seat 1B. The controller 60 shifts, based on the blowing target position, the time at which air is blown out from the blowing port 134a provided in each of the driver's seat 1A and the passenger seat 1B.

Accordingly, even in a case where one blowing port is provided in each of the driver's seat 1A and the passenger seat 1B, it is possible to reduce interference between the air blown out from the vehicle seat air conditioner 130A and the air blown out from the vehicle seat air conditioner 130B.

The controller 60 determines, based on the blowing target position, whether the air blown out from the blowing port 134a provided in the driver's seat 1A and the air blown out from the blowing port 134a provided in the passenger seat 1B interfere with each other. In a case where it is determined that the interference occurs, the controller 60 controls the vehicle seat air conditioner 130A provided in the driver's seat 1A so that air is blown out, in a first time zone, from the blowing port 134Aa of the driver's seat 1A and no air is blown out in a second time zone different from the first time zone, and controls the vehicle seat air conditioner 130B provided in the passenger seat 1B so that air is blown out, in the second time zone, from the blowing port 134Ba of the passenger seat 1B and no air is blown out in the first time zone.

This can make the time at which air is blown out from the blowing port 134Aa of the driver's seat 1A different from the time at which air is blown out from the blowing port 134Ba of the passenger seat 1B. This can reduce interference between the air blown out from the vehicle seat air conditioner 130A and the air blown out from the vehicle seat air conditioner 130B.

The first time zone is a time zone following the second time zone, and the second time zone is a time zone following the first time zone.

According to this, in the first time zone and the second time zone which are consecutive time zones, it is possible to reduce interference between the air blown out from the vehicle seat air conditioner 130A and the air blown out from the vehicle seat air conditioner 130B.

Further, the blowing target position is selected from among a plurality of portions of the occupant seated in the adjacent seat including the first portion of the occupant and the second portion, which is below the first portion, of the occupant. The controller 60 controls at least one of the blowing timing and the blowing direction based on the blowing target position.

According to the configuration, the controller 60 can blow out air more reliably toward the first portion or the second portion of the occupant seated in the adjacent seat while reducing interference between the air blown out from the vehicle seat air conditioner 130A and the air blown out from the vehicle seat air conditioner 130B, so that a comfortable air-conditioned environment can be provided for that occupant.

The blowing port 134Aa of the driver's seat 1A and the blowing port 134Ba of the passenger seat 1B are provided at heights corresponding to each other. In a case where both the blowing target positions of the vehicle seat air conditioners 130 are the first portions or the second portions, the controller 60 determines that air blown out from the blowing port 134a of the driver's seat 1A and air blown out from the blowing port 134a of the passenger seat 1B interfere with each other.

According to this, in a case where both the blowing target positions of the vehicle seat air conditioners 130 are the first portions or the second portions, it is possible to make the time at which air is blown out from the blowing port 134Aa of the driver's seat 1A different from the time at which air is blown out from the blowing port 134Ba of the passenger seat 1B. This can reduce interference between the air blown out from the vehicle seat air conditioner 130A and the air blown out from the vehicle seat air conditioner 130B.

For example, when the normal control mode is executed for a case where the blowing target position for the driver side and the blowing target position for the passenger side are both the first portions or are both the second portions, air blown out from the blowing port 134Aa of the driver's seat 1A and air blown out from the blowing port 134Ba of the passenger seat 1B interfere with each other, which may cause turbulence in the airflow. This sometimes reduces the volume of air to be blown out to the blowing target positions of the occupant seated in the driver's seat 1A and the occupant seated in the passenger seat 1B.

Accordingly, in the present modification, in a case where the blowing target position for the driver side and the blowing target position for the passenger side are both the first portions or are both the second portions, the controller 60 executes the time difference control mode. As a result, it is possible to reduce interference between air blown out from the blowing port 134Aa of the driver's seat 1A and air blown out from the blowing port 134Ba of the passenger seat 1B.

Then, air can be blown out more reliably to the blowing target positions of the occupant seated in the driver's seat 1A and the occupant seated in the passenger seat 1B, and a more comfortable air-conditioned environment can be provided for those occupants.

On the other hand, in a case where one of the blowing target position for the driver side and the blowing target position for the passenger side is the first portion and the other is the second portion, the controller 60 executes the normal control mode. In other words, in a case where it can be recognized that air blown out from the blowing port 134Aa of the driver's seat 1A and air blown out from the blowing port 134Ba of the passenger seat 1B are unlikely to interfere with each other, the controller 60 does not execute the time difference control mode.

### Second Modification of First Embodiment

The present modification is different from the vehicle seat air conditioner and the like according to the first embodiment in that there is no controller for the vehicle seat air-conditioning system and an individual controller 271 independently controls a vehicle seat air conditioner 230. The other configurations in the present modification are similar to those in the first embodiment and the like, and the same configurations and functions are denoted by the same reference numerals, and detailed description of the configurations and functions is omitted. In particular, the configuration of the vehicle seat air conditioner 230 according to the present modification is similar to the configuration of the vehicle seat air conditioner 30 according to the first embodiment illustrated in FIGS. 2 to 4.

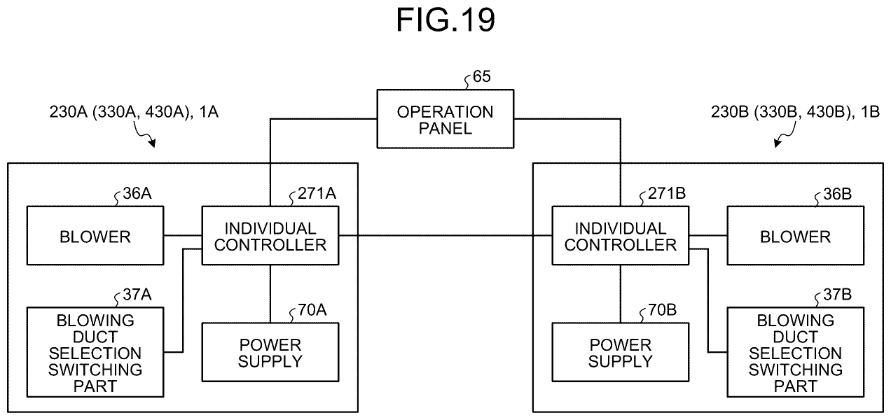

FIG. 19 is a block diagram illustrating the vehicle seat air conditioner 230 according to the second modification of the first embodiment.

As illustrated in FIG. 19, the operation panel 65 is electrically connected to an individual controller 271A included in a vehicle seat air conditioner 230A used in the driver's seat 1A. The individual controller 271A acquires, from the operation panel 65, the blowing target position for the occupant seated in the passenger seat 1B. The individual controller 271A acquires the blowing target position for the occupant seated in the driver's seat 1A from an individual controller 271B included in a vehicle seat air conditioner 230B used in the passenger seat 1B. The individual controller 271A may acquire, from the operation panel 65, the blowing target position for the occupant seated in the driver's seat 1A.

The individual controller 271A then controls the blowing duct selection switching part 37A of the vehicle seat air conditioner 230A to select any one of the first mode and the second mode so as to blow out air to the blowing target position for the passenger side, and controls the horizontal plate fins 121 of the blowing port corresponding to the selected mode to adjust the blowing direction. Note that the individual controller 271 can correspond to a “controller” in the appended claims.

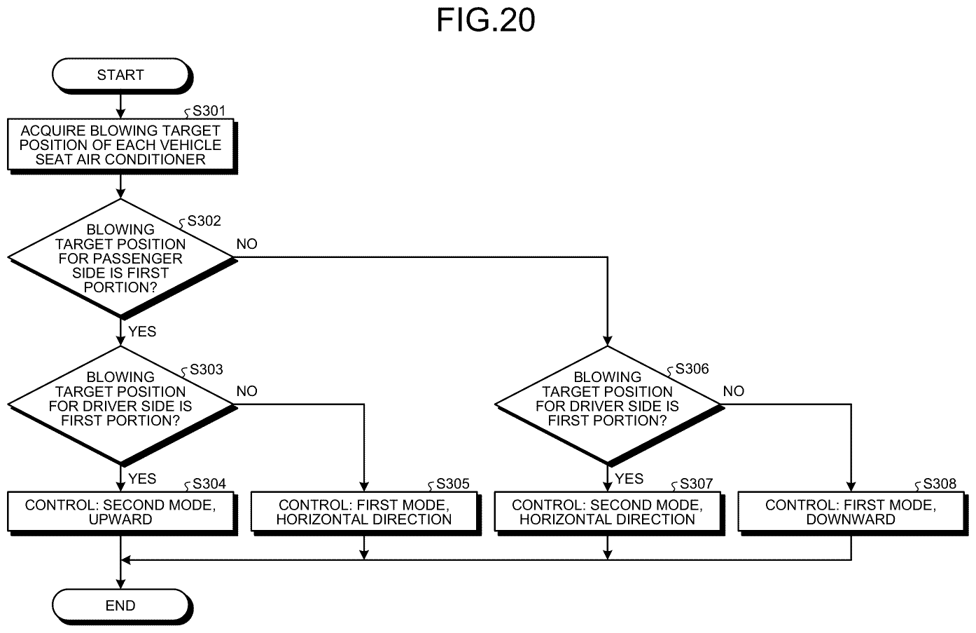

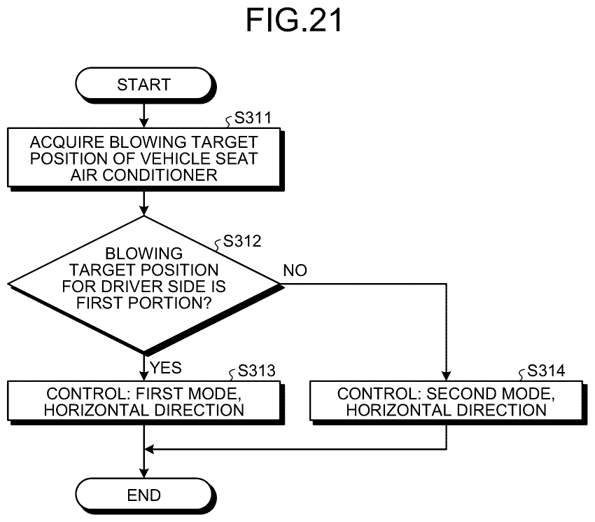

FIG. 20 is a flowchart illustrating processing of the vehicle seat air conditioner 230A according to the second modification of the first embodiment. FIG. 21 is a flowchart illustrating processing of the vehicle seat air conditioner 230B according to the second modification of the first embodiment.

In the flowcharts of FIGS. 20 and 21, the operation may be started when the functions of the vehicle seat air conditioner 230 provided in each of the driver's seat 1A and the passenger seat 1B are both turned on. The functions of the vehicle seat air conditioners 230 may be switched on or off in accordance with an input operation received by the operation panel 65.

As illustrated in FIG. 20, the individual controller 271A of the vehicle seat air conditioner 230A, first, in Step S301, acquires the blowing target position of each of the vehicle seat air conditioners 230, that is, the blowing target position of the vehicle seat air conditioner 230B for the driver side and the blowing target position of the vehicle seat air conditioner 230A for the passenger side. The individual controller 271A switches the modes of the blowing duct selection switching part 37A of the vehicle seat air conditioner 230A based on the acquired blowing target position of each of the vehicle seat air conditioners 230.

Specifically, in Step S302, the individual controller 271A determines whether the blowing target position for the passenger side is the first portion. That is, the individual controller 271A determines whether the blowing target position of the vehicle seat air conditioner 230A is at least one or more of the head, neck, acromion, and back of the occupant seated in the passenger seat 1B.

If the individual controller 271A determines that the blowing target position for the passenger side is the first portion (YES in S302), then the process proceeds to Step S303. In Step S303, the individual controller 271A determines whether the blowing target position for the driver side is the first portion. That is, the individual controller 271A determines whether the blowing target position of the vehicle seat air conditioner 230B is at least one or more of the head, neck, acromion, and back of the occupant seated in the driver's seat 1A.

If the individual controller 271A determines that the blowing target position for the driver side is the first portion (YES in S303), then the process proceeds to Step S304. In Step S304, the individual controller 271A causes the blowing duct selection switching part 37A of the driver's seat 1A to execute the second mode, and controls the horizontal plate fins 121 of the third ventilation port 12c of the driver's seat 1A to adjust the blowing direction upward. Then, the individual controller 271A ends the process and the process returns to Step S301 to repeat the process.

If the individual controller 271A determines that the blowing target position for the driver side is the second portion (NO in S303), then the process proceeds to Step S305. In Step S305, the individual controller 271A causes the blowing duct selection switching part 37A of the driver's seat 1A to execute the first mode, and controls the horizontal plate fins 121 of the second ventilation port 12b of the driver's seat 1A to adjust the blowing direction to the horizontal direction. Then, the individual controller 271A ends the process and the process returns to Step S301 to repeat the process.

If the individual controller 271A determines that the blowing target position for the passenger side is the second portion (NO in S302), then the process proceeds to Step S306. In Step S306, the individual controller 271A determines whether the blowing target position for the driver side is the first portion.

If the individual controller 271A determines that the blowing target position for the driver side is the first portion (YES in S306), then the process proceeds to Step S307. In Step S307, the individual controller 271A causes the blowing duct selection switching part 37A of the driver's seat 1A to execute the second mode, and controls the horizontal plate fins 121 of the third ventilation port 12c of the driver's seat 1A to adjust the blowing direction to the horizontal direction. Then, the individual controller 271A ends the process and the process returns to Step S301 to repeat the process.

If the individual controller 271A determines that the blowing target position for the driver side is the second portion (NO in S306), then the process proceeds to Step S308. In Step S308, the individual controller 271A causes the blowing duct selection switching part 37A of the driver's seat 1A to execute the first mode, and controls the horizontal plate fins 121 of the second ventilation port 12b of the driver's seat 1A to adjust the blowing direction downward. Then, the individual controller 271A ends the process and the process returns to Step S301 to repeat the process.

At this time, as illustrated in FIG. 21, the individual controller 271B of the vehicle seat air conditioner 230B, first, in Step S311, acquires the blowing target position of the vehicle seat air conditioner 230B, that is, the blowing target position of the vehicle seat air conditioner 230B for the driver side. The individual controller 271B switches the modes of the blowing duct selection switching part 37B of the vehicle seat air conditioner 230B based on the acquired blowing target position of the vehicle seat air conditioner 230B.

Specifically, in Step S312, the individual controller 271B determines whether the blowing target position for the driver side is the first portion.

If the individual controller 271B determines that the blowing target position for the driver side is the first portion (YES in S312), then the process proceeds to Step S313. In Step S313, the individual controller 271B causes the blowing duct selection switching part 37B of the passenger seat 1B to execute the first mode, and controls the horizontal plate fins 121 of the second ventilation port 12b of the passenger seat 1B to adjust the blowing direction to the horizontal direction. Then, the individual controller 271B ends the process and the process returns to Step S311 to repeat the process.

If the individual controller 271B determines that the blowing target position for the driver side is the second portion (NO in S312), then the process proceeds to Step S314. In Step S314, the individual controller 271B causes the blowing duct selection switching part 37B of the passenger seat 1B to execute the second mode, and controls the horizontal plate fins 121 of the third ventilation port 12c of the passenger seat 1B to adjust the blowing direction to the horizontal direction. Then, the individual controller 271B ends the process and the process returns to Step S311 to repeat the process.

As described above, the vehicle seat air conditioner 230 of the present modification is provided in the seat 1 of the vehicle 1000, and performs air-conditioning for seats other than the seat 1. The vehicle seat air conditioner 230 includes the blower 36, the blowing ducts (including the first blowing duct 34 and the second blowing duct 35) that guide air guided by the blower 36 to the blowing ports (including the first blowing port 34a and the second blowing port 35a) provided on a side surface of the seat 1, and the individual controller 271 for controlling the blower 36. Then, the individual controller 271 acquires the blowing target position of air blown out from each of the seat 1 and the other seats, and controls, based on the blowing target position, at least one of the blowing direction of air blown out from the blowing port, and the selection of the blowing port from which the air is blown out.

The configuration can reduce interference between the air blown out from each of the vehicle seat air conditioners 230. Therefore, the vehicle seat air conditioner 230 used in the seat 1 can blow out air more reliably toward the blowing target position of the occupant seated in the adjacent seat, and can provide a comfortable air-conditioned environment for that occupant.

More specifically, the vehicle seat air conditioner 230A of the present modification is provided in the driver's seat 1A, and performs air-conditioning for the passenger seat 1B adjacent to the driver's seat 1A in the left-right direction of the vehicle 1000. The blowing port of the driver's seat 1A is provided on a side surface of the driver's seat 1A facing the passenger seat 1B. The individual controller 271A sets, based on the blowing target position, selection of the blowing direction and the blowing port from which air is blown out so as to reduce interference between the air blown out from the blowing ports provided in the driver's seat 1A and the passenger seat 1B.

The configuration can reduce interference between the air blown out from the vehicle seat air conditioner 230A and the air blown out from the vehicle seat air conditioner 230B used respectively in the driver's seat 1A and the passenger seat 1B that are adjacent in the left-right direction of the vehicle 1000.

The vehicle seat air conditioner 230A of the present modification further includes the blowing duct selection switching part 37A that selects a ventilation path. The driver's seat 1A has, on its side surface, the plurality of blowing ports. The blowing ducts include a first blowing duct 34A and a second blowing duct 35A that blow out air guided by the blower 36A from each of the first blowing port 34Aa and the second blowing port 35Aa that are the plurality of blowing ports.

The blowing duct selection switching part 37A has the first mode for guiding the air guided by the blower 36A to the first blowing duct 34A and the second mode for guiding the air guided by the blower 36A to the second blowing duct 35A. The individual controller 271A switches, based on the blowing target position, between the modes of the first mode and the second mode of the blowing duct selection switching part 37A to control selection of the blowing port from which air is blown out.

Accordingly, even in a case where the plurality of blowing ports are provided in the driver's seat 1A, it is possible to reduce interference between the air blown out from the vehicle seat air conditioner 230A and the air blown out from the vehicle seat air conditioner 230B.

The second blowing port 35Aa is provided below the first blowing port 34Aa.

According to the configuration, the individual controller 271A can select a mode corresponding to any one of the first blowing port 34Aa and the second blowing port 35Aa arranged to be shifted in the vertical direction, which makes it possible to further reduce interference between the air blown out from the vehicle seat air conditioner 230A and the air blown out from the vehicle seat air conditioner 230B.

Further, the blowing target position is selected from among a plurality of portions of the occupant seated in the passenger seat 1B including the first portion of the occupant and the second portion, which is below the first portion, of the occupant. The individual controller 271A controls the blowing direction and the mode of the blowing duct selection switching part 37A based on the blowing target position.

According to the configuration, the individual controller 271A can blow out air more reliably toward the first portion, the second portion, or the like of the occupant seated in the passenger seat 1B while reducing interference between the air blown out from the vehicle seat air conditioner 230A and the air blown out from the vehicle seat air conditioner 230B, so that a comfortable air-conditioned environment can be provided for that occupant.

In the present modification, the individual controller 271B of the vehicle seat air conditioner 230B controls the vehicle seat air conditioner 230B based on the blowing target position of the vehicle seat air conditioner 230B for the driver side without acquiring the blowing target position of the vehicle seat air conditioner 230A for the passenger side. Even in such a case, the vehicle seat air conditioner 230A can achieve the above-described functional effects.

In the present modification, the individual controller 271B of the vehicle seat air conditioner 230B controls the vehicle seat air conditioner 230B based on the blowing target position of the vehicle seat air conditioner 230B for the driver side without acquiring the blowing target position of the vehicle seat air conditioner 230A for the passenger side. However, the control by the individual controller 271B is not limited thereto.

The individual controller 271B may select the mode of the blowing duct selection switching part 37B of the vehicle seat air conditioner 230B based on the blowing target position of the vehicle seat air conditioner 230B for the driver side and the blowing target position of the vehicle seat air conditioner 230A for the passenger side, and control the horizontal plate fins 121 of the blowing port corresponding to the selected mode to adjust the blowing direction. In this case, the individual controller 271A of the vehicle seat air conditioner 230A may control the vehicle seat air conditioner 230A based on the blowing target position of the vehicle seat air conditioner 230A for the passenger side without acquiring the blowing target position of the vehicle seat air conditioner 230B for the driver side.

In Steps S304, S305, S307, and S308, the individual controller 271A may perform control to switch the blowing direction and the modes of the blowing duct selection switching part 37A at predetermined time intervals, and in Steps S313 and S314, the individual controller 271B may perform control to switch the blowing direction and the modes of the blowing duct selection switching part 37B at predetermined time intervals.

For example, in Step S304, the individual controller 271A may control the vehicle seat air conditioner 230A to switch between the control for discharging the sucked air upward from the second blowing port 35Aa and the control for discharging the sucked air in the horizontal direction from the first blowing port 34Aa at predetermined time intervals. In Step S313, the individual controller 271B may control the vehicle seat air conditioner 230B to switch between the control for discharging the sucked air in the horizontal direction from the first blowing port 34Ba and the control for discharging the sucked air upward from the second blowing port 35Ba at predetermined time intervals.

At this time, in a certain period, the vehicle seat air conditioner 230A is so controlled that the sucked air is blown out upward from the second blowing port 35Aa, and the vehicle seat air conditioner 230B is so controlled that the sucked air is blown out in the horizontal direction from the first blowing port 34Ba.

Further, in another certain period, the vehicle seat air conditioner 230A is so controlled that the sucked air is blown out in the horizontal direction from the first blowing port 34Aa, and the vehicle seat air conditioner 230B is so controlled that the sucked air is blown out upward from the second blowing port 35Ba.

Further, in Step S305, the individual controller 271A may control the vehicle seat air conditioner 230A to switch between the control for discharging the sucked air in the horizontal direction from the first blowing port 34Aa and the control for discharging the sucked air upward from the second blowing port 35Aa at predetermined time intervals.

At this time, in a certain period, the vehicle seat air conditioner 230A is so controlled that the sucked air is blown out in the horizontal direction from the first blowing port 34Aa, and the vehicle seat air conditioner 230B is so controlled that the sucked air is blown out in the horizontal direction from the second blowing port 35Ba.

Further, in another certain period, the vehicle seat air conditioner 230A is so controlled that the sucked air is blown out upward from the second blowing port 35Aa, and the vehicle seat air conditioner 230B is so controlled that the sucked air is blown out in the horizontal direction from the second blowing port 35Ba.

Alternatively, the individual controller 271B may control the vehicle seat air conditioner 230B to switch between the control for discharging the sucked air in the horizontal direction from the second blowing port 35Ba and the control for discharging the sucked air downward from the first blowing port 34Ba at predetermined time intervals.

Further, in Step S307, the individual controller 271A may control the vehicle seat air conditioner 230A to switch between the control for discharging the sucked air in the horizontal direction from the second blowing port 35Aa and the control for discharging the sucked air downward from the first blowing port 34Aa at predetermined time intervals.

At this time, in a certain period, the vehicle seat air conditioner 230A is so controlled that the sucked air is blown out in the horizontal direction from the second blowing port 35Aa, and the vehicle seat air conditioner 230B is so controlled that the sucked air is blown out in the horizontal direction from the first blowing port 34Ba.

Further, in another certain period, the vehicle seat air conditioner 230A is so controlled that the sucked air is blown out downward from the first blowing port 34Aa, and the vehicle seat air conditioner 230B is so controlled that the sucked air is blown out in the horizontal direction from the first blowing port 34Ba.

Alternatively, the individual controller 271B may control the vehicle seat air conditioner 230B to switch between the control for discharging the sucked air in the horizontal direction from the first blowing port 34Ba and the control for discharging the sucked air upward from the second blowing port 35Ba at predetermined time intervals.

Further, in Step S308, the individual controller 271A controls the vehicle seat air conditioner 230A to switch between the control for discharging the sucked air downward from the first blowing port 34Aa and the control for discharging the sucked air in the horizontal direction from the second blowing port 35Aa at predetermined time intervals. In Step S314, the individual controller 271B may control the vehicle seat air conditioner 230B to switch between the control for discharging the sucked air in the horizontal direction from the second blowing port 35Ba and the control for discharging the sucked air downward from the first blowing port 34Ba at predetermined time intervals.

At this time, in a certain period, the vehicle seat air conditioner 230A is so controlled that the sucked air is blown out downward from the first blowing port 34Aa, and the vehicle seat air conditioner 230B is so controlled that the sucked air is blown out in the horizontal direction from the second blowing port 35Ba. Further, in another certain period, the vehicle seat air conditioner 230A is so controlled that the sucked air is blown out in the horizontal direction from the second blowing port 35Aa, and the vehicle seat air conditioner 230B is so controlled that the sucked air is blown out downward from the first blowing port 34Ba.

According to the control described above, it is possible to provide a more comfortable air-conditioned environment for the occupant seated in the seat while reducing interference between the air blown out from the vehicle seat air conditioner 230A and the air blown out from the vehicle seat air conditioner 230B.

### Third Modification of First Embodiment

As with the second modification, the present modification is different from the vehicle seat air conditioners according to the first embodiment and the first modification in that there is no controller for the vehicle seat air-conditioning system and the individual controller 271 independently controls a vehicle seat air conditioner 330. Further, the present modification is different also from the second modification in that only one blowing port 134a is provided on a side surface of the seat back 13 of the seat 1 and the vehicle seat air conditioner 330 has no blowing duct selection switching part.

A block diagram illustrating the vehicle seat air conditioner 330 according to the present modification is similar to that of the second modification illustrated in FIG. 19 except for the presence or absence of the blowing duct selection switching part, other configurations according to the present modification are similar to those of the first embodiment and the like, and the same configurations and functions are denoted by the same reference numerals, and detailed description of the configurations and functions is omitted. In particular, the configuration of the vehicle seat air conditioner 330 in the present modification is similar to that of the vehicle seat air conditioner 130 in the first modification illustrated in FIGS. 14 and 15.

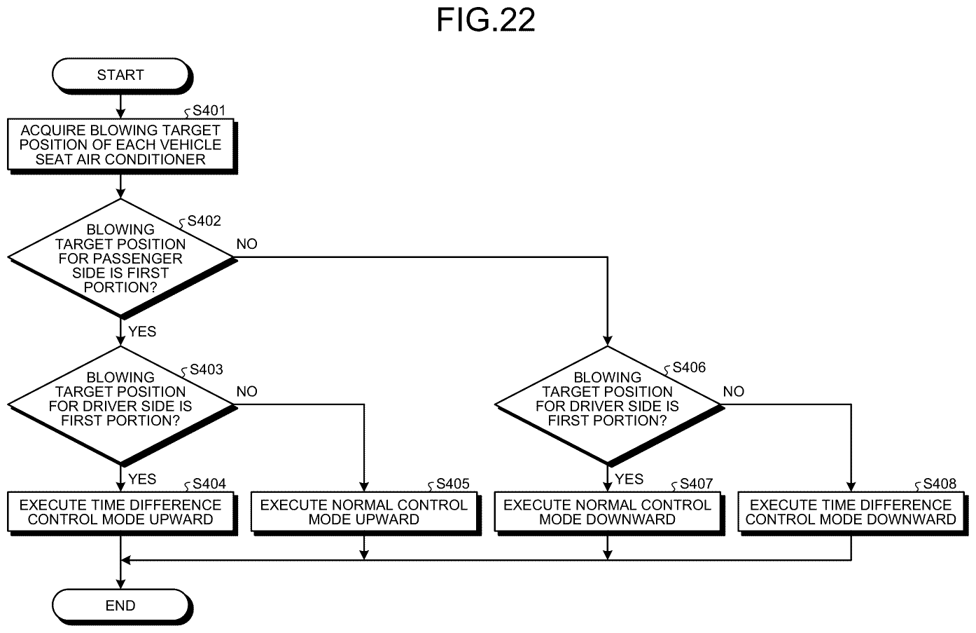

FIG. 22 is a flowchart illustrating processing of a vehicle seat air conditioner 330A according to the third modification of the first embodiment.

In the flowchart of FIG. 22, the operation may be started when the functions of the vehicle seat air conditioner 330 provided in each of the driver's seat 1A and the passenger seat 1B are both turned on. The functions of the vehicle seat air conditioners 330 may be switched on or off in accordance with an input operation received by the operation panel 65.

As illustrated in FIG. 22, the individual controller 271A of the vehicle seat air conditioner 330A, first, in Step S401, acquires the blowing target position of each of the vehicle seat air conditioners 330, that is, the blowing target position of a vehicle seat air conditioner 330B for the driver side and the blowing target position of the vehicle seat air conditioner 330A for the passenger side. The individual controller 271A controls the blower 36A of the vehicle seat air conditioner 330A based on the acquired blowing target position of each of the vehicle seat air conditioners 330.

Specifically, in Step S402, the individual controller 271A determines whether the blowing target position for the passenger side is the first portion. That is, the individual controller 271A determines whether the blowing target position of the vehicle seat air conditioner 330A is at least one or more of the head, neck, acromion, and back of the occupant seated in the passenger seat 1B.

If the individual controller 271A determines that the blowing target position for the passenger side is the first portion (YES in S402), then the process proceeds to Step S403. In Step S403, the individual controller 271A determines whether the blowing target position for the driver side is the first portion. That is, the individual controller 271A determines whether the blowing target position of the vehicle seat air conditioner 330B is at least one or more of the head, neck, acromion, and back of the occupant seated in the driver's seat 1A.

If the individual controller 271A determines that the blowing target position for the driver side is the first portion (YES in S403), then the process proceeds to Step S404. In Step S404, the individual controller 271A controls the horizontal plate fins 121 of the fourth ventilation port 112b of the driver's seat 1A to adjust the blowing direction upward. Further, the individual controller 271A controls the blower 36A of the driver's seat 1A to execute the time difference control mode. Then, the individual controller 271A ends the process and the process returns to Step S401 to repeat the process.

If the individual controller 271A determines that the blowing target position for the driver side is the second portion (NO in S403), then the process proceeds to Step S405. In Step S405, the individual controller 271A controls the horizontal plate fins 121 of the fourth ventilation port 112b of the driver's seat 1A to adjust the blowing direction upward. At this time, the individual controller 271A controls the blower 36A of the driver's seat 1A to execute the normal control mode. Then, the individual controller 271A ends the process and the process returns to Step S401 to repeat the process.

If the individual controller 271A determines that the blowing target position for the passenger side is the second portion (NO in S402), then the process proceeds to Step S406. In Step S406, the individual controller 271A determines whether the blowing target position for the driver side is the first portion.

If the individual controller 271A determines that the blowing target position for the driver side is the first portion (YES in S406), then the process proceeds to Step S407. In Step S407, the individual controller 271A controls the horizontal plate fins 121 of the fourth ventilation port 112b of the driver's seat 1A to adjust the blowing direction downward. At this time, the individual controller 271A controls the blower 36A of the driver's seat 1A to execute the normal control mode. Then, the individual controller 271A ends the process and the process returns to Step S401 to repeat the process.

If the individual controller 271A determines that the blowing target position for the driver side is the second portion (NO in S406), then the process proceeds to Step S408. In Step S408, the individual controller 271A controls the horizontal plate fins 121 of the fourth ventilation port 112b of the driver's seat 1A to adjust the blowing direction downward. Further, the individual controller 271A controls the blower 36A of the driver's seat 1A to execute the time difference control mode. Then, the individual controller 271A ends the process and the process returns to Step S401 to repeat the process.

The individual controller 271B of the vehicle seat air conditioner 330B also executes processing similar to the processing of the individual controller 271A described above.

As described above, in the vehicle seat air conditioner 330A of the present modification, one blowing port of the driver's seat 1A is provided on the side surface of the driver's seat 1A. The individual controller 271A shifts, based on the blowing target position, the time at which air is blown out from the blowing port 134Aa provided in the driver's seat 1A from the time at which air is blown out from the blowing port 134Ba provided in the passenger seat 1B.

Accordingly, even in a case where one blowing port is provided in the driver's seat 1A, it is possible to reduce interference between the air blown out from the vehicle seat air conditioner 330A and the air blown out from the vehicle seat air conditioner 330B.

The individual controller 271A determines, based on the blowing target position, whether the air blown out from the blowing port 134Aa provided in the driver's seat 1A and the air blown out from the blowing port 134Ba provided in the passenger seat 1B interfere with each other. In a case where it is determined that the interference occurs, the individual controller 271A controls the blowing timing such that air is blown out from the blowing port 134Aa of the driver's seat 1A in the first time zone in which no air is blown out from the blowing port 134Ba of the passenger seat 1B, and no air is blown out in the second time zone which is different from the first time zone and in which air is blown out from the blowing port 134Ba of the passenger seat 1B.

This can make the time at which air is blown out from the blowing port 134Aa of the driver's seat 1A different from the time at which air is blown out from the blowing port 134Ba of the passenger seat 1B. This can reduce interference between the air blown out from the vehicle seat air conditioner 330A and the air blown out from the vehicle seat air conditioner 330B.

The first time zone is a time zone following the second time zone, and the second time zone is a time zone following the first time zone.

According to this, in the first time zone and the second time zone which are consecutive time zones, it is possible to reduce interference between the air blown out from the vehicle seat air conditioner 330A and the air blown out from the vehicle seat air conditioner 330B.

Further, the blowing target position of the vehicle seat air conditioner 330A provided in the driver's seat 1A is selected from among a plurality of portions of the occupant seated in the passenger seat 1B including the first portion of the occupant and the second portion, which is below the first portion, of the occupant. The individual controller 271A controls at least one of the blowing timing and the blowing direction based on the blowing target position.

According to the configuration, the individual controller 271A can blow out air more reliably toward the first portion, the second portion, or the like of the occupant seated in the passenger seat 1B while reducing interference between the air blown out from the vehicle seat air conditioner 330A and the air blown out from the vehicle seat air conditioner 330B, so that a comfortable air-conditioned environment can be provided for that occupant.

The blowing port 134Aa of the driver's seat 1A and the blowing port 134Ba of the passenger seat 1B are provided at heights corresponding to each other. In a case where both the blowing target positions of the vehicle seat air conditioners 330 are the first portions or the second portions, the individual controller 271A determines that air blown out from the blowing port 134a of the driver's seat 1A and air blown out from the blowing port 134a of the passenger seat 1B interfere with each other.

According to this, in a case where both the blowing target positions of the vehicle seat air conditioners 330 are the first portions or the second portions, it is possible to make the time at which air is blown out from the blowing port 134Aa of the driver's seat 1A different from the time at which air is blown out from the blowing port 134Ba of the passenger seat 1B. This can reduce interference between the air blown out from the vehicle seat air conditioner 330A and the air blown out from the vehicle seat air conditioner 330B.

For example, when the normal control mode is executed for a case where the blowing target position for the driver side and the blowing target position for the passenger side are both the first portions or are both the second portions, air blown out from the blowing port 134Aa of the driver's seat 1A and air blown out from the blowing port 134Ba of the passenger seat 1B interfere with each other, which may cause turbulence in the airflow. This sometimes reduces the volume of air to be blown out to the blowing target positions of the occupant seated in the driver's seat 1A and the occupant seated in the passenger seat 1B.

Accordingly, in the present modification, in a case where the blowing target position for the driver side and the blowing target position for the passenger side are both the first portions or are both the second portions, the individual controller 271A and the individual controller 271B execute the time difference control mode. As a result, it is possible to reduce interference between air blown out from the blowing port 134Aa of the driver's seat 1A and air blown out from the blowing port 134Ba of the passenger seat 1B. Then, air can be blown out more reliably to the blowing target positions of the occupant seated in the driver's seat 1A and the occupant seated in the passenger seat 1B, and a more comfortable air-conditioned environment can be provided for those occupants.

On the other hand, in a case where one of the blowing target position for the driver side and the blowing target position for the passenger side is the first portion and the other is the second portion, the individual controller 271A and the individual controller 271B execute the normal control mode. In other words, in a case where it can be recognized that air blown out from the blowing port 134Aa of the driver's seat 1A and air blown out from the blowing port 134Ba of the passenger seat 1B are unlikely to interfere with each other, the individual controller 271A and the individual controller 271B do not execute the time difference control mode.

### Second Embodiment

The present embodiment is different from the vehicle seat air conditioner of the first embodiment in that a vehicle seat air conditioner 430 used in the seat 1 controls air-conditioning based on a seat type of a seat adjacent to the seat 1. The seat type of the seat is, for example, the driver's seat 1A and the passenger seat 1B. The configuration of the vehicle seat air conditioner 430 in the present embodiment is similar to that of the vehicle seat air conditioner 230 in the second modification of the first embodiment, and the same configurations and functions are denoted by the same reference numerals, and detailed description of the configurations and functions is omitted.

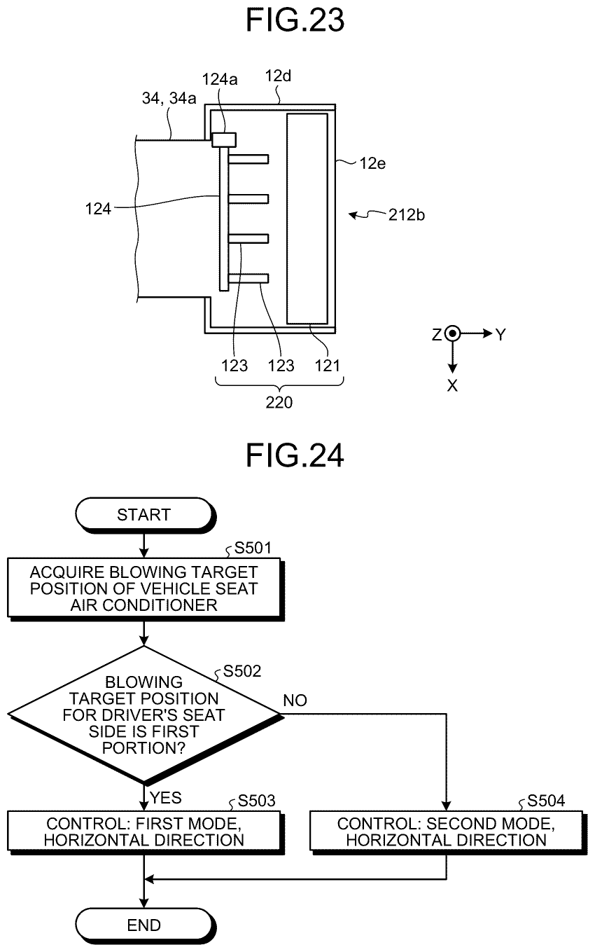

FIG. 23 is an enlarged cross-sectional view of a second ventilation port 212b in the second embodiment as viewed from the Z-axis positive direction side.

In the present embodiment, as illustrated in FIG. 23, the second ventilation port 212b is provided with, as an airflow direction changing member 220, a plurality of vertical plate fins 123, a link mechanism 124, a drive unit 124a, and the like, in addition to the plurality of horizontal plate fins 121, the link mechanism 122, and the drive unit 122a. The vertical plate fins 123 are members for changing the direction of air blown out from the second ventilation port 212b. The vertical plate fins 123 are connected by the link mechanism 124. The link mechanism 124 is configured to simultaneously change the orientations of the vertical plate fins 123. The drive unit 124a is connected to the link mechanism 124, and is configured to change the orientations of the vertical plate fins 123 by operation of the drive unit 124a. A third ventilation port 212c in the present embodiment is similarly configured.

In the present embodiment, it is only required that the second ventilation port 212b and the third ventilation port 212c formed in the driver's seat 1A have the vertical plate fins 123 and the link mechanism 124, and the second ventilation port 212b and the third ventilation port 212c formed in the passenger seat 1B may have the vertical plate fins 123 and the link mechanism 124, or, alternatively, may have a configuration without them, that is, a configuration similar to that of the second ventilation port 12b and the third ventilation port 12c in the first embodiment.

### Processing

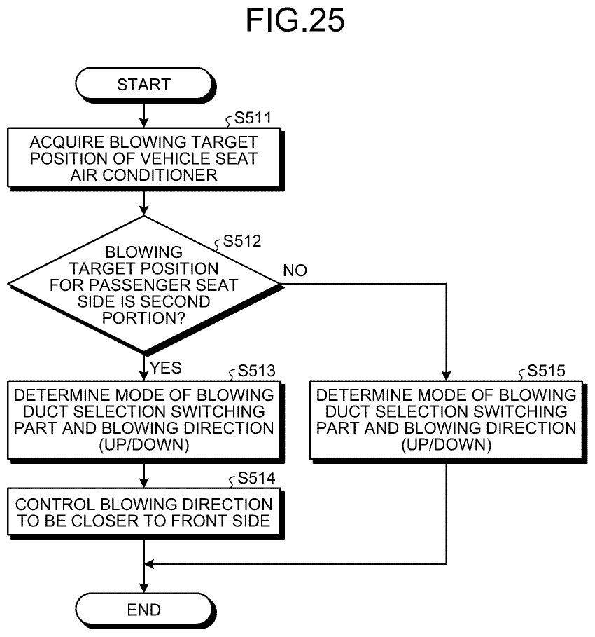

FIG. 24 is a flowchart illustrating processing of a vehicle seat air conditioner 430B according to the second embodiment. FIG. 25 is a flowchart illustrating processing of a vehicle seat air conditioner 430A according to the second embodiment.

As illustrated in FIG. 24, the individual controller 271B of the vehicle seat air conditioner 430B, first, in Step S501, acquires the blowing target position of the vehicle seat air conditioner 430B, that is, the blowing target position of the vehicle seat air conditioner 430B for the driver side. The individual controller 271B switches the modes of the blowing duct selection switching part 37B of the vehicle seat air conditioner 430B based on the acquired blowing target position of the vehicle seat air conditioner 430B.

Specifically, in Step S502, the individual controller 271B determines whether the blowing target position for the driver side is the first portion. That is, the individual controller 271B determines whether the blowing target position of the vehicle seat air conditioner 430B is at least one or more of the head, neck, acromion, and back of the occupant seated in the driver's seat 1A.

If the individual controller 271B determines that the blowing target position for the driver side is the first portion (YES in S502), then the process proceeds to Step S503. In Step S503, the individual controller 271B causes the blowing duct selection switching part 37B of the passenger seat 1B to execute the first mode, and controls the horizontal plate fins 121 of the second ventilation port 212b of the passenger seat 1B to adjust the blowing direction to the horizontal direction. Then, the individual controller 271B ends the process and the process returns to Step S501 to repeat the process.

If the individual controller 271B determines that the blowing target position for the driver side is the second portion (NO in S502), then the process proceeds to Step S504. In Step S504, the individual controller 271B causes the blowing duct selection switching part 37B of the passenger seat 1B to execute the second mode, and controls the horizontal plate fins 121 of the third ventilation port 212c of the passenger seat 1B to adjust the blowing direction to the horizontal direction. Then, the individual controller 271B ends the process and the process returns to Step S501 to repeat the process.

On the other hand, as illustrated in FIG. 25, the individual controller 271A of the vehicle seat air conditioner 430A, first, in Step S511, acquires the blowing target position of the vehicle seat air conditioner 430A, that is, the blowing target position of the vehicle seat air conditioner 430A for the passenger side. The individual controller 271A switches the modes of the blowing duct selection switching part 37A of the vehicle seat air conditioner 430A based on the acquired blowing target position of the vehicle seat air conditioner 430A.

Specifically, in Step S512, the individual controller 271A determines whether the blowing target position for the passenger side is the second portion.

If the individual controller 271A determines that the blowing target position for the passenger side is the second portion (YES in S512), then the process proceeds to Step S513. In Step S513, the individual controller 271A selects the mode of the blowing duct selection switching part 37A of the driver's seat 1A. In addition, the individual controller 271A determines the upper/lower blowing direction of air blown out from the ventilation port corresponding to the selected mode.

In other words, the individual controller 271A determines whether to blow out the air from the ventilation port upward, downward, or in the horizontal direction. The individual controller 271A controls the horizontal plate fins 121 of the ventilation port to adjust the blowing direction. The individual controller 271A selects, based on a predetermined condition for example, the mode of the blowing duct selection switching part 37A and the blowing direction from the corresponding ventilation port.

The predetermined condition is, for example, the condition described in the first embodiment. Specifically, the mode of the blowing duct selection switching part 37A and the blowing direction from the corresponding ventilation port are selected according to the mode of the blowing duct selection switching part 37B and the blowing direction from the corresponding ventilation port determined in Steps S501 to S504 so as to reduce interference between air blown out from the vehicle seat air conditioner 430A and air blown out from the vehicle seat air conditioner 430B.

The individual controller 271A may store a preset rule such as “selecting the second mode when the blowing target position for the passenger side is the second portion”, select the mode of the blowing duct selection switching part 37A based on the rule, and determine the blowing direction from the corresponding ventilation port.

Thereafter, in Step S514, the individual controller 271A controls the ventilation port corresponding to the mode of the blowing duct selection switching part 37A selected in Step S513 to control the blowing direction to be closer to the front side (closer to the X-axis positive direction). The individual controller 271A controls the vertical plate fins 123 of the ventilation port to adjust the blowing direction to be closer to the front side. Then, the individual controller 271A ends the process and the process returns to Step S511 to repeat the process.

If the individual controller 271A determines that the blowing target position for the passenger side is the first portion (NO in S512), then the process proceeds to Step S515. In Step S515, the individual controller 271A selects the mode of the blowing duct selection switching part 37A of the driver's seat 1A. In addition, the individual controller 271A determines the upper/lower blowing direction of air blown out from the ventilation port corresponding to the selected mode. The individual controller 271A controls the horizontal plate fins 121 of the ventilation port to adjust the blowing direction. The method of selecting the mode of the blowing duct selection switching part 37A and the blowing direction from the corresponding ventilation port by the individual controller 271A is similar to the method used in Step S513. Then, the individual controller 271A ends the process and the process returns to Step S511 to repeat the process.

### Functional Effects

Next, the functional effects of the vehicle seat air conditioner according to the present embodiment will be described.

As described above, the vehicle seat air conditioner 430 according to the present embodiment is provided in the first seat of the vehicle 1000, and performs air conditioning for the second seat disposed adjacent to the first seat in the left-right direction of the vehicle 1000. The vehicle seat air conditioner 430 includes the blower 36, a blowing duct that blows out air guided by the blower 36 from a blowing port provided on a side surface of the first seat, and the individual controller (controller) 271 for controlling the blower 36. The individual controller 271 acquires the blowing target position of air blown out from the first seat, and controls, based on the blowing target position and the seat type of the second seat, at least one of the blowing direction of air blown out from the blowing port, and the selection of the blowing port from which the air is blown out.

This enables the vehicle seat air conditioner 430 provided in the first seat to blow out air more reliably toward the blowing target position of the occupant seated in the second seat, and to provide a more comfortable air-conditioned environment for that occupant.

More specifically, in the vehicle seat air conditioner 430 according to the present embodiment, the individual controller 271 controls, based on the blowing target position and the seat type of the second seat, at least one of the blowing direction of air blown out from the blowing port and the selection of the blowing port from which the air is blown out such that the conditioned air, which is the air blown out from the blowing port, reaches the blowing target position.

This enables the vehicle seat air conditioner 430 provided in the first seat to blow out air more reliably toward the blowing target position of the occupant seated in the second seat, and to provide a comfortable air-conditioned environment for that occupant.

The vehicle seat air conditioner 430 of the present embodiment further includes the blowing duct selection switching part 37 that selects a ventilation path. A plurality of blowing ports is provided on the side surface of the first seat. The blowing ducts include the first blowing duct 34 and the second blowing duct 35 that blow out air guided by the blower 36 from each of the first blowing port 34a and the second blowing port 35a that are the plurality of blowing ports. The blowing duct selection switching part 37 has the first mode for guiding the air guided by the blower 36 to the first blowing duct 34 and the second mode for guiding the air guided by the blower 36 to the second blowing duct 35. The individual controller 271 switches between the modes of the first mode and the second mode of the blowing duct selection switching part 37 based on the blowing target position.

Accordingly, even when the first seat is provided with the plurality of blowing ports, air can be blown out more reliably toward the blowing target position of the occupant seated in the second seat.

Further, the blowing target position is selected from a plurality of portions of the occupant seated in the second seat including the first portion of the occupant and the second portion, which is below the first portion, of the occupant. The individual controller 271 controls the blowing direction based on the blowing target position.

According to the configuration, the individual controller 271 can blow out air more reliably toward the first portion, the second portion, or the like of the occupant seated in the second seat while achieving more reliable blowing of air toward the blowing target position of the occupant seated in the second seat, so that a comfortable air-conditioned environment can be provided for that occupant.

Further, the seat type of the second seat includes the driver's seat 1A and the passenger seat 1B.

According to this, air can be blown out more reliably toward the blowing target position of the occupant seated in the driver's seat 1A or the passenger seat 1B.

In a case where the seat type of the second seat is the driver's seat 1A, the individual controller 271B of the passenger seat 1B causes the blowing duct selection switching part 37B to execute the first mode as long as the blowing target position is the first portion.

According to the configuration, in a case where the first portion of the occupant seated in the driver's seat 1A is the blowing target position, it is possible to prevent air blown out to the arm or the like of that occupant from being blocked. Then, air can be blown out more reliably to the blowing target position of the occupant seated in the driver's seat 1A, and a more comfortable air-conditioned environment can be provided for that occupant.

In a case where the blowing target position is the second portion, the individual controller 271B causes the blowing duct selection switching part 37B to execute the second mode.

According to the configuration, in a case where the second portion of the occupant seated in the driver's seat 1A is the blowing target position, it is possible to prevent air blown out to the arm or the like of that occupant from being blocked. Then, air can be blown out more reliably to the blowing target position of the occupant seated in the driver's seat 1A, and a more comfortable air-conditioned environment can be provided for that occupant.

In a case where the seat type of the second seat is the passenger seat 1B, the individual controller 271A of the driver's seat 1A controls the blowing direction of air blown out from the blowing port provided on the side surface of the driver's seat 1A to be closer to the front side of the vehicle 1000 than the blowing direction of air blown out from the blowing port provided on the side surface of the passenger seat 1B as long as the blowing target position is the second portion.

According to the configuration, air can be blown out more reliably to the blowing target position of the occupant seated in the passenger seat 1B, and a more comfortable air-conditioned environment can be provided for that occupant.

Usually, it is assumed that the occupant seated in the driver's seat 1A grips the steering wheel while the vehicle 1000 is traveling. At this time, when air is blown out from the third ventilation port 212c of the vehicle seat air conditioner 430B to the first portion of the occupant seated in the driver's seat 1A or when air is blown out from the second ventilation port 212b of the vehicle seat air conditioner 430B to the second portion of the occupant seated in the driver's seat 1A, the air hits the arm of the occupant gripping the steering wheel, and thus air blown out to the blowing target position may be reduced.

In the present embodiment, in a case where the blowing target position for the driver side is the first portion, the individual controller 271B causes the blowing duct selection switching part 37B to execute the first mode, and controls the horizontal plate fins 121 of the second ventilation port 212b to adjust the blowing direction to the horizontal direction. In a case where the blowing target position for the driver side is the second portion, the individual controller 271B causes the blowing duct selection switching part 37B to execute the second mode, and controls the horizontal plate fins 121 of the third ventilation port 212c to adjust the blowing direction to the horizontal direction.

According to the configuration, it is possible to prevent air blown out to the arm or the like of the occupant seated in the driver's seat 1A from being blocked. Then, air can be blown out more reliably to the blowing target position of the occupant seated in the driver's seat 1A, and a more comfortable air-conditioned environment can be provided for that occupant.

Further, in the vehicle seat air conditioner 430A according to the present embodiment, the plurality of vertical plate fins 123 and the link mechanism 124 are provided in the second ventilation port 212b and the third ventilation port 212c, and the individual controller 271A controls the vertical plate fins 123 based on the blowing target position for the passenger side.

In general, the waist, buttocks, and thighs of the occupant seated in the passenger seat 1B are located closer to the front side than those of the occupant seated in the driver's seat 1A. When air is blown out to the second portion of the occupant seated in the passenger seat 1B, if control is performed similarly to that in the case of discharging air to the second portion of the occupant seated in the driver's seat 1A, the volume of air blown out to the blowing target position may be reduced.

In the present embodiment, in a case where the blowing target position for the passenger side is the second portion, the individual controller 271A controls the vertical plate fins 123 of the ventilation port from which air is blown out to adjust the blowing direction to be closer to the front side. According to the configuration, it is possible to prevent air from being blown out between the occupant seated in the passenger seat 1B and the passenger seat 1B. Then, air can be blown out more reliably to the blowing target position of the occupant seated in the passenger seat 1B, and a more comfortable air-conditioned environment can be provided for that occupant.

As described above, the vehicle seat air conditioner 430 according to the present embodiment controls air-conditioning based on the seat type of a seat to which air is to be blown out. Specifically, different processing is executed depending on whether the seat to which air is to be blown out is the driver's seat 1A or the passenger seat 1B. In other words, the vehicle seat air conditioner 430A and the vehicle seat air conditioner 430B execute different processing. The processing described above is executed in each of the vehicle seat air conditioners 430, so that air can be blown out more reliably to each of the blowing target positions, and a more comfortable air-conditioned environment can be provided for the occupant to whom the air is blown out.

### Modification of Second Embodiment

The present modification is different from the vehicle seat air conditioner of the second embodiment in that the individual controller 271 performs air-conditioning control based on the detection result of an occupant posture sensor 51. The other configurations in the present modification are similar to those in the second embodiment, and the same configurations and functions are denoted by the same reference numerals, and detailed description of the configurations and functions is omitted.

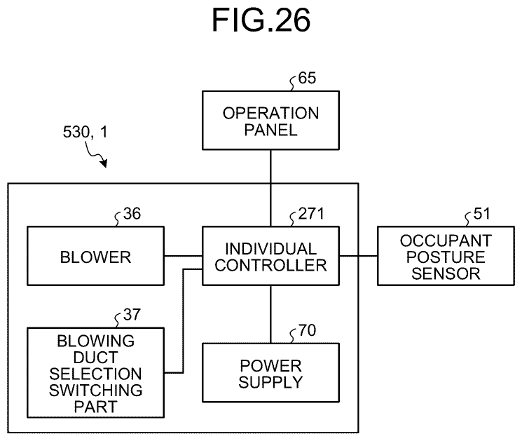

FIG. 26 is a block diagram illustrating a vehicle seat air conditioner 530 according to the modification of the second embodiment.

As illustrated in FIG. 26, in the vehicle seat air conditioner 530, the individual controller 271 is electrically connected to the occupant posture sensor 51. The occupant posture sensor 51 detects a posture of an occupant of the vehicle 1000, and outputs posture information indicating the detected posture of the occupant to the individual controller 271. The occupant posture sensor 51 detects a posture of at least one of an occupant seated in the driver's seat 1A and an occupant seated in the passenger seat 1B.

The occupant posture sensor 51 that detects the posture of the occupant seated in the driver's seat 1A is, for example, a grip sensor disposed in the steering wheel of the vehicle 1000. The grip sensor can detect the fact that the occupant seated in the driver's seat 1A grips the steering wheel. The occupant posture sensor 51 that detects the posture of the occupant seated in the driver's seat 1A may be a camera, thermography, or the like, and can also detect the fact that the occupant seated in the driver's seat 1A grips the steering wheel.

The individual controller 271B of a vehicle seat air conditioner 530B used in the passenger seat 1B determines whether the occupant seated in the driver's seat 1A grips the steering wheel based on the detection result of the occupant posture sensor 51, and controls the vehicle seat air conditioner 530B based on the determination result.

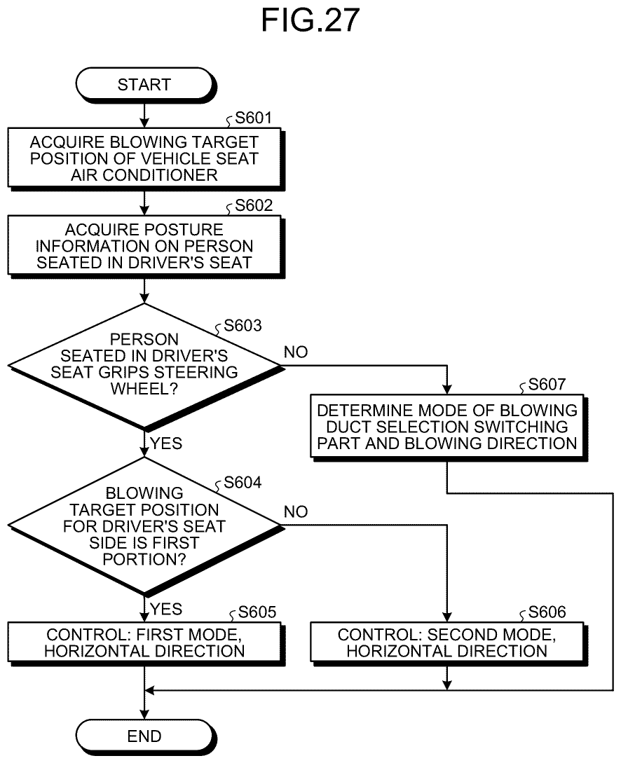

FIG. 27 is a flowchart illustrating processing of the vehicle seat air conditioner 530B according to the modification of the second embodiment.

As illustrated in FIG. 27, the individual controller 271B of the vehicle seat air conditioner 530B, first, in Step S601, acquires the blowing target position of the vehicle seat air conditioner 530B, that is, the blowing target position of the vehicle seat air conditioner 530B for the driver side.

Next, in Step S602, the individual controller 271B acquires posture information on the occupant seated in the driver's seat 1A. The individual controller 271B acquires the posture information on the occupant seated in the driver's seat 1A from the occupant posture sensor 51 that detects the fact that the occupant seated in the driver's seat 1A grips the steering wheel.

In Step S603, the individual controller 271B determines whether the occupant seated in the driver's seat 1A grips the steering wheel. The individual controller 271B determines whether the occupant seated in the driver's seat 1A grips the steering wheel based on the posture information that is a detection result of the occupant posture sensor 51.

If the individual controller 271B determines that the occupant seated in the driver's seat 1A grips the steering wheel (YES in S603), then the process proceeds to Step S604. In Step S604, the individual controller 271B determines whether the blowing target position for the driver side is the first portion. That is, the individual controller 271B determines whether the blowing target position of the vehicle seat air conditioner 530B is at least one or more of the head, neck, acromion, and back of the occupant seated in the driver's seat 1A.

If the individual controller 271B determines that the blowing target position for the driver side is the first portion (YES in S604), then the process proceeds to Step S605. In Step S605, the individual controller 271B causes the blowing duct selection switching part 37B of the passenger seat 1B to execute the first mode, and controls the horizontal plate fins 121 of the second ventilation port 212b of the passenger seat 1B to adjust the blowing direction to the horizontal direction. Then, the individual controller 271B ends the process and the process returns to Step S601 to repeat the process.

If the individual controller 271B determines that the blowing target position for the driver side is the second portion (NO in S604), then the process proceeds to Step S606. In Step S606, the individual controller 271B causes the blowing duct selection switching part 37B of the passenger seat 1B to execute the second mode, and controls the horizontal plate fins 121 of the third ventilation port 212c of the passenger seat 1B to adjust the blowing direction to the horizontal direction. Then, the individual controller 271B ends the process and the process returns to Step S601 to repeat the process.

If the individual controller 271B does not determine that the occupant seated in the driver's seat 1A grips the steering wheel (NO in S603), then the process proceeds to Step S607. In Step S607, the individual controller 271B selects the mode of the blowing duct selection switching part 37B of the passenger seat 1B. In addition, the individual controller 271B determines the blowing direction of air blown out from the ventilation port corresponding to the selected mode.

In other words, the individual controller 271B determines whether to blow out the air from the ventilation port upward, downward, or in the horizontal direction. The individual controller 271B controls the horizontal plate fins 121 of the ventilation port to adjust the blowing direction. The method of selecting the mode of the blowing duct selection switching part 37B and the blowing direction from the corresponding ventilation port by the individual controller 271B is similar to the method used in Steps S513 and S515 in the second embodiment. Then, the individual controller 271B ends the process and the process returns to Step S601 to repeat the process.

In a case where a camera, thermography, or the like is used as the occupant posture sensor 51 that detects the posture of the occupant seated in the driver's seat 1A, the occupant posture sensor 51 can detect the position of the arm of the occupant seated in the driver's seat 1A in addition to the fact that the occupant seated in the driver's seat 1A grips the steering wheel. At this time, the individual controller 271B may adjust, based on the detection result of the occupant posture sensor 51, the blowing direction so that air can be blown out to the blowing target position without being blocked by the arm of the occupant seated in the driver's seat 1A.

The occupant posture sensor 51 that detects the posture of the occupant seated in the passenger seat 1B is, for example, a camera, thermography, or the like. These sensors can detect the posture of the occupant seated in the passenger seat 1B, and can detect, for example, the fact that the waist, buttocks, and thighs of the occupant seated in the passenger seat 1B are positioned closer to the front side.

The individual controller 271A of a vehicle seat air conditioner 530A used in the driver's seat 1A determines, based on the detection result of the occupant posture sensor 51, whether the waist, buttocks, and thighs of the occupant seated in the passenger seat 1B are positioned closer to the front side, and controls the vehicle seat air conditioner 530A based on the determination result.

Specifically, in a case where the individual controller 271A determines that the waist, buttocks, and thighs of the occupant seated in the passenger seat 1B are positioned closer to the front side, and where the blowing target position for the passenger side is the second portion, the individual controller 271A controls the vertical plate fins 123 of the ventilation port from which air is blown out to adjust the blowing direction to be closer to the front side. Further, the individual controller 271A may adjust, based on the detection result of the occupant posture sensor 51, the blowing direction so that air can be blown out to the blowing target position of the occupant seated in the passenger seat 1B.

As described above, in the vehicle seat air conditioner 530 of the present modification, the mode of the blowing duct selection switching part 37 and the blowing direction can be controlled based on the detection result of the occupant posture sensor 51, so that air can be blown to the blowing target position more reliably, and a more comfortable air-conditioned environment can be provided for the occupant to whom the air is blown out.

More specifically, the individual controller 271B of the passenger seat 1B switches the modes of the blowing duct selection switching part 37B based on the detection result of the occupant posture sensor 51 that detects the posture of the occupant seated in the driver's seat 1A.

According to the configuration, the modes of the blowing duct selection switching part 37B can be switched based on the posture of the occupant seated in the driver's seat 1A detected by the occupant posture sensor 51, and air can be blown out more reliably to the blowing target position of the occupant seated in the driver's seat 1A.

The individual controller 271B further determines whether the occupant seated in the driver's seat 1A grips the steering wheel of the vehicle 1000 based on the detection result of the occupant posture sensor 51.

According to the configuration, the modes of the blowing duct selection switching part 37B can be switched based on the determination result as to whether the occupant seated in the driver's seat 1A grips the steering wheel detected by the occupant posture sensor 51, and air can be blown out more reliably to the blowing target position of the occupant seated in the driver's seat 1A.

In a case where it is determined that the occupant seated in the driver's seat 1A grips the steering wheel and the blowing target position is the first portion, the individual controller 271B causes the blowing duct selection switching part 37B to execute the first mode.

According to the configuration, in a case where the first portion of the occupant seated in the driver's seat 1A is the blowing target position, it is possible to prevent air blown out to the arm or the like of that occupant gripping the steering wheel from being blocked. Then, air can be blown out more reliably to the blowing target position of the occupant seated in the driver's seat 1A, and a more comfortable air-conditioned environment can be provided for that occupant.

In a case where it is determined that the occupant seated in the driver's seat 1A grips the steering wheel and the blowing target position is the second portion, the individual controller 271B causes the blowing duct selection switching part 37B to execute the second mode.

According to the configuration, in a case where the second portion of the occupant seated in the driver's seat 1A is the blowing target position, it is possible to prevent air blown out to the arm or the like of that occupant gripping the steering wheel from being blocked. Then, air can be blown out more reliably to the blowing target position of the occupant seated in the driver's seat 1A, and a more comfortable air-conditioned environment can be provided for that occupant.

In addition, the individual controller 271A of the driver's seat 1A controls the blowing direction of air blown out from the blowing port provided on the side surface of the driver's seat 1A based on the detection result of the occupant posture sensor 51 that detects the posture of the occupant seated in the passenger seat 1B.

According to the configuration, the blowing direction of air blown out from the blowing port provided on the side surface of the driver's seat 1A can be controlled based on the posture of the occupant seated in the passenger seat 1B detected by the occupant posture sensor 51, and air can be blown out more reliably to the blowing target position of the occupant seated in the passenger seat 1B.

### Third Embodiment

The present embodiment is different from the vehicle seat air conditioner of the second embodiment and the like in that a vehicle seat air conditioner 630 used in the seat 1 controls air-conditioning based on an amount of solar radiation. The configuration of the vehicle seat air conditioner 630 in the present embodiment is similar to that of the vehicle seat air conditioner 430 in the second embodiment, and the same configurations and functions are denoted by the same reference numerals, and detailed description of the configurations and functions is omitted.

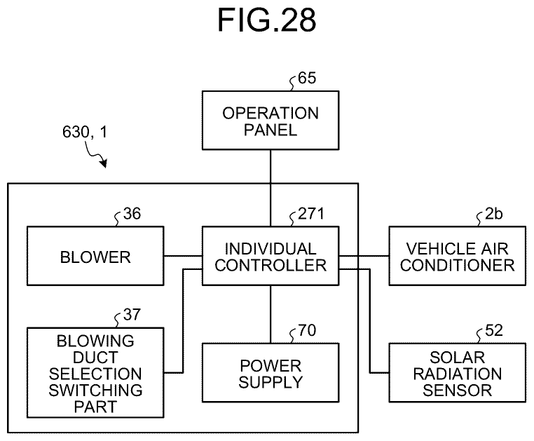

FIG. 28 is a block diagram illustrating the vehicle seat air conditioner 630 according to the second embodiment.

In the present embodiment, as illustrated in FIG. 28, the individual controller 271 is electrically connected to a solar radiation sensor 52. The solar radiation sensor 52 is a sensor that detects the amount and direction of solar radiation entering the interior of the vehicle 1000. The solar radiation sensor 52 is provided, for example, on a dashboard or the like in the vehicle interior. The solar radiation sensor 52 includes, for example, a plurality of light receiving elements arranged with directivity in different directions. The solar radiation sensor 52 includes an arithmetic unit that calculates a direction of solar radiation based on an amount of solar radiation detected by each of the light receiving elements. Note that the solar radiation sensor 52 is an example of a “temperature detection sensor” in the appended claims.

Further, the seat 1 in the present embodiment can correspond to the “first seat” in the appended claims, and a seat adjacent to the seat 1 can correspond to the “second seat” in the appended claims.

The individual controller 271 is electrically connected to the vehicle air conditioner 2b. In the present embodiment, it is not an essential constituent feature that the individual controller 271 is electrically connected to the vehicle air conditioner 2b.

### Processing

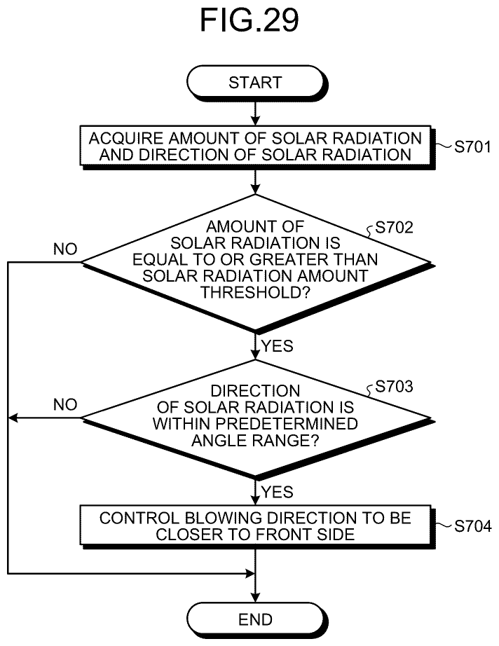

FIG. 29 is a flowchart illustrating processing of the vehicle seat air conditioner 630 according to the third embodiment.

As illustrated in FIG. 29, the individual controller 271 of the vehicle seat air conditioner 630 first, in Step S701, acquires information on the amount of solar radiation and the direction of solar radiation from the solar radiation sensor 52. The individual controller 271 may directly acquire the information on the amount of solar radiation and the direction of solar radiation from the solar radiation sensor 52, or may acquire these pieces of information from the vehicle air conditioner 2b connected to the solar radiation sensor 52.

Next, in Step S702, the individual controller 271 determines whether the amount of solar radiation acquired from the solar radiation sensor 52 is equal to or greater than a solar radiation amount threshold. The solar radiation amount threshold is a threshold used for determining whether it is necessary to start processing of controlling the blowing direction from the vehicle seat air conditioner 630 based on the direction of solar radiation. As the solar radiation amount threshold, an amount of solar radiation is set which has magnitude with which it can be determined that a change in the irradiation region of the solar radiation on the occupant seated in the seat adjacent to the seat 1 due to a change in the direction of solar radiation causes a change of a certain degree or more in the thermal sensation of that occupant. The solar radiation amount threshold is determined in advance based on an experiment or the like. The solar radiation amount threshold is, for example, 800 W/m².

If the individual controller 271 determines that the amount of solar radiation is equal to or greater than the solar radiation amount threshold (YES in S702), then the process proceeds to Step S703. In Step S703, the individual controller 271 determines whether the direction of solar radiation acquired from the solar radiation sensor 52 is within a predetermined angle range. The predetermined angle range is an angle range of solar radiation in which it can be determined that the thermal sensation of the occupant seated in the seat adjacent to the seat 1 differs, to some extent or more, between the right side and the left side of that occupant. Here, assuming that the front of the vehicle 1000 (X-axis positive direction) is 0 degrees in the direction of solar radiation, solar radiation is emitted from the right side of the vehicle 1000 (Y-axis negative direction side) when the direction of solar radiation is between 0 degrees and 180 degrees, and solar radiation is emitted from the left side of the vehicle 1000 (Y-axis positive direction side) when the direction of solar radiation is between 180 degrees and 360 degrees.

The predetermined angle range is, for example, from 30 degrees to 150 degrees in the vehicle seat air conditioner 630 used in the seat 1 on the right side (Y-axis negative direction side) of the vehicle 1000, and is from 210 degrees to 330 degrees in the vehicle seat air conditioner 630 used in the seat 1 on the left side (Y-axis positive direction side) of the vehicle 1000.

That is, in a case where the direction of solar radiation is in the range of 30 degrees to 150 degrees, the solar radiation is emitted from the right side (door side of the vehicle 1000) for the occupant seated in the right seat of the vehicle 1000, and it can be determined that the occupant seated in the right seat of the vehicle 1000 feels hotter on the right side than the left side (center console 2a side of the vehicle 1000).

In a case where the direction of solar radiation is in the range of 210 degrees to 330 degrees, the solar radiation is emitted from the left side (door side of the vehicle 1000) for the occupant seated in the left seat of the vehicle 1000, and it can be determined that the occupant seated in the left seat of the vehicle 1000 feels hotter on the left side than the right side (center console 2a side of the vehicle 1000).

If the individual controller 271 determines that the direction of solar radiation is within the predetermined angle range (YES in S703), then the process proceeds to Step S704. In Step S704, the individual controller 271 controls the vertical plate fins 123 of the second ventilation port 212b or the third ventilation port 212c of the seat 1 to adjust the blowing direction to be closer to the front (X-axis positive direction) side.

Specifically, the individual controller 271 adjusts the blowing direction to be closer to the front side than the occupant seated in the seat adjacent to the seat 1 so as to blow out air between that occupant and the steering wheel. The individual controller 271 merges the blown out air with the conditioned air blown from the vehicle air conditioner 2b, and adjusts the blowing direction to a direction between the steering wheel and the occupant seated in the seat adjacent to the seat 1 so that air is blown to a portion of the occupant's body on the door side of the vehicle 1000.

For example, the individual controller 271 adjusts the blowing direction so that air blown out from the vehicle seat air conditioner 630 and air blown out from the blowing port of the vehicle air conditioner 2b such as an air conditioner disposed on the window side of the instrument panel of the vehicle 1000 are merged to be blown to the portion of the body of the occupant seated in the seat adjacent to the seat 1 on the door side of the vehicle 1000. Then, the individual controller 271 ends the process and the process returns to Step S701 to repeat the process.

If the individual controller 271 determines that the amount of solar radiation is less than the solar radiation amount threshold (NO in S702), and if the individual controller 271 determines that the direction of solar radiation is out of the predetermined angle range (NO in S703), then the individual controller 271 ends the process, and the process returns to Step S701 to repeat the process.

Note that the second ventilation port 212b and the third ventilation port 212c, which are two ventilation ports, do not have to be provided on the side surface of the seat 1. As in the third modification of the first embodiment, the configuration is possible in which only one ventilation port is provided on the side surface of the seat 1 and the vertical plate fins 123 are further provided in that ventilation port.

In addition, the individual controller 271 may control the blower 36 to change the blowing amount according to the amount of solar radiation acquired from the solar radiation sensor 52. For example, the individual controller 271 sets the blowing amount to a first air volume if the acquired amount of solar radiation is equal to or greater than a first solar radiation amount threshold and smaller than a second solar radiation amount threshold, sets the blowing amount to a second air volume that is larger than the first air volume if the acquired amount of solar radiation is equal to or greater than the second solar radiation amount threshold and smaller than a third solar radiation amount threshold, and sets the blowing amount to a third air volume that is larger than the second air volume if the acquired amount of solar radiation is equal to or greater than the third solar radiation amount threshold. For example, the first solar radiation amount threshold is 800 W/m², the second solar radiation amount threshold is 900 W/m², and the third solar radiation amount threshold is 1000 W/m². The first air volume is 20 m³/h, the second air volume is 25 m³/h, and the third air volume is 30 m³/h.

The solar radiation sensor 52 does not have to be provided on the dashboard, and may be provided on the seat 1 and a door-side portion of the seat adjacent to the seat 1. In this case, the individual controller 271 may determine the direction of solar radiation by comparing the amounts of solar radiation detected by the solar radiation sensors 52 provided on the left and right seats. Specifically, in a case where the ratio of the amounts of solar radiation detected by the solar radiation sensors 52 is a predetermined value or more, the individual controller 271 may execute the process of step S704 described above.

Alternatively, the individual controller 271 may execute the above-described process based on information acquired from a temperature sensor such as a non-contact thermometer or thermography instead of the solar radiation sensor 52. Specifically, the individual controller 271 may execute the process of Step S704 in a case where it is determined that a portion of the body of the occupant seated in the seat adjacent to the seat 1 on the door side is equal to or larger than a predetermined value based on the information acquired from the temperature sensor.

### Functional Effects

Next, the functional effects of the vehicle seat air conditioner according to the present embodiment will be described.

As described above, the vehicle seat air conditioner 630 according to the present embodiment is provided in the first seat of the vehicle 1000, and performs air conditioning for the second seat disposed adjacent to the first seat in the left-right direction of the vehicle 1000. The vehicle seat air conditioner 630 includes the blower 36, a blowing duct that blows out air guided by the blower 36 from a blowing port provided on a side surface of the first seat, and the individual controller (controller) 271 for controlling the blower 36. The individual controller 271 controls at least one of the blowing direction and the blowing amount of air blown out from the blowing port based on the detection result of the temperature detection sensor that detects information on the temperature of the second seat.

According to the configuration, at least one of the blowing direction and the blowing amount of air blown out from the blowing port can be controlled based on the information on the temperature of the second seat detected by the temperature detection sensor, so that it is possible to prevent a reduction in comfort due to solar radiation for the occupant seated in the second seat. Therefore, the vehicle seat air conditioner 630 according to the present embodiment can provide a more comfortable air-conditioned environment for that occupant.

The temperature detection sensor may be the solar radiation sensor 52 that detects the amount of solar radiation entering the interior of the vehicle 1000.

According to the configuration, at least one of the blowing direction and the blowing amount of air blown out from the blowing port can be controlled based on the amount of solar radiation detected by the solar radiation sensor 52, so that it is possible to prevent a reduction in comfort due to solar radiation for the occupant seated in the second seat.

The temperature detection sensor may be a non-contact thermometer or thermography.

According to the configuration, at least one of the blowing direction and the blowing amount of air blown out from the blowing port can be controlled based on the information on the temperature detected by the non-contact thermometer or thermograph, so that it is possible to prevent a reduction in comfort due to solar radiation for the occupant seated in the second seat.

Further, in a case where the detected value indicating the information on the temperature detected by the temperature detection sensor is equal to or greater than the threshold, the individual controller 271 controls the blowing direction to be closer to the front side of the vehicle 1000 than the blowing direction for a case where the detected value is less than the threshold.

According to the configuration, in a case where the detected value related to the temperature of the second seat is equal to or greater than the threshold, the blowing direction can be controlled to be closer to the front side of the vehicle 1000, and air blown out from the vehicle seat air conditioner 630 can be easily merged with air blown from the vehicle air conditioner 2b. Therefore, air can be easily blown out to a portion of the body of the occupant seated in the second seat on the door side which is heated by solar radiation, so that it is possible to prevent a reduction in comfort due to solar radiation for the occupant seated in the second seat.

Further, in a case where the detected value indicating the information on the temperature detected by the temperature detection sensor is equal to or greater than the threshold, the individual controller 271 controls the blowing amount to be larger than the blowing amount for a case where the detected value is less than the threshold.

According to the configuration, in a case where the detected value related to the temperature of the second seat is equal to or greater than the threshold, the blowing amount can be controlled to be increased, which prevents a reduction in comfort due to solar radiation for the occupant seated in the second seat.

### First Modification of Third Embodiment

The present modification is different from the vehicle seat air conditioner according to the third embodiment in that the individual controller 271 controls the vehicle seat air conditioner 630 according to air-conditioning setting information on the vehicle air conditioner 2b. The other configurations in the present modification are similar to those in the third embodiment, and the same configurations and functions are denoted by the same reference numerals, and description of the configurations and functions is omitted.

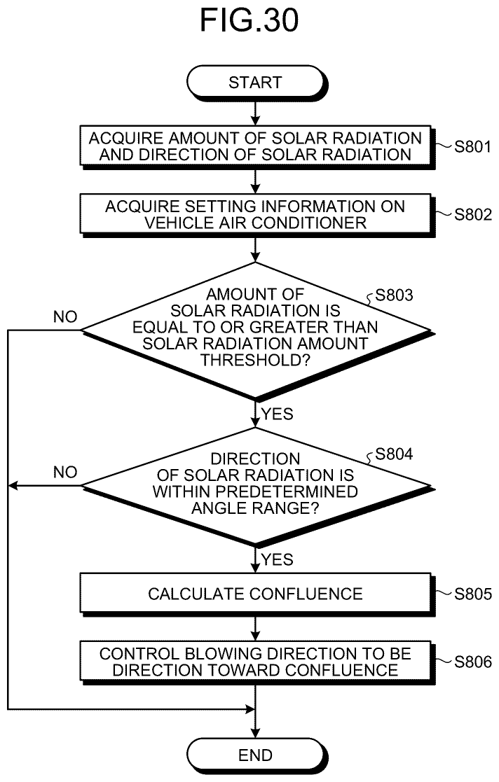

FIG. 30 is a flowchart illustrating processing of the vehicle seat air conditioner 630 according to the first modification of the third embodiment.

As illustrated in FIG. 30, the individual controller 271 of the vehicle seat air conditioner 630 first, in Step S801, acquires information on the amount of solar radiation and the direction of solar radiation from the solar radiation sensor 52.

Next, in Step S802, the individual controller 271 acquires air-conditioning setting information from the vehicle air conditioner 2b. Specifically, the individual controller 271 acquires the air volume and the blowing direction of conditioned air blown from the vehicle air conditioner 2b.

In Step S803, the individual controller 271 determines whether the amount of solar radiation acquired from the solar radiation sensor 52 is equal to or greater than a solar radiation amount threshold. The solar radiation amount threshold may be similar to the solar radiation amount threshold in the third embodiment.

If the individual controller 271 determines that the amount of solar radiation is equal to or greater than the solar radiation amount threshold (YES in S803), then the process proceeds to Step S804. In Step S804, the individual controller 271 determines whether the direction of solar radiation acquired from the solar radiation sensor 52 is within a predetermined angle range. The predetermined angle range may be similar to the predetermined angle range in the third embodiment.

If the individual controller 271 determines that the direction of solar radiation is within the predetermined angle range (YES in S804), then the process proceeds to Step S805. In Step S805, the individual controller 271 calculates a confluence of air blown out from the vehicle seat air conditioner 630 and conditioned-air blown from the vehicle air conditioner 2b.

The individual controller 271 calculates a confluence at which the air blown out from the vehicle seat air conditioner 630 and the conditioned-air blown from the vehicle air conditioner 2b merge with each other to blow the air toward a portion of the body of the occupant seated in the seat adjacent to the seat 1 on the door side of the vehicle 1000. The individual controller 271 calculates the confluence based on the setting information on the air volume and the blowing direction acquired from the vehicle air conditioner 2b.

Next, in Step S806, the individual controller 271 controls the vertical plate fins 123 of the second ventilation port 212b or the third ventilation port 212c of the seat 1 to adjust the blowing direction to a direction toward the confluence. The individual controller 271 may further control the blower 36 to adjust the blowing amount so that the merged air is blown to a portion of the body of the occupant seated in the seat adjacent to the seat 1 on the door side.

The individual controller 271 stores, for example, a table indicating a correspondence between the air volume as well as the blowing direction of the vehicle air conditioner 2b and the blowing amount as well as the blowing direction of the vehicle seat air conditioner 630. The individual controller 271 reads out the table and uses the table to control the blowing amount and the blowing direction of the vehicle seat air conditioner 630 according to the air volume and the blowing direction of the vehicle air conditioner 2b. Then, the individual controller 271 ends the process and the process returns to Step S801 to repeat the process.

If the individual controller 271 determines that the amount of solar radiation is less than the solar radiation amount threshold (NO in S803), and if the individual controller 271 determines that the direction of solar radiation is out of the predetermined angle range (NO in S804), then the individual controller 271 ends the process, and the process returns to Step S801 to repeat the process.

The individual controller 271 does not have to acquire the blowing direction of the vehicle air conditioner 2b. In this case, similarly to the third embodiment, the individual controller 271 may adjust the blowing direction of the vehicle seat air conditioner 630 so as to blow out air between the occupant seated in the seat adjacent to the seat 1 and the steering wheel, and adjust the blowing amount of the vehicle seat air conditioner 630 according to the air volume of the vehicle air conditioner 2b.

For example, the individual controller 271 performs control such that the volume of air after merging approaches a constant value by decreasing the blowing amount of the vehicle seat air conditioner 630 as the air volume of the vehicle air conditioner 2b increases and by increasing the blowing amount of the vehicle seat air conditioner 630 as the air volume of the vehicle air conditioner 2b decreases.

As described above, in the present modification, the individual controller 271 of the vehicle seat air conditioner 630 provided in the first seat of the vehicle 1000 acquires the setting information on the blowing direction and the air volume of the conditioned-air blown from the vehicle air conditioner 2b mounted on the vehicle 1000, and controls at least one of the blowing direction and the blowing amount of the vehicle seat air conditioner 630 according to the acquired setting information on the vehicle air conditioner 2b.

According to the configuration, the blowing direction, the blowing amount, and the like of the vehicle seat air conditioner 630 can be controlled in accordance with the setting information on the vehicle air conditioner 2b. Therefore, for the occupant seated in the second seat disposed adjacent to the first seat in the left-right direction of the vehicle 1000, a reduction in comfort due to solar radiation can be further prevented.

Further, the individual controller 271 calculates a confluence of the air blown out from the blowing port of the vehicle seat air conditioner 630 and the conditioned-air blown from the vehicle air conditioner 2b based on the setting information on the vehicle air conditioner 2b, and controls the blowing direction of the air blown out from the vehicle seat air conditioner 630 so as to blow out the air toward the confluence.

According to the configuration, the air blown out from the vehicle seat air conditioner 630 is easily merged with the air blown from the vehicle air conditioner 2b, so that, for the occupant seated in the second seat, a reduction in comfort due to solar radiation can be further prevented.

Further, the individual controller 271 controls at least one of the blowing direction and the blowing amount such that the air blown out from the blowing port of the vehicle seat air conditioner 630 merges with the conditioned-air blown from the vehicle air conditioner 2b and the resultant is blown to a portion of the occupant seated in the second seat on the door side of the vehicle 1000.

According to the configuration, the merged air resulting from the air blown out from the blowing port of the vehicle seat air conditioner 630 and the air blown from the vehicle air conditioner 2b is easily blown out to a portion of the body of the occupant seated in the second seat on the door side heated by solar radiation, which can further prevent a reduction in comfort due to solar radiation for the occupant seated in the second seat.

### Second Modification of Third Embodiment

The present modification is different from the vehicle seat air conditioner according to the third embodiment and the first modification thereto in that the individual controller 271 controls the vehicle air conditioner 2b. The other configurations in the present modification are similar to those in the third embodiment, and the same configurations and functions are denoted by the same reference numerals, and description of the configurations and functions is omitted.

As illustrated in FIG. 28, the individual controller 271 is electrically connected to the vehicle air conditioner 2b. The individual controller 271 outputs an instruction to the vehicle air conditioner 2b to adjust at least one of the blowing direction and the air volume of the conditioned-air blown from the blowing port 2c of the vehicle air conditioner 2b.

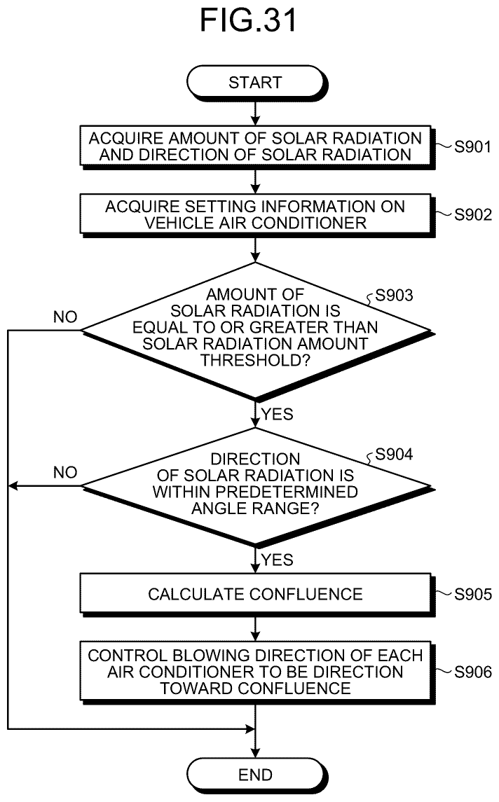

FIG. 31 is a flowchart illustrating processing of the vehicle seat air conditioner 630 according to the second modification of the third embodiment.

The processes in Steps S901 to S904 illustrated in FIG. 31 are similar to the processes in Steps S801 to S804 in the vehicle seat air conditioner according to the first modification of the third embodiment.

If the individual controller 271 determines that the direction of solar radiation is within the predetermined angle range (YES in S904), then the process proceeds to Step S905. In Step S905, the individual controller 271 calculates a confluence of air blown out from the vehicle seat air conditioner 630 and conditioned-air blown from the vehicle air conditioner 2b.

The individual controller 271 calculates a confluence at which the air blown out from the vehicle seat air conditioner 630 and the conditioned-air blown from the vehicle air conditioner 2b merge with each other to blow the air toward a portion of the body of the occupant seated in the seat adjacent to the seat 1 on the door side of the vehicle 1000. The individual controller 271 calculates a confluence in accordance with the blowing target position for the occupant seated in the seat adjacent to the seat 1, for example. Specifically, a confluence for a case where the blowing target position is the first portion may be set to a position higher than a confluence for a case where the blowing target position is the second portion.

Next, in Step S906, the individual controller 271 controls the vehicle seat air conditioner 630 and the vehicle air conditioner 2b to adjust the blowing direction of the air blown out from the vehicle seat air conditioner 630 and the air blown out from the vehicle air conditioner 2b to a direction toward the confluence. The individual controller 271 may adjust the blowing amount of the air blown out from the vehicle seat air conditioner 630 and the air blown out from the vehicle air conditioner 2b toward the occupant seated in the seat adjacent to the seat 1 after merging. Another configuration is possible in which the individual controller 271 controls only the blowing amount of the vehicle air conditioner 2b and does not control the blowing direction of the vehicle air conditioner 2b.

The individual controller 271 stores, for example, a table indicating a correspondence between the blowing direction of the vehicle air conditioner 2b as well as the air volume of the vehicle air conditioner 2b and the blowing amount and the blowing direction of the vehicle seat air conditioner 630. The individual controller 271 reads out the table and uses the table to control the air volume of the vehicle air conditioner 2b, the blowing amount and the blowing direction of the vehicle seat air conditioner 630 according to the blowing direction of the vehicle air conditioner 2b. Then, the individual controller 271 ends the process and the process returns to Step S901 to repeat the process.

If the individual controller 271 determines that the amount of solar radiation is less than the solar radiation amount threshold (NO in S903), and if the individual controller 271 determines that the direction of solar radiation is out of the predetermined angle range (NO in S904), then the individual controller 271 ends the process, and the process returns to Step S901 to repeat the process.

The vehicle air conditioner 2b may control the air conditioning of the vehicle air conditioner 2b according to the air-conditioning setting information on the vehicle seat air conditioner 630. More specifically, the vehicle air conditioner 2b acquires the blowing amount and the blowing direction of air blown out from the vehicle seat air conditioner 630, calculates a confluence with the air blown out from the vehicle seat air conditioner 630, and adjusts the blowing direction and the air volume of the conditioned-air so that the conditioned-air blown from the vehicle air conditioner 2b is directed to the confluence.

In this case, a configuration is preferable in which no instruction is output from the vehicle seat air conditioner 630 to the vehicle air conditioner 2b, and information on the blowing amount and the blowing direction of the air blown out from the vehicle seat air conditioner 630 is output. With this configuration also, it is possible to perform air-conditioning in which the air blown out from the vehicle seat air conditioner 630 and the conditioned-air blown from the vehicle air conditioner 2b are merged with each other to blow the air toward a portion of the body of the occupant seated in the seat adjacent to the seat 1 on the door side of the vehicle 1000.

As described above, in the present modification, in a case where the detected value indicating the information on the temperature detected by the temperature detection sensor is equal to or greater than the threshold, the individual controller 271 of the vehicle seat air conditioner 630 provided in the first seat of the vehicle 1000 further controls at least one of the blowing direction and the air volume of the conditioned-air blown from the vehicle air conditioner 2b mounted on the vehicle 1000 in addition to at least one of the blowing direction and the blowing amount.

According to this configuration, the individual controller 271 can control the vehicle seat air conditioner 630 and the vehicle air conditioner 2b. Therefore, for the occupant seated in the second seat disposed adjacent to the first seat in the left-right direction of the vehicle 1000, a reduction in comfort due to solar radiation can be further prevented.

Further, the individual controller 271 controls the blowing direction of the air blown out from the blowing port of the vehicle seat air conditioner 630 and the blowing direction of the conditioned-air blown from the vehicle air conditioner 2b such that the air blown out from the blowing port of the vehicle seat air conditioner 630 and the conditioned-air blown from the vehicle air conditioner 2b merge with each other.

According to the configuration, the air blown out from the vehicle seat air conditioner 630 is easily merged with the air blown from the vehicle air conditioner 2b, so that, for the occupant seated in the second seat, a reduction in comfort due to solar radiation can be further prevented.

Further, the individual controller 271 controls at least one of the blowing direction and the blowing amount of the air blown out from the blowing port of the vehicle seat air conditioner 630 and at least one of the blowing direction and the air volume of the conditioned-air blown from the vehicle air conditioner 2b such that the air blown out from the blowing port of the vehicle seat air conditioner 630 is merged with the conditioned-air blown from the vehicle air conditioner 2b and the resultant is blown to a portion of the occupant seated in the second seat on the door side of the vehicle 1000.

According to the configuration, the merged air resulting from the air blown out from the blowing port of the vehicle seat air conditioner 630 and the air blown from the vehicle air conditioner 2b is easily blown out to a portion of the body of the occupant seated in the second seat on the door side heated by solar radiation, which can further prevent a reduction in comfort due to solar radiation for the occupant seated in the second seat.

### Fourth Embodiment

The present embodiment is different from the vehicle seat air conditioner of the second embodiment and the like in that a vehicle seat air conditioner 730 used in the seat 1 controls air-conditioning based on seat positions of the seat 1 and the seat adjacent to the seat 1. The configuration of the vehicle seat air conditioner 730 in the present embodiment is similar to that of the vehicle seat air conditioner 430 in the second embodiment, and the same configurations and functions are denoted by the same reference numerals, and detailed description of the configurations and functions is omitted.

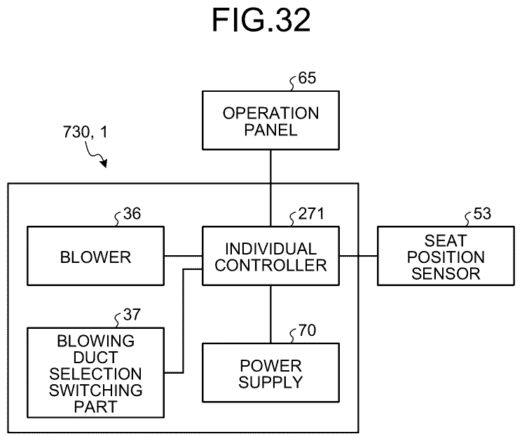

FIG. 32 is a block diagram illustrating the vehicle seat air conditioner 730 according to the fourth embodiment.

As illustrated in FIG. 32, in the vehicle seat air conditioner 730, the individual controller 271 is electrically connected to a seat position sensor 53. The seat position sensor 53 detects the seat position of the seat 1 and the seat position of the seat adjacent to the seat 1.

The seat position herein includes a reclining angle and a slide position of the seat. For example, in a case where the reclining angle and the slide position of the seat 1 can be electrically changed, the seat position sensor 53 may be an adjusting unit that adjusts the reclining angle of the seat 1 or an adjusting unit that adjusts the slide position of the seat 1.

That is, the individual controller 271 may acquire the reclining angle and the slide position of the seat 1 from the adjusting units.

In a case where the reclining angle and the slide position of the seat 1 can be changed only manually, the seat position sensor 53 may be a gyro sensor for detecting the reclining angle or a sensor for detecting the slide position of the seat 1 provided on the seat 1. That is, the individual controller 271 may acquire the reclining angle and the slide position of the seat 1 from the detection results of the sensors.

The reclining angle is, for example, a rotation angle of a reclining motor from a reference state in which the seat back 13 is substantially parallel to the Z-axis direction. Further, the slide position is represented by, for example, a distance of the movement in the X-axis direction of the seat 1 with respect to a reference state in which the seat 1 is located furthest forward (the X-axis positive direction side).

Further, the seat 1 herein can correspond to the “first seat” in the appended claims, and a seat adjacent to the seat 1 can correspond to the “second seat” in the appended claims.

### Processing

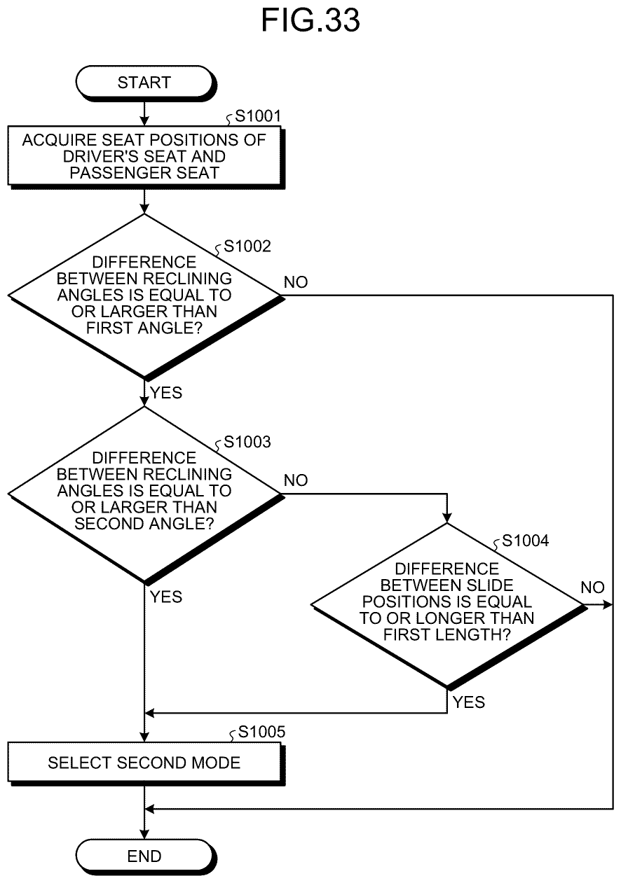

FIG. 33 is a flowchart illustrating processing of the vehicle seat air conditioner 730 according to the fourth embodiment.

As illustrated in FIG. 33, the individual controller 271 of the vehicle seat air conditioner 730 first acquires, in Step S1001, the seat positions of the driver's seat 1A and the passenger seat 1B from the seat position sensor 53.

Next, in Step S1002, the individual controller 271 determines whether the difference between the reclining angle of the driver's seat 1A and the reclining angle of the passenger seat 1B acquired from the seat position sensor 53 is equal to or larger than a first angle. The first angle is, for example, 10 degrees.

Here, the individual controller 271A of the driver's seat 1A determines whether an angle obtained by subtracting the reclining angle of the passenger seat 1B from the reclining angle of the driver's seat 1A is equal to or larger than the first angle. In other words, the individual controller 271A determines whether the driver's seat 1A is inclined rearward (the X-axis negative direction side) by the first angle or larger with respect to the passenger seat 1B.

Further, the individual controller 271B of the passenger seat 1B determines whether an angle obtained by subtracting the reclining angle of the driver's seat 1A from the reclining angle of the passenger seat 1B is equal to or larger than the first angle. In other words, the individual controller 271B determines whether the passenger seat 1B is inclined rearward by the first angle or larger with respect to the driver's seat 1A.

If the individual controller 271 determines that the difference between the reclining angles is equal to or larger than the first angle (YES in S1002), then the process proceeds to Step S1003. In Step S1003, the individual controller 271 determines whether the difference between the reclining angle of the driver's seat 1A and the reclining angle of the passenger seat 1B acquired from the seat position sensor 53 is equal to or larger than a second angle. The second angle is, for example, 20 degrees.

Here, as with Step S1002, the individual controller 271A of the driver's seat 1A determines whether an angle obtained by subtracting the reclining angle of the passenger seat 1B from the reclining angle of the driver's seat 1A is equal to or larger than the second angle. In other words, the individual controller 271A determines whether the driver's seat 1A is inclined rearward (the X-axis negative direction side) by the second angle or larger with respect to the passenger seat 1B. Further, the individual controller 271B of the passenger seat 1B determines whether an angle obtained by subtracting the reclining angle of the driver's seat 1A from the reclining angle of the passenger seat 1B is equal to or larger than the second angle. In other words, the individual controller 271B determines whether the passenger seat 1B is inclined rearward by the second angle or larger with respect to the driver's seat 1A.

If the individual controller 271 determines that the difference between the reclining angles is less than the second angle (NO in S1003), then the process proceeds to Step S1004. In Step S1004, the individual controller 271 determines whether the difference between the slide position of the driver's seat 1A and the slide position of the passenger seat 1B acquired from the seat position sensor 53 is equal to or longer than a first length. The first length is, for example, 150 mm.

Here, the individual controller 271A of the driver's seat 1A determines whether a length obtained by subtracting the slide position of the passenger seat 1B from the slide position of the driver's seat 1A is equal to or longer than the first length. In other words, the individual controller 271A determines whether the driver's seat 1A is positioned rearward with respect to the passenger seat 1B by the first length or longer. The individual controller 271B of the passenger seat 1B determines whether a length obtained by subtracting the slide position of the driver's seat 1A from the slide position of the passenger seat 1B is equal to or longer than the first length. In other words, the individual controller 271B determines whether the passenger seat 1B is positioned rearward with respect to the driver's seat 1A by the first length or longer.

If the individual controller 271 determines that the difference between the reclining angles is equal to or larger than the second angle (YES in S1003), and if the individual controller 271 determines that the difference between the slide positions is equal to or longer than the first length (YES in S1004), then the process proceeds to Step S1005. In Step S1005, the individual controller 271 controls the blowing duct selection switching part 37 to execute the second mode. Then, the individual controller 271 ends the process and the process returns to Step S1001 to repeat the process.

If the individual controller 271 determines that the difference between the reclining angles is less than the first angle (NO in S1002), and if the individual controller 271 determines that the difference between the slide positions is shorter than the first length (NO in S1004), then the individual controller 271 ends the process, and the process returns to Step S1001 to repeat the process.

The individual controller 271 may store a table indicating a correspondence between the difference in reclining angle as well as the difference in slide position and the mode of the blowing duct selection switching part 37. In this case, the individual controller 271 reads out the table and uses the table to control the blowing duct selection switching part 37 according to the difference in reclining angle and the difference in slide position.

The configuration of the individual controller 271 is not limited to the configuration in which the mode of the blowing duct selection switching part 37 is selected according to the difference in reclining angle and the difference in slide position, and the mode of the blowing duct selection switching part 37 may be selected only according to the difference in reclining angle. For example, in a case where the individual controller 271 determines, in Step S1003, that the difference between the reclining angles is less than the second angle, the process may end to return to Step S1001 without proceeding to Step S1004.

### Functional Effects

Next, the functional effects of the vehicle seat air conditioner according to the present embodiment will be described.

As described above, the vehicle seat air conditioner 730 according to the present embodiment is provided in the first seat of the vehicle 1000, and performs air conditioning for the second seat disposed adjacent to the first seat in the left-right direction of the vehicle 1000. The vehicle seat air conditioner 730 includes the blower 36, the first blowing duct 34 that blows out air guided by the blower 36 from the first blowing port 34a provided on a side surface of the first seat, the second blowing duct 35 that blows out the air guided by the blower 36 from the second blowing port 35a that is provided below the first blowing port 34a on the first seat, the blowing duct selection switching part 37 that selects a ventilation path, and the individual controller (controller) 271 that controls the blower 36 and the blowing duct selection switching part 37.

The blowing duct selection switching part 37 has the first mode for guiding the air guided by the blower 36 to the first blowing duct 34 and the second mode for guiding the air guided by the blower 36 to the second blowing duct 35. The individual controller 271 switches between the modes of the first mode and the second mode of the blowing duct selection switching part 37 based on at least one of the reclining angle and the slide position of each of the first seat and the second seat.

According to the configuration, the modes of the blowing duct selection switching part 37 can be switched based on at least one of the reclining angle and the slide position of each of the first seat and the second seat, and air can be blown out more reliably to the blowing target position of the occupant seated in the second seat. Therefore, the vehicle seat air conditioner 730 according to the present embodiment can provide a more comfortable air-conditioned environment for that occupant.

The second blowing port 35a is provided below the first blowing port 34a on the side surface of the seat back 13 of the first seat.

According to the configuration, in a case where two blowing ports are provided on the side surface of the seat back 13 of the first seat, it is possible to execute the second mode in which air is blown out from the second blowing port 35a which is less affected by reclining and sliding based on at least one of the reclining angle and the slide position of each of the first seat and the second seat. Therefore, air can be blown out more reliably to the blowing target position of the occupant seated in the second seat.

In a case where the angle obtained by subtracting the reclining angle of the second seat from the reclining angle of the first seat is equal to or larger than the first angle and where the length obtained by subtracting the slide position of the second seat from the slide position of the first seat is equal to or longer than the first length, the individual controller 271 causes the blowing duct selection switching part 37 to execute the second mode.

According to the configuration, in a case where the seat back 13 of the first seat is positioned rearward with respect to the second seat to some extent or more due to reclining and sliding of the first seat, the blowing duct selection switching part 37 is caused to execute the second mode, which allows air to be blown out from the second blowing port 35a that is less affected by reclining and sliding. Therefore, air can be blown out more reliably to the blowing target position of the occupant seated in the second seat.

In a case where the angle obtained by subtracting the reclining angle of the second seat from the reclining angle of the first seat is equal to or larger than the second angle that is larger than the first angle, the individual controller 271 causes the blowing duct selection switching part 37 to execute the second mode regardless of the length obtained by subtracting the slide position of the second seat from the slide position of the first seat.

According to the configuration, in a case where the seat back 13 of the first seat is positioned rearward with respect to the second seat to some extent or more due to reclining of the first seat, the blowing duct selection switching part 37 is caused to execute the second mode, which allows air to be blown out from the second blowing port 35a that is less affected by reclining and sliding. Therefore, air can be blown out more reliably to the blowing target position of the occupant seated in the second seat.

The individual controller 271 switches the modes of the blowing duct selection switching part 37 based on a table indicating a correspondence between the angle obtained by subtracting the reclining angle of the second seat from the reclining angle of the first seat as well as the length obtained by subtracting the slide position of the second seat from the slide position of the first seat and the modes of the blowing duct selection switching part 37.

According to the configuration, the modes of the blowing duct selection switching part 37 can be switched based on the table indicating the correspondence between the seat positions of the first seat and the second seat and the mode of the blowing duct selection switching part 37, and air can be blown out more reliably to the blowing target position of the occupant seated in the second seat.

For example, when the blowing duct selection switching part 37B of the passenger seat 1B is caused to execute the first mode in a case where the seat back 13 of the passenger seat 1B is positioned rearward to some extent with respect to the seat back 13 of the driver's seat 1A, such as a case where the passenger seat 1B is reclined by a predetermined angle or more as compared to the driver's seat 1A to incline the seat back 13 rearward, there is a possibility that air blown out from the first blowing port 34Aa is blown out onto a surface on the rear side (X-axis negative direction side) of the seat back 13 of the driver's seat 1A, and thus the air cannot be blown out to the blowing target position of the occupant seated in the driver's seat 1A.

According to the present embodiment, the mode of the blowing duct selection switching part 37 can be selected according to the difference in reclining angle and the difference in slide position between adjacent seats. Specifically, the blowing duct selection switching part 37 can execute the second mode in a case where the difference in reclining angle is equal to or larger than the second angle, where the difference in reclining angle is equal to or larger than the first angle, and where the difference in slide position is equal to or longer than the first length.

Therefore, for example, even in a case where the passenger seat 1B is reclined by a predetermined angle or larger as compared to the driver's seat 1A and the seat back 13 is inclined rearward, air can be blown out from the second blowing port 35Ba that is less affected by the reclining than the first blowing port 34Ba, and the air can be blown out more reliably to the blowing target position.

In S1005, the individual controller 271 may output an instruction to the vehicle air conditioner 2b to thereby adjust the blowing direction of the conditioned-air blown from the blowing port 2c of the vehicle air conditioner 2b. Specifically, the individual controller 271 may adjust the blowing direction and the air volume from the vehicle air conditioner 2b so that air is directed to the blowing target position of the occupant. According to the configuration, for example, even in a case where the vehicle seat air conditioner 730 does not have the second blowing port 35a, that is, in a case where the vehicle seat air conditioner 730 includes one blowing port also, conditioned-air can be blown from the vehicle air conditioner 2b that is hardly affected by reclining and sliding. At this time, the individual controller 271 may control the vehicle seat air conditioner 730 so as not to blow out air from the vehicle seat air conditioner 730.

### Modification of Fourth Embodiment

The present modification is different from the vehicle seat air conditioner of the fourth embodiment in that the seat portion 11 of the seat 1 is provided with a third blowing port 38a instead of the second blowing port 35a. The other configurations in the present modification are similar to those in the fourth embodiment, and the same configurations and functions are denoted by the same reference numerals, and detailed description of the configurations and functions is omitted.

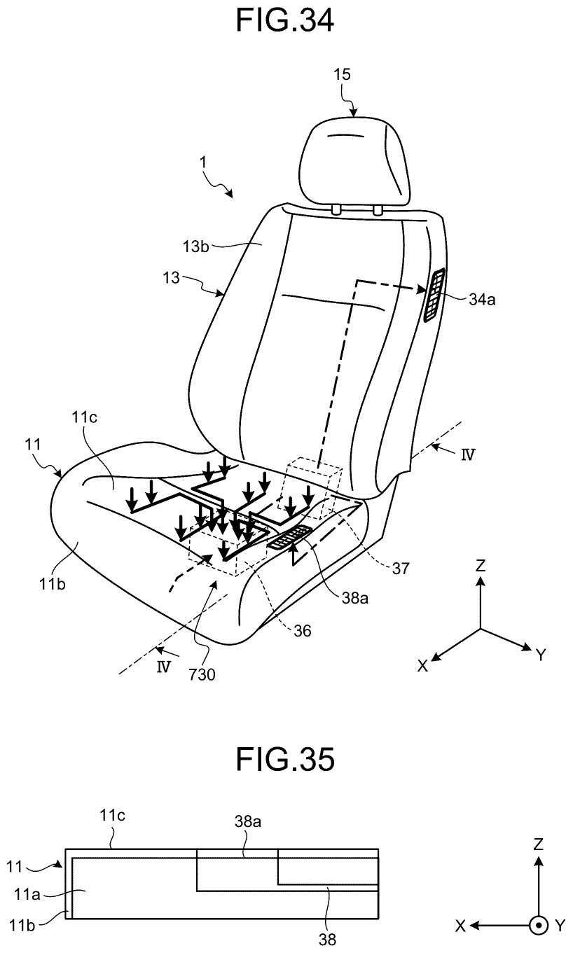

FIG. 34 is a perspective view illustrating the appearance of the seat 1 provided with the vehicle seat air conditioner 730 according to the modification of the fourth embodiment. FIG. 35 is a cross-sectional view of the seat portion 11 of the seat 1 provided with the vehicle seat air conditioner 730 taken along line IV-IV in FIG. 34.

As illustrated in FIGS. 34 and 35, the third blowing port 38a is formed in the seat portion 11 of the seat 1 provided with the vehicle seat air conditioner 730 according to the present modification. In the present modification, the third blowing port 38a is formed, of both ends in the Y-axis direction of the seat surface 11c which is the surface on which the occupant sits on the seat 1, at the end on the seat side adjacent to the seat 1. The end is, for example, a portion protruding from the seat surface 11c in the Z-axis positive direction. The third blowing port 38a may be formed on the side surface of the seat 1 facing the seat adjacent to the seat 1.

Air is guided to the third blowing port 38a by the blower 36 via a third blowing duct 38. The third blowing port 38a is connected to the blowing duct selection switching part 37 via the third blowing duct 38. The third blowing duct 38 may be a simple through hole formed in the first seat pad 11a. The third blowing duct 38 can correspond to a “second blowing duct” or a “third blowing duct” in the appended claims. The third blowing port 38a can correspond to a “second blowing port” or a “third blowing port” in the appended claims.

That is, the blowing duct selection switching part 37 is driven and controlled by the individual controller 271 to select one mode from among a first mode in which air guided from the air blowing duct 33 is guided only to the first blowing duct 34 and a third mode in which the air guided from the air blowing duct 33 is guided only to the third blowing duct 38. The third mode can correspond to a “second mode” or a “third mode” in the appended claims.

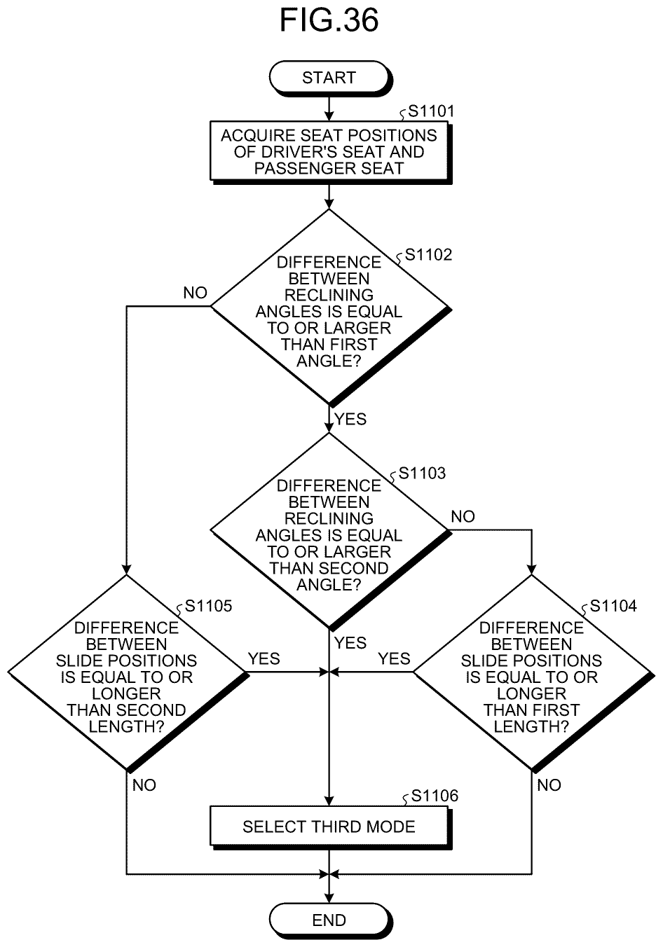

FIG. 36 is a flowchart illustrating processing of the vehicle seat air conditioner 730 according to the modification of the fourth embodiment.

The processes in Steps S1101 to S1103 illustrated in FIG. 36 are similar to the processes in Steps S1001 to S1003 in the vehicle seat air conditioner according to the fourth embodiment.

If the individual controller 271 determines that the difference between the reclining angles is less than the second angle (NO in S1103), then the process proceeds to Step S1104. In Step S1104, the individual controller 271 determines whether the difference between the slide position of the driver's seat 1A and the slide position of the passenger seat 1B acquired from the seat position sensor 53 is equal to or longer than a first length. The first length is, for example, 100 mm.

Here, the individual controller 271A of the driver's seat 1A determines whether a length obtained by subtracting the slide position of the passenger seat 1B from the slide position of the driver's seat 1A is equal to or longer than the first length. In other words, the individual controller 271A determines whether the driver's seat 1A is positioned rearward with respect to the passenger seat 1B by the first length or longer. The individual controller 271B of the passenger seat 1B determines whether a length obtained by subtracting the slide position of the driver's seat 1A from the slide position of the passenger seat 1B is equal to or longer than the first length. In other words, the individual controller 271B determines whether the passenger seat 1B is positioned rearward with respect to the driver's seat 1A by the first length or longer.

On the other hand, if the individual controller 271 determines that the difference between the reclining angles is less than the first angle (NO in S1102), then the process proceeds to Step S1105. In Step S1105, the individual controller 271 determines whether the difference between the slide position of the driver's seat 1A and the slide position of the passenger seat 1B acquired from the seat position sensor 53 is equal to or longer than a second length. The second length is, for example, 150 mm.

Here, the individual controller 271A of the driver's seat 1A determines whether a length obtained by subtracting the slide position of the passenger seat 1B from the slide position of the driver's seat 1A is equal to or longer than the second length. In other words, the individual controller 271A determines whether the driver's seat 1A is positioned rearward with respect to the passenger seat 1B by the second length or longer.

The individual controller 271B of the passenger seat 1B determines whether a length obtained by subtracting the slide position of the driver's seat 1A from the slide position of the passenger seat 1B is equal to or longer than the second length. In other words, the individual controller 271B determines whether the passenger seat 1B is positioned rearward with respect to the driver's seat 1A by the second length or longer.

If the individual controller 271 determines that the difference between the reclining angles is equal to or larger than the second angle (YES in S1103), if the individual controller 271 determines that the difference between the slide positions is equal to or longer than the first length (YES in S1104), and if the individual controller 271 determines that the difference between the slide positions is equal to or longer than the second length (YES in S1105), then the process proceeds to Step S1106. In Step S1106, the individual controller 271 controls the blowing duct selection switching part 37 to execute the third mode. Then, the individual controller 271 ends the process and the process returns to Step S1101 to repeat the process.

If the individual controller 271 determines that the difference between the slide positions is shorter than the first length (NO in S1104), and if the individual controller 271 determines that the difference between the slide positions is shorter than the second length (NO in S1105), then the individual controller 271 ends the process, and the process returns to Step S1101 to repeat the process.

Accordingly, even in a case where the difference between the reclining angles is equal to or larger than the predetermined angle, air can be blown out from the third blowing port 38a that is less affected by the reclining than the first blowing port 34a. Further, even in a case where the difference between the slide positions is equal to or longer than the first length, air can be blown out from the third blowing port 38a that is less affected by the sliding than the first blowing port 34a. Therefore, the air can be blown out to the blowing target position more reliably.

Note that the first length and the second length may be the same length. For example, both the first length and the second length may be 150 mm.

In the vehicle seat air conditioner 730, the third blowing port 38a may be provided in addition to the first blowing port 34a and the second blowing port 35a.

In this case, for example, the individual controller 271 may cause the blowing duct selection switching part 37 to execute the third mode in a case where the difference between the slide positions is equal to or longer than the second length in the processing illustrated in FIG. 33. The second length is, for example, 200 mm.

Specifically, the individual controller 271B of the passenger seat 1B causes the blowing duct selection switching part 37 to execute the third mode in a case where the passenger seat 1B is slid by the second length or longer as compared with the driver's seat 1A.

According to the configuration, even in a case where the difference in sliding is large, air can be blown out from the third blowing port 38a that is less affected by sliding than the first blowing port 34a and the second blowing port 35a, and air can be blown out to the blowing target position more reliably.

As described above, the vehicle seat air conditioner 730 according to the present modification is provided in the first seat of the vehicle 1000, and performs air conditioning for the second seat disposed adjacent to the first seat in the left-right direction of the vehicle 1000. The third blowing port 38a is provided in a portion of the seat portion 11 of the first seat on the second seat side, instead of the second blowing port 35a of the vehicle seat air conditioner in the fourth embodiment.

According to the configuration, since the third blowing port 38a is provided at a position less affected by the reclining and sliding, air can be blown out more reliably to the blowing target position of the occupant seated in the second seat by executing the third mode based on at least one of the reclining angle and the slide position of each of the first seat and the second seat.

Further, in a case where the angle obtained by subtracting the reclining angle of the second seat from the reclining angle of the first seat is equal to or larger than the first angle and where the length obtained by subtracting the slide position of the second seat from the slide position of the first seat is equal to or longer than the first length, the individual controller 271 causes the blowing duct selection switching part 37 to execute the second mode. In a case where the length obtained by subtracting the slide position of the second seat from the slide position of the first seat is equal to or longer than the second length which is longer than the first length, the individual controller 271 causes the blowing duct selection switching part 37 to execute the third mode regardless of the angle obtained by subtracting the reclining angle of the second seat from the reclining angle of the first seat.

According to the configuration, in a case where the seat back 13 of the first seat is positioned rearward with respect to the second seat to some extent or more due to sliding of the first seat, the blowing duct selection switching part 37 is caused to execute the second mode, which allows air to be blown out from the third blowing port 38a that is less affected by sliding. Therefore, air can be blown out more reliably to the blowing target position of the occupant seated in the second seat.

The vehicle seat air conditioner 730 of the present modification may further include the third blowing duct 38 that blows out air guided by the blower 36 from the third blowing port 38a provided in a portion of the seat portion 11 of the first seat on the second seat side. The blowing duct selection switching part 37 further has a third mode for guiding the air guided by the blower 36 to the third blowing duct 38. The individual controller 271 switches between the modes of the first mode, the second mode, and the third mode of the blowing duct selection switching part 37 based on at least one of the reclining angle and the slide position of each of the first seat and the second seat.

According to the configuration, since the third blowing port 38a is provided at a position less affected by the reclining and sliding, air can be blown out more reliably to the blowing target position of the occupant seated in the second seat by executing the third mode based on at least one of the reclining angle and the slide position of each of the first seat and the second seat.

Further, in a case where the angle obtained by subtracting the reclining angle of the second seat from the reclining angle of the first seat is equal to or larger than the first angle and where the length obtained by subtracting the slide position of the second seat from the slide position of the first seat is equal to or longer than the first length, the individual controller 271 causes the blowing duct selection switching part 37 to execute the second mode. In a case where the length obtained by subtracting the slide position of the second seat from the slide position of the first seat is equal to or longer than the second length which is longer than the first length, the individual controller 271 causes the blowing duct selection switching part 37 to execute the third mode regardless of the angle obtained by subtracting the reclining angle of the second seat from the reclining angle of the first seat.

According to the configuration, in a case where the seat back 13 of the first seat is positioned rearward with respect to the second seat to some extent or more due to sliding of the first seat, the blowing duct selection switching part 37 is caused to execute the second mode, which allows air to be blown out from the third blowing port 38a that is less affected by sliding. Therefore, air can be blown out more reliably to the blowing target position of the occupant seated in the second seat.

### Fifth Embodiment

In the present embodiment, a vehicle seat air-conditioning system 3b executes the control described in each of the first to fourth embodiments. The configuration of the vehicle seat air-conditioning system 3b in the present embodiment is similar to that of the vehicle seat air-conditioning system 3 in the first embodiment, and the configuration of a vehicle seat air conditioner 830 included in the vehicle seat air-conditioning system 3b is similar to that of the vehicle seat air conditioner 430 in the second embodiment.

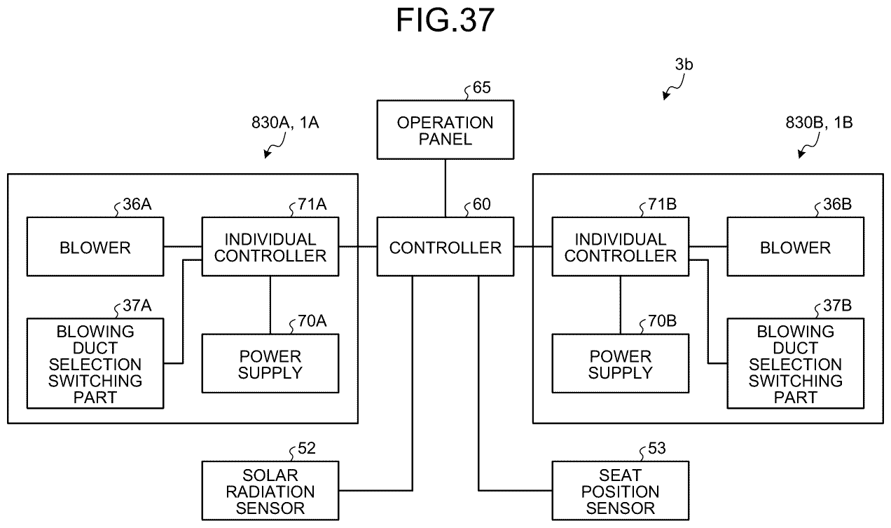

FIG. 37 is a block diagram illustrating the vehicle seat air-conditioning system 3b according to the fifth embodiment.

As illustrated in FIG. 37, in the vehicle seat air-conditioning system 3b, the controller 60 is electrically connected to the solar radiation sensor 52 and the seat position sensor 53. The sensors are similar to the solar radiation sensor 52 in the third embodiment and the seat position sensor 53 in the fourth embodiment.

### Processing

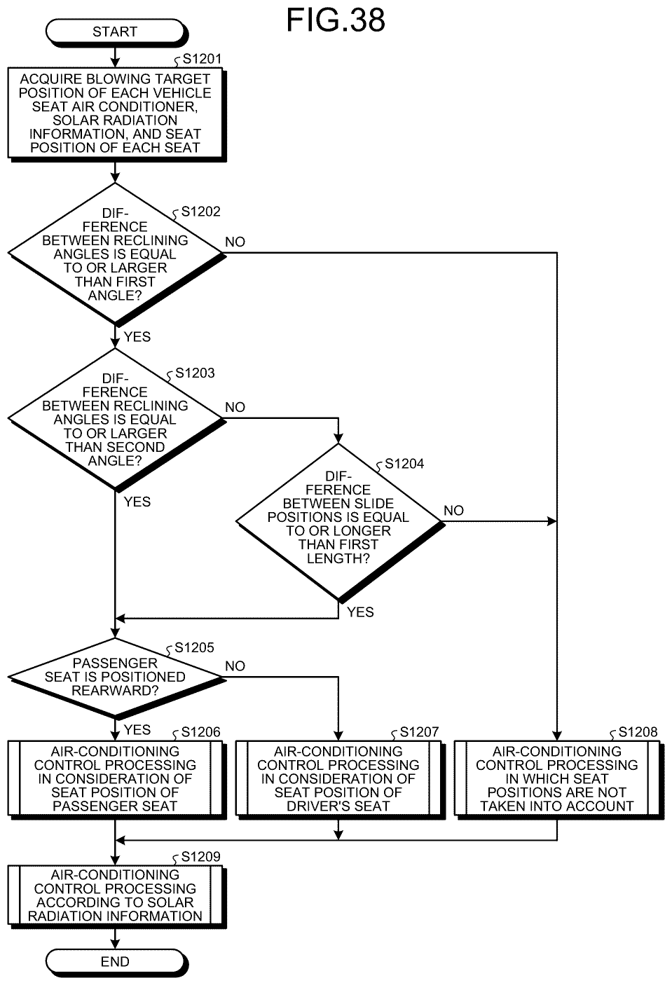

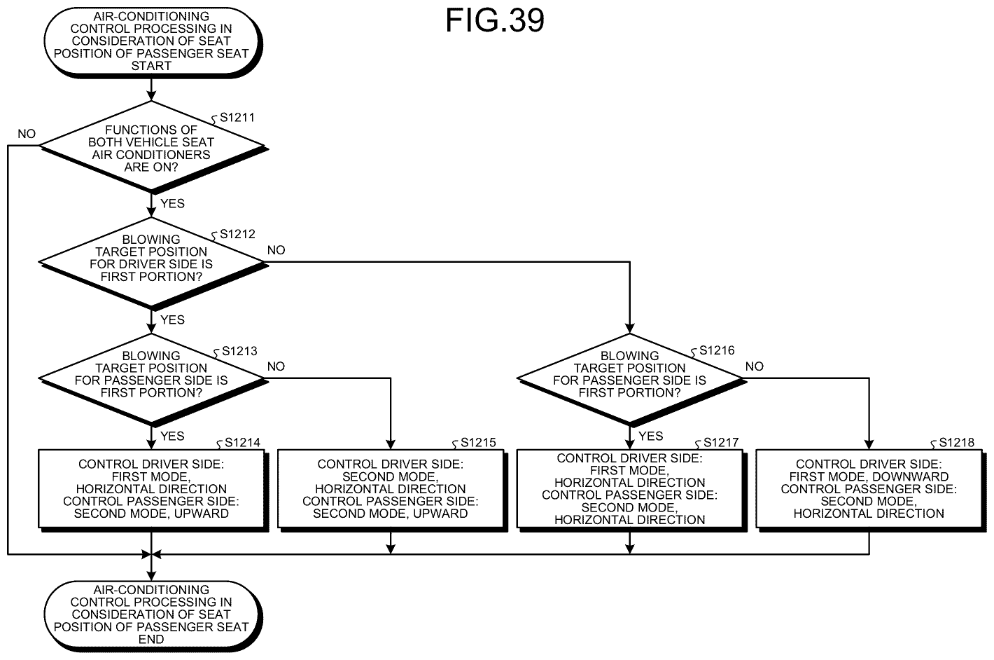

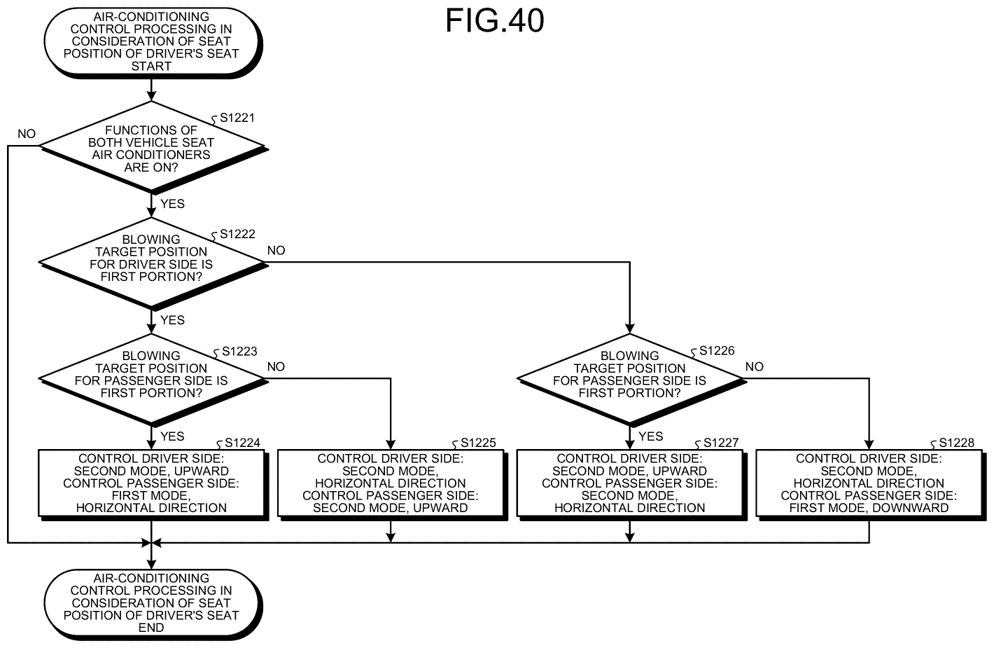

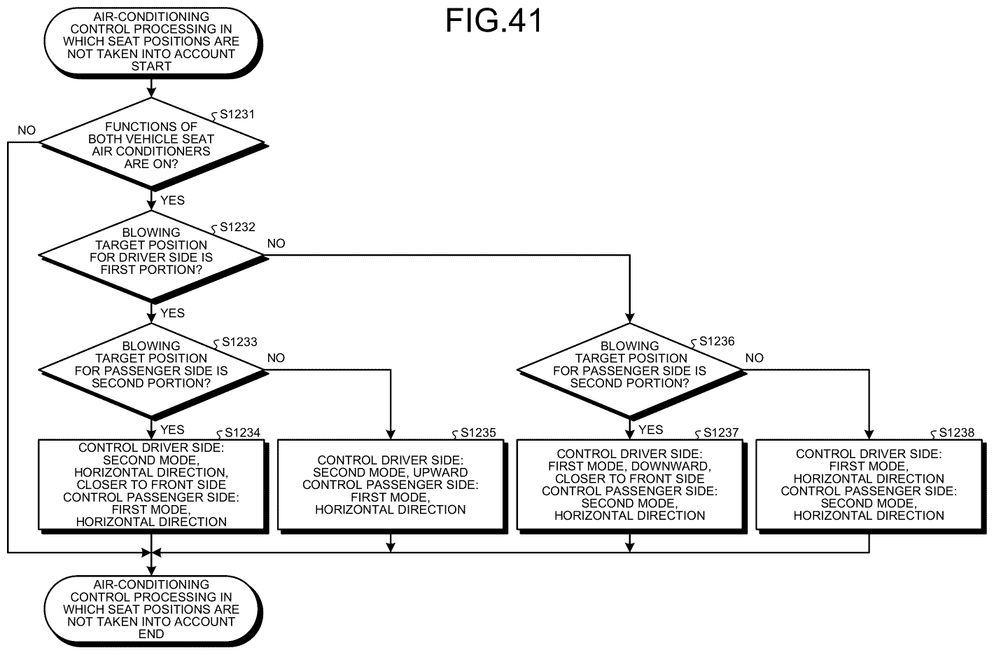

FIG. 38 is a flowchart illustrating processing of the vehicle seat air-conditioning system 3b according to the fifth embodiment. FIG. 39 is a flowchart illustrating a subroutine of air-conditioning control processing in consideration of the seat position of the passenger seat 1B in FIG. 38. FIG. 40 is a flowchart illustrating a subroutine of air-conditioning control processing in consideration of the seat position of the driver's seat 1A in FIG. 38. FIG. 41 is a flowchart illustrating a subroutine of air-conditioning control processing in which the seat positions are not taken into account in FIG. 38.

As illustrated in FIG. 38, the controller 60 of the vehicle seat air-conditioning system 3b, first, in Step S1201, acquires the blowing target position of each of the vehicle seat air conditioners 830, that is, the blowing target position of a vehicle seat air conditioner 830B for the driver side and the blowing target position of a vehicle seat air conditioner 830A for the passenger side.

Further, the controller 60 acquires information on the amount of solar radiation and the direction of solar radiation from the solar radiation sensor 52.

The controller 60 may directly acquire the information on the amount of solar radiation and the direction of solar radiation from the solar radiation sensor 52, or may acquire these pieces of information from the vehicle air conditioner 2b connected to the solar radiation sensor 52. Further, the controller 60 acquires the seat positions of the driver's seat 1A and the passenger seat 1B from the seat position sensor 53.

Next, in Step S1202, the controller 60 determines whether the difference between the reclining angle of the driver's seat 1A and the reclining angle of the passenger seat 1B acquired from the seat position sensor 53 is equal to or larger than a first angle. The first angle is, for example, 10 degrees.

If the controller 60 determines that the difference between the reclining angles is equal to or larger than the first angle (YES in S1202), then the process proceeds to Step S1203. In Step S1203, the controller 60 determines whether the difference between the reclining angle of the driver's seat 1A and the reclining angle of the passenger seat 1B acquired from the seat position sensor 53 is equal to or larger than a second angle. The second angle is, for example, 20 degrees.

If the controller 60 determines that the difference between the reclining angles is less than the second angle (NO in S1203), then the process proceeds to Step S1204. In Step S1204, the controller 60 determines whether the difference between the slide position of the driver's seat 1A and the slide position of the passenger seat 1B acquired from the seat position sensor 53 is equal to or longer than a first length. The first length is, for example, 150 mm.

Here, in a case where the controller 60 determines that the angle obtained by subtracting the reclining angle of the passenger seat 1B from the reclining angle of the driver's seat 1A is equal to or larger than the first angle in Step S1202, the controller 60 determines whether a length obtained by subtracting the slide position of the passenger seat 1B from the slide position of the driver's seat 1A is equal to or longer than the first length.

Further, in a case where the controller 60 determines that the angle obtained by subtracting the reclining angle of the driver's seat 1A from the reclining angle of the passenger seat 1B is equal to or larger than the first angle in Step S1202, the controller 60 determines whether a length obtained by subtracting the slide position of the driver's seat 1A from the slide position of the passenger seat 1B is equal to or longer than the first length.

If the controller 60 determines that the difference between the reclining angles is equal to or larger than the second angle (YES in S1203) and if the controller 60 determines that the difference between the slide positions is equal to or longer than the first length (YES in S1204), then the process proceeds to Step S1205. In Step S1205, the controller 60 determines whether the passenger seat 1B is positioned rearward with respect to the driver's seat 1A.

In Step S1205, in a case where the controller 60 determines that the angle obtained by subtracting the reclining angle of the driver's seat 1A from the reclining angle of the passenger seat 1B is equal to or larger than the second angle in Step S1203, or, alternatively, in a case where the controller 60 determines that a length obtained by subtracting the slide position of the driver's seat 1A from the slide position of the passenger seat 1B is equal to or longer than the first length in Step S1204, the controller 60 determines that the passenger seat 1B is positioned rearward with respect to the driver's seat 1A. Further, in a case where the controller 60 determines that the angle obtained by subtracting the reclining angle of the passenger seat 1B from the reclining angle of the driver's seat 1A is equal to or larger than the second angle in Step S1203, or, alternatively, in a case where the controller 60 determines that a length obtained by subtracting the slide position of the passenger seat 1B from the slide position of the driver's seat 1A is equal to or longer than the first length in Step S1204, the controller 60 determines that the driver's seat 1A is positioned rearward with respect to the passenger seat 1B.

If the controller 60 determines that the passenger seat 1B is positioned rearward with respect to the driver's seat 1A (YES in S1205), then the process proceeds to Step S1206. In Step S1206, air-conditioning control processing in consideration of the seat position of the passenger seat 1B is executed, and thereafter, the process proceeds to Step S1209.

If the controller 60 determines that the driver's seat 1A is positioned rearward with respect to the passenger seat 1B (NO in S1205), then the process proceeds to Step S1207. In Step S1207, air-conditioning control processing in consideration of the seat position of the driver's seat 1A is executed, and thereafter, the process proceeds to Step S1209.

If the controller 60 determines that the difference between the reclining angles is less than the first angle (NO in S1202) and if the controller 60 determines that the difference between the slide positions is shorter than the first length (NO in S1204), then the process proceeds to Step S1208. In Step S1208, air-conditioning control processing in which the seat positions are not taken into account is executed, and thereafter, the process proceeds to Step S1209.

In Step S1209, air-conditioning control processing according to solar radiation information is executed. As the air-conditioning control processing according to solar radiation information, the controller 60 executes the processing illustrated in FIG. 29. Then, the controller 60 ends the process and the process returns to Step S1201 to repeat the process.

In the air-conditioning control processing in consideration of the seat position of the passenger seat 1B in Step S1206, as illustrated in FIG. 39, the controller 60 first determines, in Step S1211, whether the functions of the vehicle seat air conditioners 830 provided in the driver's seat 1A and the passenger seat 1B are both ON. The functions of the vehicle seat air conditioners 830 may be switched on or off in accordance with an input operation received by the operation panel 65.

If the controller 60 determines that the functions of the vehicle seat air conditioners 830 provided in the driver's seat 1A and the passenger seat 1B are both ON (YES in Step S1211), then the process proceeds to Step S1212. In Step S1212, the controller 60 determines whether the blowing target position for the driver side is the first portion.

If the controller 60 determines that the blowing target position for the driver side is the first portion (YES in S1212), then the process proceeds to Step S1213. In Step S1213, the controller 60 determines whether the blowing target position for the passenger side is the first portion.

If the controller 60 determines that the blowing target position for the passenger side is the first portion (YES in S1213), then the process proceeds to Step S1214. In Step S1214, the controller 60 causes the blowing duct selection switching part 37A of the driver's seat 1A to execute the first mode, and controls the horizontal plate fins 121 of the third ventilation port 12c of the driver's seat 1A to adjust the blowing direction to the horizontal direction. Further, the controller 60 causes the blowing duct selection switching part 37B of the passenger seat 1B to execute the second mode, and controls the horizontal plate fins 121 of the second ventilation port 12b of the passenger seat 1B to adjust the blowing direction upward. Then, the controller 60 finishes the air-conditioning control processing in consideration of the seat position of the passenger seat 1B.

If the controller 60 determines that the blowing target position for the passenger side is the second portion (NO in S1213), then the process proceeds to Step S1215. In Step S1215, the controller 60 causes the blowing duct selection switching part 37A of the driver's seat 1A to execute the second mode, and controls the horizontal plate fins 121 of the third ventilation port 12c of the driver's seat 1A to adjust the blowing direction to the horizontal direction. Further, the controller 60 causes the blowing duct selection switching part 37B of the passenger seat 1B to execute the second mode, and controls the horizontal plate fins 121 of the second ventilation port 12b of the passenger seat 1B to adjust the blowing direction upward. Then, the controller 60 finishes the air-conditioning control processing in consideration of the seat position of the passenger seat 1B.

If the controller 60 determines that the blowing target position for the driver side is the second portion (NO in S1212), then the process proceeds to Step S1216. In Step S1216, the controller 60 determines whether the blowing target position for the passenger side is the first portion.

If the controller 60 determines that the blowing target position for the passenger side is the first portion (YES in S1216), then the process proceeds to Step S1217. In Step S1217, the controller 60 causes the blowing duct selection switching part 37A of the driver's seat 1A to execute the first mode, and controls the horizontal plate fins 121 of the second ventilation port 12b of the driver's seat 1A to adjust the blowing direction to the horizontal direction. Further, the controller 60 causes the blowing duct selection switching part 37B of the passenger seat 1B to execute the second mode, and controls the horizontal plate fins 121 of the third ventilation port 12c of the passenger seat 1B to adjust the blowing direction to the horizontal direction. Then, the controller 60 finishes the air-conditioning control processing in consideration of the seat position of the passenger seat 1B.

If the controller 60 determines that the blowing target position for the passenger side is the second portion (NO in S1216), then the process proceeds to Step S1218. In Step S1218, the controller 60 causes the blowing duct selection switching part 37A of the driver's seat 1A to execute the first mode, and controls the horizontal plate fins 121 of the second ventilation port 12b of the driver's seat 1A to adjust the blowing direction downward. Further, the controller 60 causes the blowing duct selection switching part 37B of the passenger seat 1B to execute the second mode, and controls the horizontal plate fins 121 of the third ventilation port 12c of the passenger seat 1B to adjust the blowing direction to the horizontal direction. Then, the controller 60 finishes the air-conditioning control processing in consideration of the seat position of the passenger seat 1B.

According to Steps S1214, S1215, S1217, and S1218, in combination with Step S1209 to be executed later, it is possible to reduce interference between air blown out from both the vehicle seat air conditioners 830, to prevent a reduction in comfort due to solar radiation, and to blow out air more reliably to the blowing target position of the occupant regardless of the reclining angle and the slide position of each seat 1. In the processes, the air-conditioning control in consideration of the seat type of the adjacent seat may not be sufficiently performed; however, by preferentially performing the air-conditioning control according to the seat position of each seat, it is possible to prevent the blown out air from being blown out onto the surface on the rear side (X-axis negative direction side) of the seat back 13 of the adjacent seat and to blow out air to the blowing target position more reliably.

In the air-conditioning control processing in consideration of the seat position of the driver's seat 1A in Step S1207, as illustrated in FIG. 40, the controller 60 first determines, in Step S1221, whether the functions of the vehicle seat air conditioners 830 provided in the driver's seat 1A and the passenger seat 1B are both ON. The functions of the vehicle seat air conditioners 830 may be switched on or off in accordance with an input operation received by the operation panel 65.

If the controller 60 determines that the functions of the vehicle seat air conditioners 830 provided in the driver's seat 1A and the passenger seat 1B are both ON (YES in Step S1221), then the process proceeds to Step S1222. In Step S1222, the controller 60 determines whether the blowing target position for the driver side is the first portion.

If the controller 60 determines that the blowing target position for the driver side is the first portion (YES in S1222), then the process proceeds to Step S1223. In Step S1223, the controller 60 determines whether the blowing target position for the passenger side is the first portion.

If the controller 60 determines that the blowing target position for the passenger side is the first portion (YES in S1223), then the process proceeds to Step S1224. In Step S1224, the controller 60 causes the blowing duct selection switching part 37A of the driver's seat 1A to execute the second mode, and controls the horizontal plate fins 121 of the third ventilation port 12c of the driver's seat 1A to adjust the blowing direction upward. Further, the controller 60 causes the blowing duct selection switching part 37B of the passenger seat 1B to execute the first mode, and controls the horizontal plate fins 121 of the second ventilation port 12b of the passenger seat 1B to adjust the blowing direction to the horizontal direction. Then, the controller 60 finishes the air-conditioning control processing in consideration of the seat position of the driver's seat 1A.

If the controller 60 determines that the blowing target position for the passenger side is the second portion (NO in S1223), then the process proceeds to Step S1225. In Step S1225, the controller 60 causes the blowing duct selection switching part 37A of the driver's seat 1A to execute the second mode, and controls the horizontal plate fins 121 of the third ventilation port 12c of the driver's seat 1A to adjust the blowing direction to the horizontal direction.

Further, the controller 60 causes the blowing duct selection switching part 37B of the passenger seat 1B to execute the second mode, and controls the horizontal plate fins 121 of the second ventilation port 12b of the passenger seat 1B to adjust the blowing direction upward. Then, the controller 60 finishes the air-conditioning control processing in consideration of the seat position of the driver's seat 1A.

If the controller 60 determines that the blowing target position for the driver side is the second portion (NO in S1222), then the process proceeds to Step S1226. In Step S1226, the controller 60 determines whether the blowing target position for the passenger side is the first portion.

If the controller 60 determines that the blowing target position for the passenger side is the first portion (YES in S1226), then the process proceeds to Step S1227. In Step S1227, the controller 60 causes the blowing duct selection switching part 37A of the driver's seat 1A to execute the second mode, and controls the horizontal plate fins 121 of the second ventilation port 12b of the driver's seat 1A to adjust the blowing direction upward. Further, the controller 60 causes the blowing duct selection switching part 37B of the passenger seat 1B to execute the second mode, and controls the horizontal plate fins 121 of the third ventilation port 12c of the passenger seat 1B to adjust the blowing direction to the horizontal direction. Then, the controller 60 finishes the air-conditioning control processing in consideration of the seat position of the driver's seat 1A.

If the controller 60 determines that the blowing target position for the passenger side is the second portion (NO in S1226), then the process proceeds to Step S1228. In Step S1228, the controller 60 causes the blowing duct selection switching part 37A of the driver's seat 1A to execute the second mode, and controls the horizontal plate fins 121 of the second ventilation port 12b of the driver's seat 1A to adjust the blowing direction to the horizontal direction. Further, the controller 60 causes the blowing duct selection switching part 37B of the passenger seat 1B to execute the first mode, and controls the horizontal plate fins 121 of the third ventilation port 12c of the passenger seat 1B to adjust the blowing direction downward. Then, the controller 60 finishes the air-conditioning control processing in consideration of the seat position of the driver's seat 1A.

According to Steps S1224, S1225, S1227, and S1228, in combination with Step S1209 to be executed later, it is possible to reduce interference between air blown out from both the vehicle seat air conditioners 830, to prevent a reduction in comfort due to solar radiation, and to blow out air more reliably to the blowing target position of the occupant regardless of the reclining angle and the slide position of each seat 1. In the processes, the air-conditioning control in consideration of the seat type of the adjacent seat may not be sufficiently performed; however, by preferentially performing the air-conditioning control according to the seat position of each seat, it is possible to prevent the blown out air from being blown out onto the surface on the rear side (X-axis negative direction side) of the seat back 13 of the adjacent seat and to blow out air to the blowing target position more reliably.

In the air-conditioning control processing in which the seat positions are not taken into account in Step S1208, as illustrated in FIG. 41, the controller 60 first determines, in Step S1231, whether the functions of the vehicle seat air conditioners 830 provided in the driver's seat 1A and the passenger seat 1B are both ON. The functions of the vehicle seat air conditioners 830 may be switched on or off in accordance with an input operation received by the operation panel 65.

If the controller 60 determines that the functions of the vehicle seat air conditioners 830 provided in the driver's seat 1A and the passenger seat 1B are both ON (YES in Step S1231), then the process proceeds to Step S1232. In Step S1232, the controller 60 determines whether the blowing target position for the driver side is the first portion.

If the controller 60 determines that the blowing target position for the driver side is the first portion (YES in S1232), then the process proceeds to Step S1233. In Step S1233, the controller 60 determines whether the blowing target position for the passenger side is the second portion.

If the controller 60 determines that the blowing target position for the passenger side is the second portion (YES in S1233), then the process proceeds to Step S1234. In Step S1234, the controller 60 causes the blowing duct selection switching part 37A of the driver's seat 1A to execute the second mode, and controls the horizontal plate fins 121 of the third ventilation port 12c of the driver's seat 1A to adjust the blowing direction to the horizontal direction.

Further, the controller 60 controls the vertical plate fins 123 of the third ventilation port 12c of the driver's seat 1A to adjust the blowing direction to be closer to the front side (closer to the X-axis positive direction). Further, the controller 60 causes the blowing duct selection switching part 37B of the passenger seat 1B to execute the first mode, and controls the horizontal plate fins 121 of the second ventilation port 12b of the passenger seat 1B to adjust the blowing direction to the horizontal direction. Then, the controller 60 finishes the air-conditioning control processing in which the seat positions are not taken into account.

If the controller 60 determines that the blowing target position for the passenger seat 1B is the first portion (NO in S1233), then the process proceeds to Step S1235.

In Step S1235, the controller 60 causes the blowing duct selection switching part 37A of the driver's seat 1A to execute the second mode, and controls the horizontal plate fins 121 of the third ventilation port 12c of the driver's seat 1A to adjust the blowing direction upward. Further, the controller 60 causes the blowing duct selection switching part 37B of the passenger seat 1B to execute the first mode, and controls the horizontal plate fins 121 of the second ventilation port 12b of the passenger seat 1B to adjust the blowing direction to the horizontal direction. Then, the controller 60 finishes the air-conditioning control processing in which the seat positions are not taken into account.

If the controller 60 determines that the blowing target position for the driver side is the second portion (NO in S1232), then the process proceeds to Step S1236. In Step S1236, the controller 60 determines whether the blowing target position for the passenger side is the second portion.

If the controller 60 determines that the blowing target position for the passenger side is the second portion (YES in S1236), then the process proceeds to Step S1237. In Step S1237, the controller 60 causes the blowing duct selection switching part 37A of the driver's seat 1A to execute the first mode, and controls the horizontal plate fins 121 of the second ventilation port 12b of the driver's seat 1A to adjust the blowing direction downward.

Further, the controller 60 controls the vertical plate fins 123 of the third ventilation port 12c of the driver's seat 1A to adjust the blowing direction to be closer to the front side (closer to the X-axis positive direction). Further, the controller 60 causes the blowing duct selection switching part 37B of the passenger seat 1B to execute the second mode, and controls the horizontal plate fins 121 of the third ventilation port 12c of the passenger seat 1B to adjust the blowing direction to the horizontal direction. Then, the controller 60 finishes the air-conditioning control processing in which the seat positions are not taken into account.

If the controller 60 determines that the blowing target position for the passenger side is the first portion (NO in S1236), then the process proceeds to Step S1238. In Step S1238, the controller 60 causes the blowing duct selection switching part 37A of the driver's seat 1A to execute the first mode, and controls the horizontal plate fins 121 of the second ventilation port 12b of the driver's seat 1A to adjust the blowing direction to the horizontal direction. Further, the controller 60 causes the blowing duct selection switching part 37B of the passenger seat 1B to execute the second mode, and controls the horizontal plate fins 121 of the third ventilation port 12c of the passenger seat 1B to adjust the blowing direction to the horizontal direction. Then, the controller 60 finishes the air-conditioning control processing in which the seat positions are not taken into account.

According to Steps S1234, S1235, S1237, and S1238, in combination with Step S1209 to be executed later, it is possible to reduce interference between air blown out from both the vehicle seat air conditioners 830, to perform air-conditioning control in which the seat type of the adjacent seat is taken into account, and prevent reduction in comfort due to solar radiation. In the processes, it is assumed that air can be sufficiently blown out to the blowing target position without taking account of the seat position of each seat. Therefore, it is possible to perform air-conditioning control in consideration of the seat type of the adjacent seat, and air can be blown out to the blowing target position more reliably regardless of the posture or the like of the occupant seated in the adjacent seat.

In the processes described above, the order of the determination processes may be appropriately changed. The processing of each of the vehicle seat air conditioners 830 is not limited to the above-described processing.

As in the first modification of the first embodiment, one blowing port 134a may be provided on a side surface of the seat back 13 of each of the driver's seat 1A and the passenger seat 1B. In this case, the controller 60 may execute, after the process in Step S1201 of FIG. 38, the process illustrated in FIG. 16 and further execute the process in Step S1209 of FIG. 38.

As in the second modification and the third modification of the first embodiment, the controller of the vehicle seat air-conditioning system may not be provided and the individual controller 271 may independently control the vehicle seat air conditioners 830.

As in the modification of the second embodiment, the controller 60 may be electrically connected to the occupant posture sensor 51. In this case, in the processes of Steps S1234, S1235, S1237, and S1238 of FIG. 41, the controller 60 may control the mode of the blowing duct selection switching part 37 and the blowing direction based on the processing illustrated in FIG. 27 or the like.

As in the first and second modifications of the third embodiment, the controller 60 may be electrically connected to the vehicle air conditioner 2b. In this case, in the process of Step S1209 of FIG. 38, the controller 60 may execute the processing illustrated in FIG. 30 or 31.

### Other Modifications, Etc

Although the present disclosure has been described based on the first to fifth embodiments, the present disclosure is not limited to the first to fifth embodiments.

For example, the vehicle seat air conditioner according to each of the first to fifth embodiments does not have to blow out air to the occupant seated in the adjacent seat along the width direction of the vehicle 1000. For example, air may be blown out to the occupant seated in the adjacent seat along the front-back direction, or may be blown out to the occupant seated in the adjacent seat along the oblique direction.

Although the vehicle seat air-conditioning system according to the first embodiment controls the vehicle seat air conditioner provided in each of the two adjacent seats, the vehicle seat air-conditioning system may control the vehicle seat air conditioner provided in each of three or more adjacent seats. Such a vehicle seat air-conditioning system is applicable not only to a general ordinary vehicle but also to a bus or the like in which three or more seats can be adjacent.

In the vehicle seat air-conditioning system and the vehicle seat air conditioner according to each of the first to fifth embodiments, the blowing ports may be provided side by side in the front-back direction on the side surface of the seat.

Each of the processing units included in the vehicle seat air-conditioning system and the vehicle seat air conditioner according to each of the first to fifth embodiments is typically implemented as an LSI that is an integrated circuit. They may be individually integrated into one chip, or may be integrated into one chip so as to include a part or all of them.

Further, the circuit integration is not limited to LSI, and may be implemented by a dedicated circuit or a general-purpose processor. A field programmable gate array (FPGA) that can be programmed after the LSI is manufactured or a reconfigurable processor in which connections and settings of circuit cells inside the LSI can be reconfigured may be used.

Note that, in each of the above embodiments, each constituent element may be configured by dedicated hardware or may be implemented by executing a software program suitable for each constituent element. Each constituent element may be implemented by a program execution unit such as a CPU or a processor reading and executing a software program recorded in a recording medium such as a hard disk or a semiconductor memory.

The numbers used above are all exemplified to specifically describe the present disclosure, and the first to fifth embodiments of the present disclosure are not limited to the exemplified numbers.

Further, the division of the functional blocks in the block diagrams is an example, and a plurality of functional blocks may be implemented as one functional block, one functional block may be divided into a plurality of functional blocks, or some functions may be transferred to another functional block. In addition, functions of a plurality of functional blocks having similar functions may be processed in parallel or in a time-sharing manner by single hardware or software.

The order in which each step in the flowcharts is executed is exemplified to specifically describe the present disclosure, and may be an order other than the above order. Some of the above steps may be executed simultaneously (in parallel) with other steps.

The present disclosure also includes a mode obtained by making various modifications conceivable by those skilled in the art to the first to fifth embodiments, and a mode implemented by arbitrarily combining the constituent elements and functions of the first to fifth embodiment without departing from the gist of the present disclosure.

### APPENDIX

As is apparent from the above embodiments, the present disclosure includes the following aspects. In the following, reference numerals are given in parentheses only to clearly indicate the correspondence with the embodiments.

A vehicle seat air-conditioning system (3, 3a, 3b) according to a first aspect includes a plurality of vehicle seat air conditioners (30, 130, 830) and a controller (60). The plurality of vehicle seat air conditioners (30, 130, 830) are provided in a plurality of seats (1) of a vehicle (1000). The controller (60) controls the plurality of vehicle seat air conditioners (30, 130, 830). The vehicle seat air conditioner (30, 130, 830) includes a blower (36) and a blowing duct (34, 35, 134, 38). The blowing duct (34, 35, 134, 38) blows out air guided by the blower (36) from a blowing port (34a, 35a, 134a, 38a) provided on a side surface of the seat (1). The controller (60) acquires blowing target positions of air from the plurality of vehicle seat air conditioners (30, 130, 830), and controls, based on the blowing target positions, at least one of a time at which air is blown out from the blowing port (34a, 35a, 134a, 38a), a blowing direction, and selection of the blowing ports (34a, 35a, 134a, 38a) from which the air is blown out.

The vehicle seat air-conditioning system (3, 3a, 3b) according to a second aspect may be implemented in combination with the first aspect. In the second aspect, the vehicle seat air conditioners (30, 130, 830) are provided on a first seat and a second seat that are two seats (1) adjacent in the left-right direction of the vehicle (1000). The blowing ports (34a, 35a, 134a) are provided on a side surface of the first seat facing the second seat and a side surface of the second seat facing the first seat. The controller (60) executes, based on the blowing target positions, at least one of shifting the time at which the air is blown out from the blowing port (34a, 35a, 134a) provided in each of the first seat and the second seat, and setting the blowing direction and selection of the blowing ports (34a, 35a, 134a) from which the air is blown out so as to reduce interference between the air blown out from the blowing port (34a, 35a, 134a) provided in the first seat and the air blown out from the blowing port (34a, 35a, 134a) provided in the second seat.

The vehicle seat air-conditioning system (3, 3b) according to a third aspect may be implemented in combination with the second aspect. The plurality of blowing ports (34a, 35a) are respectively provided in the first seat and the second seat. The blowing duct (34, 35) includes a first blowing duct (34) and a second blowing duct (35) that respectively blow out the air guided by the blower (36) from a first blowing port (34a) and a second blowing port (35a) that are the plurality of blowing ports (34a, 35a). The vehicle seat air conditioner (30, 830) further includes a blowing duct selection switching part (37) that selects a ventilation path. The blowing duct selection switching part (37) has a first mode for guiding the air guided by the blower (36) to the first blowing duct (34) and a second mode for guiding the air guided by the blower (36) to the second blowing duct (35). The controller (60) switches, based on the blowing target positions, between the first mode and the second mode of the blowing duct selection switching part (37) for the first seat and the second seat to control the selection of the blowing ports (34a, 35a) from which the air is blown out.

The vehicle seat air-conditioning system (3, 3b) according to a fourth aspect may be implemented in combination with the third aspect. In the fourth aspect, the second blowing port (35a) is provided below the first blowing port (34a).

The vehicle seat air-conditioning system (3, 3b) according to a fifth aspect may be implemented in combination with the third or fourth aspect. In the fifth aspect, the blowing target position is selected from among a plurality of portions of an occupant seated in the adjacent seat including a first portion of the occupant and a second portion of the occupant located below the first portion. The controller (60) controls the blowing direction and the mode of the blowing duct selection switching part (37) based on the blowing target position.

The vehicle seat air-conditioning system (3, 3b) according to a sixth aspect may be implemented in combination with any one of the third to fifth aspects. In the sixth aspect, the controller (60) switches, based on the blowing target positions, the blowing direction and the modes of the blowing duct selection switching part (37) at predetermined time intervals.

The vehicle seat air-conditioning system (3a) according to a seventh aspect may be implemented in combination with the second aspect. In the seventh aspect, one blowing port (134a) is provided in each of the first seat and the second seat.

The vehicle seat air-conditioning system (3a) according to an eighth aspect may be implemented in combination with the seventh aspect. In the eighth aspect, the controller (60) determines, based on the blowing target positions, whether the air blown out from the blowing port (134a) provided in the first seat and the air blown out from the blowing port (134a) provided in the second seat interfere with each other. When it is determined that the interference occurs, the controller (60) controls the vehicle seat air conditioner (130) provided in the first seat so that air is blown out in a first time zone from the blowing port (134a) of the first seat and air is not blown out in a second time zone different from the first time zone, and controls the vehicle seat air conditioner (130) provided in the second seat so that air is blown out in the second time zone from the blowing port (134a) of the second seat and air is not blown out in the first time zone.

The vehicle seat air-conditioning system (3a) according to a ninth aspect may be implemented in combination with the eighth aspect. In the ninth aspect, the first time zone is a time zone following the second time zone. The second time zone is a time zone following the first time zone.

The vehicle seat air-conditioning system (3a) according to a tenth aspect may be implemented in combination with the eighth or ninth aspect. In the tenth aspect, the blowing target position is selected from among a plurality of portions of an occupant seated in the adjacent seat including a first portion of the occupant and a second portion of the occupant located below the first portion. The controller (60) controls at least one of the blowing timing and the blowing direction based on the blowing target positions.

The vehicle seat air-conditioning system (3a) according to an eleventh aspect may be implemented in combination with the tenth aspect. In the eleventh aspect, the blowing port (134a) of the first seat is provided at a height corresponding to the blowing port (134a) of the second seat. When both the blowing target positions of the plurality of vehicle seat air conditioners (130) are the first portion or the second portion, the controller (60) determines that the air blown out from the blowing port (134a) of the first seat and the air blown out from the blowing port (134a) of the second seat interfere with each other.

A vehicle seat air conditioner (230, 330, 430, 530, 630, 730) according to a twelfth aspect is provided in a first seat of a vehicle (1000), and performs air-conditioning for another seat other than the first seat. The vehicle seat air conditioner (230, 330, 430, 530, 630, 730) includes a blower (36), a blowing duct (34, 35, 134, 38), and a controller (271). The blowing duct (34, 35, 134, 38) blows out air guided by the blower (36) from a blowing port (34a, 35a, 134a, 38a) provided on a side surface of the first seat. The controller (271) controls the blower (36). The controller (271) acquires blowing target positions of air blown out from the blowing port of the first seat and a blowing port of the other seat, and controls, based on the blowing target positions, at least one of a time at which air is blown out from the blowing port (34a, 35a, 134a, 38a), a blowing direction, and selection of the blowing ports (34a, 35a, 134a, 38a) from which the air is blown out.

The vehicle seat air conditioner (230, 330, 430, 530, 630, 730) according to a thirteenth aspect may be implemented in combination with the twelfth aspect. In the thirteenth aspect, the other seat includes a second seat adjacent to the first seat in the left-right direction of the vehicle (1000). The blowing port (34a, 35a, 134a) of the first seat is provided on the side surface of the first seat facing the second seat. The controller (271) executes, based on the blowing target positions, at least one of shifting the time at which the air is blown out from the blowing port (34a, 35a, 134a) provided in the first seat from a time at which air is blown out from the blowing port (34a, 35a, 134a) provided in the second seat, and setting the blowing direction and the selection of the blowing ports (34a, 35a, 134a) from which the air is blown out to reduce interference between the air blown out from the blowing port (34a, 35a, 134a) provided in the first seat and the air blown out from the blowing port provided in the second seat.

The vehicle seat air conditioner (230) according to a fourteenth aspect may be implemented in combination with the thirteenth aspect. In the fourteenth aspect, the vehicle seat air conditioner (230) further includes a blowing duct selection switching part (37) that selects a ventilation path. The blowing port provided in the first seat includes a plurality of blowing ports (34a, 35a) on the side surface of the first seat. The blowing duct (34, 35) includes a first blowing duct (34) and a second blowing duct (35) that respectively blow out the air guided by the blower (36) from a first blowing port (34a) and a second blowing port (35a) that are the plurality of blowing ports. The blowing duct selection switching part (37) has a first mode for guiding the air guided by the blower (36) to the first blowing duct (34) and a second mode for guiding the same to the second blowing duct (35). The controller (271) switches, based on the blowing target positions, between the first mode and the second mode of the blowing duct selection switching part (37) to control the selection of the blowing ports (34a, 35a) from which air is blown out.

The vehicle seat air conditioner (230) according to a fifteenth aspect may be implemented in combination with the fourteenth aspect. In the fifteenth aspect, the second blowing port (35a) is provided below the first blowing port (34a).

The vehicle seat air conditioner (230) according to a sixteenth aspect may be implemented in combination with the fourteenth or fifteenth aspect. In the sixteenth aspect, the blowing target position of the vehicle seat air conditioner (230) provided in the first seat is selected from a plurality of portions of an occupant seated in the second seat including a first portion of the occupant and a second portion of the occupant located below the first portion. The controller (271) controls the blowing direction and the mode of the blowing duct selection switching part (37) based on the blowing target position.

The vehicle seat air conditioner (230) according to a seventeenth aspect may be implemented in combination with any one of the fourteenth to sixteenth aspects. In the seventeenth aspect, the controller (271) switches, based on the blowing target positions, the blowing direction and the modes of the blowing duct selection switching part (37) at predetermined time intervals.

The vehicle seat air conditioner (330) according to an eighteenth aspect may be implemented in combination with the thirteenth aspect. In the eighteenth aspect, the blowing port (134a) of the first seat is one blowing port provided on the side surface of the first seat.

The vehicle seat air conditioner (330) according to a nineteenth aspect may be implemented in combination with the eighteenth aspect. In the nineteenth aspect, the controller (271) determines, based on the blowing target positions, whether the air blown out from the blowing port (134a) provided in the first seat and the air blown out from the blowing port (134a) provided in the second seat interfere with each other. When it is determined that interference occurs, the controller (271) controls the blowing timing so that the air is blown out from the blowing port (134a) of the first seat in a first time zone in which air is not blown out from the blowing port (134a) of the second seat, and the air is not blown out from the blowing port of the first seat in a second time zone, different from the first time zone, in which the air is blown out from the blowing port (134a) of the second seat.

The vehicle seat air conditioner (330) according to a twentieth aspect may be implemented in combination with the nineteenth aspect. In the twentieth aspect, the first time zone is a time zone following the second time zone. The second time zone is a time zone following the first time zone.

The vehicle seat air conditioner (330) according to a twenty-first aspect may be implemented in combination with the nineteenth or twentieth aspect. In the twenty-first aspect, the blowing target position of the vehicle seat air conditioner (330) provided in the first seat is selected from a plurality of portions of an occupant seated in the second seat including a first portion of the occupant and a second portion of the occupant located below the first portion. The controller (271) controls at least one of the blowing timing and the blowing direction based on the blowing target positions.

The vehicle seat air conditioner (330) according to a twenty-second aspect may be implemented in combination with the twenty-first aspect. In the twenty-second aspect, the blowing port (134a) of the first seat is provided at a height corresponding to the blowing port (134a) of the second seat. When both the blowing target positions of the vehicle seat air conditioners (330) of the first seat and the second seat are the first portion or the second portion, the controller (271) determines that the air blown out from the blowing port (134a) of the first seat and the air blown out from the blowing port (134a) of the second seat interfere with each other.

The vehicle seat air conditioner (430, 530) according to a twenty-third aspect may be implemented in combination with the thirteenth aspect. In the twenty-third aspect, the controller (271) controls, based on the blowing target positions and the seat type of the second seat, at least one of the blowing direction and the selection of the blowing ports (34a, 35a, 134a) from which the air is blown out.

The vehicle seat air conditioner (430, 530) according to a twenty-fourth aspect may be implemented in combination with the twenty-third aspect. In the twenty-fourth aspect, the controller (271) controls, based on the blowing target positions and the seat type of the second seat, at least one of the blowing direction and the selection of the blowing ports (34a, 35a, 134a) from which the air is blown out so that conditioned-air, which is the air blown out from the blowing port (34a, 35a, 134a), reaches the blowing target position.

The vehicle seat air conditioner (430, 530) according to a twenty-fifth aspect may be implemented in combination with the twenty-third or twenty-fourth aspect. In the twenty-fifth aspect, the vehicle seat air conditioner (430, 530) further includes a blowing duct selection switching part (37) that selects a ventilation path. The blowing port provided in the first seat includes a plurality of blowing ports (34a, 35a) on the side surface of the first seat. The blowing duct (34, 35) includes a first blowing duct (34) and a second blowing duct (35) that respectively blow out the air guided by the blower (36) from a first blowing port (34a) and a second blowing port (35a) that are the plurality of blowing ports. The blowing duct selection switching part (37) has a first mode for guiding the air guided by the blower (36) to the first blowing duct (34) and a second mode for guiding the air guided by the blower (36) to the second blowing duct (35). The controller (271) switches between the first mode and the second mode of the blowing duct selection switching part (37) based on the blowing target positions.

The vehicle seat air conditioner (430, 530) according to a twenty-sixth aspect may be implemented in combination with the twenty-fifth aspect. In the twenty-sixth aspect, the blowing target position is selected from among a plurality of portions of an occupant seated in the second seat including a first portion of the occupant and a second portion of the occupant located below the first portion. The controller (271) controls the blowing direction based on the blowing target positions.

The vehicle seat air conditioner (430) according to a twenty-seventh aspect may be implemented in combination with the twenty-sixth aspect. In the twenty-seventh aspect, the seat type of the second seat includes a driver's seat and a passenger seat.

The vehicle seat air conditioner (430) according to a twenty-eighth aspect may be implemented in combination with the twenty-seventh aspect. In the twenty-eighth aspect, the seat type of the second seat includes the driver's seat.

The vehicle seat air conditioner (430) according to a twenty-ninth aspect may be implemented in combination with the twenty-eighth aspect. In the twenty-ninth aspect, when the blowing target position is the first portion, the controller (271) causes the blowing duct selection switching part (37) to execute the first mode.

The vehicle seat air conditioner (430) according to a thirtieth aspect may be implemented in combination with the twenty-eighth or twenty-ninth aspect. In the thirtieth aspect, when the blowing target position is the second portion, the controller (271) causes the blowing duct selection switching part (37) to execute the second mode.

The vehicle seat air conditioner (530) according to a thirty-first aspect may be implemented in combination with the twenty-sixth aspect. In the thirty-first aspect, the controller (271) switches the modes of the blowing duct selection switching part (37) based on a detection result of an occupant posture sensor (51) that detects the posture of the occupant seated in the second seat.

The vehicle seat air conditioner (530) according to a thirty-second aspect may be implemented in combination with the thirty-first aspect. In the thirty-second aspect, the controller (271) determines whether the occupant seated in the second seat grips a steering wheel of the vehicle (1000) based on the detection result of the occupant posture sensor (51).

The vehicle seat air conditioner (530) according to a thirty-third aspect may be implemented in combination with the thirty-second aspect. In the thirty-third aspect, when it is determined that the occupant seated in the second seat grips the steering wheel and the blowing target position is the first portion, the controller (271) causes the blowing duct selection switching part (37) to execute the first mode.

The vehicle seat air conditioner (530) according to a thirty-fourth aspect may be implemented in combination with the thirty-second or thirty-third aspect. In the thirty-fourth aspect, when it is determined that the occupant seated in the second seat grips the steering wheel and the blowing target position is the second portion, the controller (271) causes the blowing duct selection switching part (37) to execute the second mode.

The vehicle seat air conditioner (430, 530) according to a thirty-fifth aspect may be implemented in combination with the twenty-seventh aspect. In the thirty-fifth aspect, the seat type of the second seat includes the passenger seat.

The vehicle seat air conditioner (430) according to a thirty-sixth aspect may be implemented in combination with the thirty-fifth aspect. In the thirty-sixth aspect, the blowing port (34a, 35a) for performing air-conditioning for the first seat is provided on the side surface of the second seat. When the blowing target position is the second portion, the controller (271) controls the blowing direction of air blown out from the blowing port (34a, 35a) provided on the side surface of the first seat to be closer to the front side of the vehicle (1000) than the blowing direction of air blown out from the blowing port (34a, 35a) provided on the side surface of the second seat.

The vehicle seat air conditioner (530) according to a thirty-seventh aspect may be implemented in combination with the thirty-fifth or thirty-sixth aspect. In the thirty-seventh aspect, the controller (271) controls the blowing direction of air blown out from the blowing port (34a, 35a) provided on the side surface of the first seat based on the detection result of the occupant posture sensor (51) that detects the posture of the occupant seated in the second seat.

The vehicle seat air conditioner (630) according to a thirty-eighth aspect may be implemented in combination with the thirteenth aspect. In the thirty-eighth aspect, the controller (271) controls at least one of the blowing direction and a blowing amount of air blown out from the blowing port (34a, 35a, 134a) based on a detection result of a temperature detection sensor that detects information on a temperature of the second seat.

The vehicle seat air conditioner (630) according to a thirty-ninth aspect may be implemented in combination with the thirty-eighth aspect. In the thirty-ninth aspect, the temperature detection sensor is a solar radiation sensor (52) that detects an amount of solar radiation entering the interior of the vehicle (1000).

The vehicle seat air conditioner (630) according to a fortieth aspect may be implemented in combination with the thirty-eighth aspect. In the fortieth aspect, the temperature detection sensor includes a non-contact thermometer or a thermography.

The vehicle seat air conditioner (630) according to a forty-first aspect may be implemented in combination with any one of the thirty-eighth to fortieth aspects. In the forty-first aspect, when a detected value indicating information on the temperature detected by the temperature detection sensor is equal to or greater than a threshold, the controller (271) controls the blowing direction to be closer to the front side of the vehicle (1000) than the blowing direction when the detected value is less than the threshold.

The vehicle seat air conditioner (630) according to a forty-second aspect may be implemented in combination with any one of the thirty-eighth to forty-first aspects. In the forty-second aspect, when a detected value indicating information on the temperature detected by the temperature detection sensor is equal to or greater than a threshold, the controller (271) controls the blowing amount to be larger than the blowing amount when the detected value is less than the threshold.

The vehicle seat air conditioner (630) according to a forty-third aspect may be implemented in combination with any one of the thirty-eighth to fortieth aspects. In the forty-third aspect, the controller (271) acquires setting information on a blowing direction and an air volume of conditioned air blown from the vehicle air conditioner (2b) mounted on the vehicle (1000). The controller (271) controls at least one of the blowing direction and the blowing amount based on the setting information.

The vehicle seat air conditioner (630) according to a forty-fourth aspect may be implemented in combination with the forty-third aspect. In the forty-fourth aspect, the controller (271) calculates a confluence of air blown out from the blowing port (34a, 35a, 134a) and conditioned-air blown from the vehicle air conditioner (2b) based on the setting information. The controller (271) controls the blowing direction to blow out the air toward the confluence.

The vehicle seat air conditioner (630) according to a forty-fifth aspect may be implemented in combination with the forty-third or forty-fourth aspect. In the forty-fifth aspect, the controller (271) controls at least one of the blowing direction and the blowing amount so that the air blown out from the blowing port (34a, 35a, 134a) merges with the conditioned-air blown from the vehicle air conditioner (2b) to be blown to a portion of the occupant seated in the second seat on a door side of the vehicle (1000).

The vehicle seat air conditioner (630) according to a forty-sixth aspect may be implemented in combination with any one of the thirty-eighth to fortieth aspects. In the forty-sixth aspect, when the detected value indicating the information on the temperature detected by the temperature detection sensor is equal to or greater than the threshold, the controller (271) controls at least one of the blowing direction and the air volume of the conditioned-air blown from the vehicle air conditioner (2b) mounted on the vehicle (1000) in addition to at least one of the blowing direction and the blowing amount.

The vehicle seat air conditioner (630) according to a forty-seventh aspect may be implemented in combination with the forty-sixth aspect. In the forty-seventh aspect, the controller (271) controls the blowing direction of the air blown out from the blowing port (34a, 35a, 134a) and the blowing direction of the conditioned-air blown from the vehicle air conditioner (2b) so that the air blown out from the blowing port (34a, 35a, 134a) and the conditioned-air blown from the vehicle air conditioner (2b) merge with each other.

The vehicle seat air conditioner (630) according to a forty-eighth aspect may be implemented in combination with the forty-sixth or forty-seventh aspect. In the forty-eighth aspect, the controller (271) controls at least one of the blowing direction and the blowing amount of the air blown out from the blowing port (34a, 35a, 134a) and at least one of the blowing direction and the air volume of the conditioned-air blown from the vehicle air conditioner (2b) so that the air blown out from the blowing port (34a, 35a, 134a) is merged with the conditioned-air blown from the vehicle air conditioner (2b) to be blown to a portion of the occupant seated in the second seat on the door side of the vehicle (1000).

The vehicle seat air conditioner (730) according to a forty-ninth aspect may be implemented in combination with the thirteenth aspect. In the forty-ninth aspect, the vehicle seat air conditioner (730) further includes a blowing duct selection switching part (37) that selects a ventilation path. The blowing port provided in the first seat includes a plurality of blowing ports (34a, 35a, 38a) in the first seat. The blowing duct (34, 35, 38) includes a first blowing duct (34) and a second blowing duct (35, 38) that respectively blow out the air guided by the blower (36) from a first blowing port (34a) and a second blowing port (35a, 38a) that are the plurality of blowing ports. The first blowing port (34a) is provided on the side surface of the first seat. The second blowing port (35a, 38a) is provided below the first blowing port (34a) in the first seat. The blowing duct selection switching part (37) has a first mode for guiding the air guided by the blower (36) to the first blowing duct (34) and a second mode for guiding the air guided by the blower (36) to the second blowing duct (35, 38). The controller (271) switches between the first mode and the second mode of the blowing duct selection switching part (37) based on at least one of a reclining angle and a slide position of each of the first seat and the second seat.

The vehicle seat air conditioner (730) according to a fiftieth aspect may be implemented in combination with the forty-ninth aspect. In the fiftieth aspect, the second blowing port (35a) is provided below the first blowing port (34a) on the side surface of the seat back (13) of the first seat.

The vehicle seat air conditioner (730) according to a fifty-first aspect may be implemented in combination with the forty-ninth or fiftieth aspect. In the fifty-first aspect, when an angle obtained by subtracting the reclining angle of the second seat from the reclining angle of the first seat is equal to or larger than a first angle and a length obtained by subtracting the slide position of the second seat from the slide position of the first seat is equal to or longer than a first length, the controller (271) causes the blowing duct selection switching part (37) to execute the second mode.

The vehicle seat air conditioner (730) according to a fifty-second aspect may be implemented in combination with the fifty-first aspect. In the fifty-second aspect, when the angle obtained by subtracting the reclining angle of the second seat from the reclining angle of the first seat is equal to or larger than a second angle that is larger than the first angle, the controller (271) causes the blowing duct selection switching part (37) to execute the second mode regardless of the length obtained by subtracting the slide position of the second seat from the slide position of the first seat.

The vehicle seat air conditioner (730) according to a fifty-third aspect may be implemented in combination with the forty-ninth aspect. In the fifty-third aspect, the second blowing port (38a) is provided in a portion of a seat portion (11) of the first seat on the second seat side.

The vehicle seat air conditioner (730) according to a fifty-fourth aspect may be implemented in combination with the fifty-third aspect. In the fifty-fourth aspect, when an angle obtained by subtracting the reclining angle of the second seat from the reclining angle of the first seat is equal to or larger than a first angle and a length obtained by subtracting the slide position of the second seat from the slide position of the first seat is equal to or longer than a first length, the controller (271) causes the blowing duct selection switching part (37) to execute the second mode. When the length obtained by subtracting the slide position of the second seat from the slide position of the first seat is equal to or longer than a second length that is longer than the first length, the controller (271) causes the blowing duct selection switching part (37) to execute the second mode regardless of the angle obtained by subtracting the reclining angle of the second seat from the reclining angle of the first seat.

The vehicle seat air conditioner (730) according to a fifty-fifth aspect may be implemented in combination with the fiftieth aspect. In the fifty-fifth aspect, the vehicle seat air conditioner (730) further includes a third blowing duct (38) that blows out the air guided by the blower (36) from the third blowing port (38a) provided in a portion of the seat portion (11) of the first seat on the second seat side. The blowing duct selection switching part (37) further has a third mode for guiding the air guided by the blower (36) to the third blowing duct (38). The controller (271) switches between the first mode, the second mode, and the third mode of the blowing duct selection switching part (37) based on at least one of the reclining angle and the slide position of each of the first seat and the second seat.

The vehicle seat air conditioner (730) according to a fifty-sixth aspect may be implemented in combination with the fifty-fifth aspect. In the fifty-sixth aspect, when the angle obtained by subtracting the reclining angle of the second seat from the reclining angle of the first seat is equal to or larger than the first angle and the length obtained by subtracting the slide position of the second seat from the slide position of the first seat is equal to or longer than the first length, the controller (271) causes the blowing duct selection switching part (37) to execute the second mode. When the length obtained by subtracting the slide position of the second seat from the slide position of the first seat is equal to or longer than the second length that is longer than the first length, the controller (271) causes the blowing duct selection switching part (37) to execute the third mode regardless of the angle obtained by subtracting the reclining angle of the second seat from the reclining angle of the first seat.

The vehicle seat air conditioner (730) according to a fifty-seventh aspect may be implemented in combination with any one of the forty-ninth to fifty-sixth aspects. In the fifty-seventh aspect, the controller (271) switches the modes of the blowing duct selection switching part (37) based on a table indicating a correspondence between “the angle obtained by subtracting the reclining angle of the second seat from the reclining angle of the first seat as well as the length obtained by subtracting the slide position of the second seat from the slide position of the first seat” and the modes of the blowing duct selection switching part (37).

The vehicle seat air-conditioning system and the vehicle seat air conditioner according to the present disclosure can provide a more comfortable air-conditioned environment for an occupant seated in a seat.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle seat air conditioner that is provided in a first seat of a vehicle and performs air-conditioning for another seat other than the first seat, the vehicle seat air conditioner comprising:
a blower;
a blowing duct configured to blow out air guided by the blower from a blowing port provided on a side surface of the first seat; and
a controller configured to control the blower,
the controller being configured to:
acquire blowing target positions of air blown out from the blowing port of the first seat and a blowing port of the other seat; and
control, based on the blowing target positions, at least one of a time at which air is blown out from the blowing port, a blowing direction, and selection of the blowing ports from which the air is blown out.

2. The vehicle seat air conditioner according to claim 1, wherein
the other seat includes a second seat adjacent to the first seat in a left-right direction of the vehicle,
the blowing port of the first seat is provided on the side surface of the first seat facing the second seat, and
the controller is configured to execute, based on the blowing target positions, at least one of shifting the time at which the air is blown out from the blowing port provided in the first seat from a time at which air is blown out from the blowing port provided in the second seat, and setting the blowing direction and the selection of the blowing ports from which the air is blown out to reduce interference between the air blown out from the blowing port provided in the first seat and the air blown out from the blowing port provided in the second seat.

3. The vehicle seat air conditioner according to claim 2, further comprising:
a blowing duct selection switching part that selects a ventilation path, wherein
the blowing port provided in the first seat includes a plurality of blowing ports on the side surface of the first seat,
the blowing duct includes a first blowing duct and a second blowing duct that respectively blow out the air guided by the blower from a first blowing port and a second blowing port that are the plurality of blowing ports,
the blowing duct selection switching part has a first mode for guiding the air guided by the blower to the first blowing duct and a second mode for guiding the air guided by the blower to the second blowing duct, and
the controller is configured to switch, based on the blowing target positions, between the first mode and the second mode of the blowing duct selection switching part to control the selection of the blowing ports from which the air is blown out.

4. The vehicle seat air conditioner according to claim 3, wherein
the second blowing port is provided below the first blowing port.

5. The vehicle seat air conditioner according to claim 3, wherein
the blowing target position of the vehicle seat air conditioner provided in the first seat is selected from among a plurality of portions of an occupant seated in the second seat including a first portion of the occupant and a second portion of the occupant located below the first portion, and
the controller is configured to control the blowing direction and the mode of the blowing duct selection switching part based on the blowing target position.

6. The vehicle seat air conditioner according to claim 3, wherein
the controller is configured to switch, based on the blowing target positions, the blowing direction and the modes of the blowing duct selection switching part at predetermined time intervals.

7. The vehicle seat air conditioner according to claim 2, wherein
the blowing port provided in the first seat is one blowing port provided on the side surface of the first seat.

8. The vehicle seat air conditioner according to claim 7, wherein
the controller is configured to:
determine, based on the blowing target positions,
whether the air blown out from the blowing port provided in the first seat and the air blown out from the blowing port provided in the second seat interfere with each other; and
when it is determined that interference occurs, control the time at which the air is blown out so that the air is blown out from the blowing port of the first seat in a first time zone in which air is not blown out from the blowing port of the second seat, and the air is not blown out from the blowing port of the first seat in a second time zone, different from the first time zone, in which the air is blown out from the blowing port of the second seat.

9. The vehicle seat air conditioner according to claim 8, wherein
the first time zone is a time zone following the second time zone, and
the second time zone is a time zone following the first time zone.

10. The vehicle seat air conditioner according to claim 8, wherein
the blowing target position of the vehicle seat air conditioner provided in the first seat is selected from among a plurality of portions of an occupant seated in the second seat including a first portion of the occupant and a second portion of the occupant located below the first portion, and
the controller is configured to control at least one of the time at which the air is blown out and the blowing direction based on the blowing target positions.

11. The vehicle seat air conditioner according to claim 10, wherein
the blowing port of the first seat is provided at a height corresponding to the blowing port of the second seat, and
when both the blowing target positions of the vehicle seat air conditioners in the first seat and the second seat are the first portion or the second portion, the controller is configured to determine that the air blown out from the blowing port of the first seat and the air blown out from the blowing port of the second seat interfere with each other.

12. The vehicle seat air conditioner according to claim 2, wherein
the controller is configured to control at least one of the blowing direction and the selection of the blowing ports from which the air is blown out based on the blowing target positions and a seat type of the second seat.

13. The vehicle seat air conditioner according to claim 12, further comprising:
a blowing duct selection switching part that selects a ventilation path, wherein
the blowing port provided in the first seat includes a plurality of blowing ports on the side surface of the first seat,
the blowing duct includes a first blowing duct and a second blowing duct that respectively blow out the air guided by the blower from a first blowing port and a second blowing port that are the plurality of blowing ports,
the blowing duct selection switching part has a first mode for guiding the air guided by the blower to the first blowing duct and a second mode for guiding the air guided by the blower to the second blowing duct, and
the controller is configured to switch, based on the blowing target positions, between the first mode and the second mode of the blowing duct selection switching part.

14. The vehicle seat air conditioner according to claim 2, wherein
the controller is configured to control at least one of the blowing direction and a blowing amount of air blown out from the blowing port based on a detection result of a temperature detection sensor that detects information on a temperature of the second seat.

15. The vehicle seat air conditioner according to claim 14, wherein
the controller is configured to control, when a detected value indicating information on the temperature detected by the temperature detection sensor is equal to or greater than a threshold, the blowing direction to be closer to a front side of the vehicle than the blowing direction when the detected value is less than the threshold.

16. The vehicle seat air conditioner according to claim 14, wherein
the controller is configured to control, when a detected value indicating information on the temperature detected by the temperature detection sensor is equal to or greater than a threshold, the blowing amount to be larger than the blowing amount when the detected value is less than the threshold.

17. The vehicle seat air conditioner according to claim 2, further comprising:
a blowing duct selection switching part that selects a ventilation path, wherein
the blowing port provided in the first seat includes a plurality of blowing ports in the first seat,
the blowing duct includes a first blowing duct and a second blowing duct that respectively blow out the air guided by the blower from a first blowing port and a second blowing port that are the plurality of blowing ports,
the first blowing port is provided on the side surface of the first seat,
the second blowing port is provided below the first blowing port in the first seat,
the blowing duct selection switching part has a first mode for guiding the air guided by the blower to the first blowing duct and a second mode for guiding the air guided by the blower to the second blowing duct, and
the controller is configured to switch, based on at least one of a reclining angle and a slide position of each of the first seat and the second seat, between the first mode and the second mode of the blowing duct selection switching part.

18. The vehicle seat air conditioner according to claim 17, wherein
the second blowing port is provided below the first blowing port on a side surface of a seat back of the first seat.

19. The vehicle seat air conditioner according to claim 17, wherein
the controller is configured to cause the blowing duct selection switching part to execute the second mode when an angle obtained by subtracting the reclining angle of the second seat from the reclining angle of the first seat is equal to or larger than a first angle and a length obtained by subtracting the slide position of the second seat from the slide position of the first seat is equal to or longer than a first length.

20. The vehicle seat air conditioner according to claim 19, wherein
the controller is configured to cause the blowing duct selection switching part to execute the second mode regardless of the length obtained by subtracting the slide position of the second seat from the slide position of the first seat when the angle obtained by subtracting the reclining angle of the second seat from the reclining angle of the first seat is equal to or larger than a second angle that is larger than the first angle.
